(19) United States
(12) Patent Application Publication
(10) Pub. No.: US 2019/0181436 A1
(43) Pub. Date: Jun. 13, 2019

(54) ANODE MATERIALS FOR LI-ION BATTERIES

(71) Applicant: Board of Regents, The University of Texas System, Austin, TX (US)

(72) Inventors: Brian A. Korgel, Round Rock, TX (US); Aaron Chockla, Garwood, NJ (US); Timothy Bogart, Austin, TX (US)

(21) Appl. No.: 16/208,110

(22) Filed: Dec. 3, 2018

Related U.S. Application Data
(63) Continuation of application No. 14/415,890, filed on Jan. 20, 2015, now abandoned.
(60) Provisional application No. 61/674,048, filed on Jul. 20, 2012.

(51) Int. Cl. H01M 4/36; C22C 28/00; H01M 10/0525; H01M 4/04; H01M 4/134; H01M 4/1393; H01M 4/1395; H01M 4/133; H01M 4/38; H01M 10/0567; B22F 9/00; C01B 33/021; H01M 10/0569; H01M 4/587

(52) U.S. Cl. CPC H01M 4/366; H01M 4/623; H01M 10/0525; H01M 4/04; H01M 4/134; H01M 4/1393; H01M 4/1395; H01M 4/133; H01M 4/38; H01M 4/386; H01M 10/0567; B22F 9/00; C01B 33/021; H01M 10/0569; H01M 4/587; C22C 28/00

(57) ABSTRACT

The subject matter disclosed herein relates generally to the field of the energy storage in Li-ion type batteries. More specifically, the subject matter disclosed herein relates to materials for the anode of a Li-ion battery, to their method of preparation and to their use in the anode of a Li-ion battery. Another subject matter disclosed herein are Li-ion batteries manufactured by incorporating the disclosed materials. Devices comprising the disclosed Li-ion batteries are also disclosed.

### CROSS-REFERENCE TO RELATED APPLICATIONS

This application is a continuation of U.S. application Ser. No. 14/415,890, filed on Jan. 20, 2015 and now abandoned, which is a U.S. National Stage of PCT International Application No. PCT/US2013/051486, filed on Jul. 22, 2013. PCT International Application No. PCT/US2013/051486 claims the benefit of priority to U.S. Provisional Application No. 61/674,048, filed Jul. 20, 2012, which is incorporated herein by reference in its entirety.

### STATEMENT OF GOVERNMENT SUPPORT

The invention disclosed herein was made with government support under Grant No. FA-8650-07-2-5061 awarded by the Air Force Research Laboratory. The U.S. government has certain rights in this invention.

### FIELD

The subject matter disclosed herein relates generally to the field of energy storage in Li-ion type batteries. More specifically, the subject matter disclosed herein relates to materials for the anode of a Li-ion battery, to their method of preparation and to their use in the anode of a Li-ion battery. Another subject matter disclosed herein are Li-ion batteries manufactured by incorporating the disclosed materials. Devices comprising the disclosed Li-ion batteries are also disclosed.

### BACKGROUND

Lithium (Li)-ion batteries are widely used to power portable electronic devices because they have limited self-discharge, no degradative memory effect, and the highest energy and power density of any available rechargeable battery technology. Still, Li-ion batteries can be improved in many respects. The most demanding applications like battery-powered electric vehicles and large-scale (or grid) energy storage require significantly enhanced energy and power density (see e.g., Hayner et al., Annu. Rev. Chem. Biomol. Eng. 2012, 3, 445-471; Goodenough et al., Chem. Mater. 2009, 22, 587-603). One way to significantly increase the energy density of a Li-ion battery is to replace the graphite anode with silicon (Si), as Si has a theoretical lithium storage capacity nearly ten times higher than graphite (3,579 mA h g⁻¹ compared to 373 mA h g⁻¹). (See Li et al., J. Electrochem. Soc. 2007, 154, A156-A161; Obrovac et al., Electrochem. Solid St. 2004, 7, A93-A96; Szczech et al., Energ. Environ. Sci. 2011, 4, 56-72.) Si is also a relatively inexpensive, abundant, environmentally benign material that can be reversibly lithiated electrochemically at room temperature. Si, however, expands significantly with lithium uptake, nearly tripling in volume when fully saturated. Bulk Si pulverizes under the stress of the extreme expansion and contraction during cycling. Si also has a much lower electrical conductivity than graphite, which creates a significant barrier to efficient charging and discharging. For this reason, many of the best Si-based Li-ion battery anode demonstrations to date have been made with very thin films (<1 μm) of material that cannot provide sufficient power for most applications. (See e.g., Yao et al., Nano Lett. 2011, 11, 2949-2954; Choi et al., J. Power Sources 2006, 161, 1254-1259; Ohara et al., J. Power Sources 2004, 136, 303-306; Takamura et al., J. Power Sources 2004, 129, 96-100; Maranchi et al., Electrochem. Solid St. 2003, 6, A198-A201; Takamura et al., J. Power Sources 2006, 158, 1401-1404; Wu et al., Nature Nanotechnology 2012, 7, 310-315).

What are needed in the art are improved materials for Li-ion batteries that have high energy density, good performance, and long term stability. The materials, methods, and devices disclosed herein address these and other needs.

### SUMMARY

In accordance with the purposes of the disclosed materials, compounds, compositions, articles, devices, and methods, as embodied and broadly described herein, the disclosed subject matter, in one aspect, relates to compositions and methods for preparing and using the disclosed compositions. In more specific aspects, the subject matter disclosed herein relates to materials for the anode of a Li-ion battery, to their method of preparation and to their use in the anode of a Li-ion battery. Another subject matter disclosed herein are Li-ion batteries manufactured by incorporating the disclosed materials.

In a first aspect, the present disclosure relates to an anode for a Li-ion battery. The anode comprises a layer of nanowires as the anode active material having a thickness of greater than about 10 μm on a conductive substrate. The nanowires comprise silicon and/or germanium, have an optional coating of graphitic carbon, and are prepared in a supercritical fluid with a seed material without attachment to a surface. In some embodiments, the amount of nanowires on the conductive substrate is from about 0.1 mg cm⁻² to about 1.5 mg cm⁻². The nanowires have an average diameter of from about 1 nm to about 100 nm and an average length of greater than about 1 μm and a length to diameter aspect ratio of great than 100. In the anode, the nanowires are substantially intertwined with one another in the layer. In some embodiments, the seed material comprises tin and the nanowires are silicon nanowires that comprise at least 0.5 wt. % tin in the body of the nanowire. The nanowires in the anode are crystalline, amorphous with crystalline core, or amorphous nanowires. In one embodiment, the seed material comprises gold nanocrystal and the nanowires are germanium nanowires that are substantially free of gold. The nanowires of the anode comprise a silicon and germanium alloy represented by a formula LiₓSi_{y}Ge_{(1-y)} where x=0-4.4 and y=0-1. In some embodiments, the nanowires further comprises a dopant. The nanowires without the carbon coating are mixed with a conductive carbon in the anode. The conductive carbon comprises carbon black, graphene, graphite, carbon nanotubes, or a mixture thereof. The layer of nanowires of the anode further comprises a binder. The binder comprises polyvinylidene fluoride (PVdF), annealed PVdF, crosslinked sodium alginate, crosslinked carboxymethyl cellulose, polyacrylic acid, or a combination thereof. In some embodiments, the binder comprises crosslinked sodium alginate and polyacrylic acid or crosslinked carboxymethyl cellulose and polyacrylic acid. In one embodiment, the nanowires are silicon nanowires and the binder comprises sodium alginate. In another embodiment, the nanowires are germanium nanowires and the binder comprises PVdF. The conductive substrate of the binder comprises copper, nickel, aluminum, or chromium. The nanowires, the binder, and the conductive carbon are slurry cast onto the conductive substrate to form the anode. The anode has a discharge capacity of at least 500 mA h g⁻¹ when cycled at 2C rate. The anode has a discharge capacity retention at the 100^{th} cycle of at least 50% relative to the first cycle when cycled at a rate of C/10.

In a second aspect, the present disclosure relates to a Li-ion battery, comprising. a cathode, a separator between the anode and the cathode, and an electrolyte that comprises at least one lithium salt and at least on aprotic solvent. The lithium salt for the electrolyte of the battery comprises one or more of LiPF₆, LiAsF₆, LiClO₄, lithium tris(trifluoromethyl sulfonyl)methide, lithium tetrachloroaluminate, lithium chloride, lithium difluoro oxalato borate, LiBF₄, LiC₄BO₈, Li(C₂F₅SO₂)₂N, Li[(C₂F₅)₃PF₃], LiCF₃SO₃, LiCH₃SO₃, LiN(SO₂CF₃)₂, or LiN(SO₂F)₂. The lithium salt is present in the electrolyte at a concentration of from about 0.5 M to about 1.5 M. The aprotic solvent for the electrolyte of the battery comprises one or more of vinylene carbonate, ethylene carbonate, propylene carbonate, dimethyl carbonate, diethyl carbonate, methyl carbonate, or fluoroethylene carbonate. In some embodiments, the aprotic solvent comprises one or more fluorinated additives including fluorinated vinyl carbonate, monochloro ethylene carbonate, monobromo ethylene carbonate, 4-(2,2,3,3-tetrafluoropropoxymethyl)-[1,3]dioxolan-2-one, 4-(2,3,3,3-tetrafluoro-2-trifluoro methyl-propyl)[1,3]dioxolan-2-one, 4-trifluoromethyl-1,3-dioxolan-2-one, bis(2,2,3,3-tetrafluoro-propyl)carbonate, or bis(2,2,3,3,3-pentafluoro-propyl)carbonate. The aprotic solvent of the electrolyte of the battery comprises an about 1:1 w/w mixture of ethylene carbonate:diethyl carbonate, ethylene carbonate:dimethyl carbonate, fluoroethylene carbonate:diethyl carbonate, methyl carbonate:diethyl carbonate, methyl carbonate:dimethyl carbonate, propylene carbonate:diethyl carbonate, or propylene carbonate:dimethyl carbonate, or an about 1:1:1 w/w/w mixture of ethylene carbonate:diethyl carbonate:dimethyl carbonate, fluoroethylene carbonate:diethyl carbonate:dimethyl carbonate, methyl carbonate:diethyl carbonate:dimethyl carbonate, or propylene carbonate:diethyl carbonate:dimethyl carbonate. In some embodiments, the electrolyte further comprises from about 1 to about 5 wt. % fluoroethylene carbonate. In one embodiment, in the battery, the nanowire is silicon nanowire, the binder comprises sodium alginate, and the electrolyte comprises ethylene carbonate:diethyl carbonate with from about 1 to about 5 wt. % fluoroethylene carbonate.

In a third aspect, the anode active material for a Li-ion battery comprises nanowires comprising silicon and/or germanium. The nanowires are prepared in a supercritical fluid with a seed material without attachment to a surface and have a discharge capacity retention at the 100^{th} cycle of at least 60% relative to the first cycle at C/10. In some embodiments, the nanowires further comprising a coating of carbon. The nanowires have an average diameter of from about 1 nm to about 100 nm and an average length of greater than about 1 μm with a length to diameter aspect ratio of great than 100. In some embodiments, the seed material comprises tin and the nanowires are silicon nanowires that comprise at least 0.5 wt. % tin in the body of the nanowire. The nanowires are crystalline, amorphous with crystalline core, or amorphous nanowires. In some embodiments, the seed material comprises gold nanocrystal and the nanowires are germanium nanowires that are substantially free of gold. The nanowires comprise a silicon and germanium alloy represented by a formula Si_{y}Ge_{(1-y)} where y=0-1. In some embodiments, the nanowires further comprises a dopant. In one embodiment, the seed material comprises gold nanocrystal and the nanowires are germanium nanowires that are substantially free of gold. In some embodiments, the anode active material has a first cycle irreversible capacity loss of less than 200 mA h g⁻¹. In some embodiments, the anode active material have a discharge capacity retention at the 100^{th} cycle of at least 70% relative to the first cycle when cycled at a rate of C/10. In some embodiments, the anode active material has a discharge capacity retention at the 100^{th} cycle of at least 70% relative to the fifth cycle when cycled at a rate of C/10.

In a fourth aspect, the present disclosure relates to a method of forming nanowires in a supercritical fluid without attachment to a surface. The method comprises combining a nanowire source material and a seed material in the fluid to form a reaction mixture and injecting the reaction mixture into a preheated reactor pressurized with the fluid in a supercritical state at a predetermined rate with a closed outlet to at least double the pressure in the reactor followed by slowly cooling the reactor to room temperature to form the nanowires. The nanowire source material comprises silicon and/or germanium and the seed material comprises Au or tin. In one embodiment, the fluid is toluene and the reactor is preheated to about 450° C. In one embodiment, the source material for the method is trisilane and the seed material is Sn(HMDS)₂ having a mole ratio between 10:1 to 100:1. In one embodiment, the seed material comprises tin and the nanowires are silicon nanowires that comprise at least 0.5 wt. % tin in the body of the nanowire. The nanowires formed by the method can be crystalline, amorphous with crystalline core, or amorphous nanowires. In one embodiment, the seed material used in the method comprises gold nanocrystal with the mole ratio between the nanowire source material and the gold nanocrystal between 4:1 to 1000:1 and the nanowires are germanium nanowires that are substantially free of gold. The nanowires formed by the method can comprise a silicon and germanium alloy represented by a formula Si_{y}Ge_{(1-y)} where y=0-1. The nanowires formed by the method can have an average diameter of from about 1 nm to about 100 nm and an average length of greater than about 1 μm with a length to diameter aspect ratio of great than 100. In one embodiment, the source material used in the method is monophenylsilane and the nanowires formed has a residual polyphenylsilane shell. The method further comprises converting the polyphenylsilane shell into a coating of graphitic carbon in a reducing environment to form nanowires with a graphitic carbon coating. The seed material used in the method can comprise Sn, Pb, Bi, Ag, Ni, Au, or a combination thereof.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 shows the total charge capacity, Qtot, of a Li-ion battery depends on the capacities of both the cathode and anode, Qcat and Qan.

FIG. 2A, FIG. 2B, FIG. 2C, FIG. 2D, FIG. 2E, FIG. 2F, FIG. 2G, and FIG. 2H show the results from SEM, TEM, and XRD analysis of Si nanowires formed by the method of Example 1 with or without removal of Au.

FIG. 3A, FIG. 3B, FIG. 3C, and FIG. 3D show discharge capacity cycle and percentage capacity retention data for batteries prepared in Example 2.

FIG. 4A and FIG. 4B show charge capacity (Q) measured at the indicated cycle rates for Si nanowire anodes with NaAlg binder and various electrolyte with and without Au in the anode of Example 2.

FIG. 5A, FIG. 5B, FIG. 5C, and FIG. 5D show battery performance data for Si nanowires (no Au etching) with NaAlg binder and various electrolyte of Example 2.

FIG. 6A and FIG. 6B show battery performance data for Si nanowires with Au removed, NaAlg binder and various electrolyte of Example 2.

FIG. 7A, FIG. 7B, FIG. 7C, FIG. 7D, FIG. 7E, FIG. 7F, FIG. 7G, and FIG. 7H show first cycle voltage profiles and differential capacity curves of the batteries of Example 2.

FIG. 8A and FIG. 8B show influence of cycle rate on the differential capacity of Si nanowire anodes with Au removed of Example 2.

FIG. 9A, FIG. 9B, FIG. 9C, FIG. 9D, and FIG. 9E show SEM and TEM images and XRD data of the Ge nanowires and Ge nanowire anode produced in Example 3.

FIG. 10A and FIG. 10B show the discharge capacity and capacity retention of batteries 1-6 of example 4 cycled between 0.01 and 2 V vs Li/Li+ at a rate of C/10.

FIG. 11A, FIG. 11B, FIG. 11C, FIG. 11D, and, FIG. 11E show (i) charge and discharge capacities plotted with Coulombic efficiencies, (ii) voltage profiles and (iii) corresponding differential capacity curves for Ge nanowire batteries a-e correspond to the battery data in FIG. 10A and FIG. 10B.

FIG. 12A shows the first cycle charge and discharge capacity between 0.01 to 1.0 V and FIG. 12B shows differential capacity plots for Ge nanowire batteries a-e correspond to the battery data in FIG. 10A and FIG. 10B.

FIG. 13A, FIG. 13B, FIG. 13C, FIG. 13D, and FIG. 13E show differential capacity (panels i and iii) color maps and (panel ii) waterfall plots for Ge nanowire batteries a-e correspond to the battery data in FIG. 10A and FIG. 10B.

FIG. 14 shows discharge capacity of batteries a-f of Example 4 cycled at different rates.

FIG. 15A, FIG. 15B, FIG. 15C, FIG. 15D, and FIG. 15E show (i) charge and discharge capacity (Q), Coulombic efficiency, (ii) voltage profiles, and (iii) differential capacity of batteries a-e correspond to the battery data in FIG. 14.

FIG. 16A and FIG. 16B show differential capacity (panels i and iii) color maps and (panel ii) waterfall plots for Ge nanowire batteries a-e correspond to the battery data in FIG. 14.

FIG. 17A shows charge and discharge capacity Q for battery c of Example 4 charged at a rate of 1C and discharged at various rates. FIG. 17B and FIG. 17C show the voltage profiles and differential capacity curves corresponding to the cycle data in FIG. 17A.

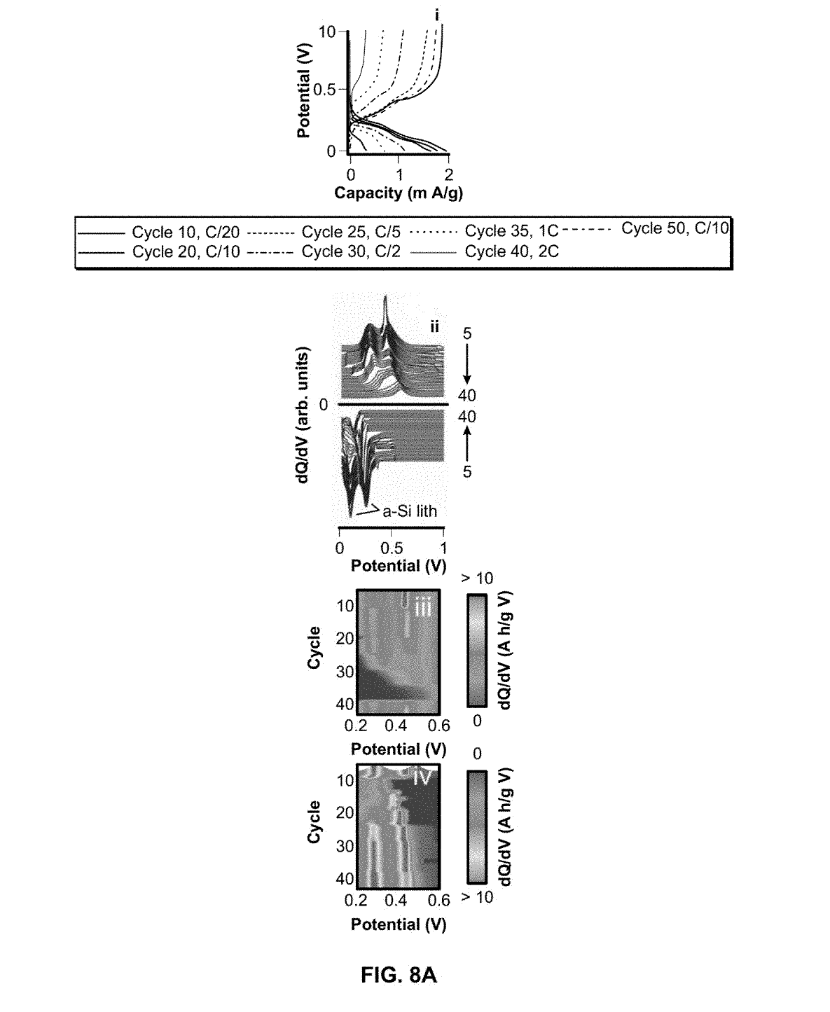

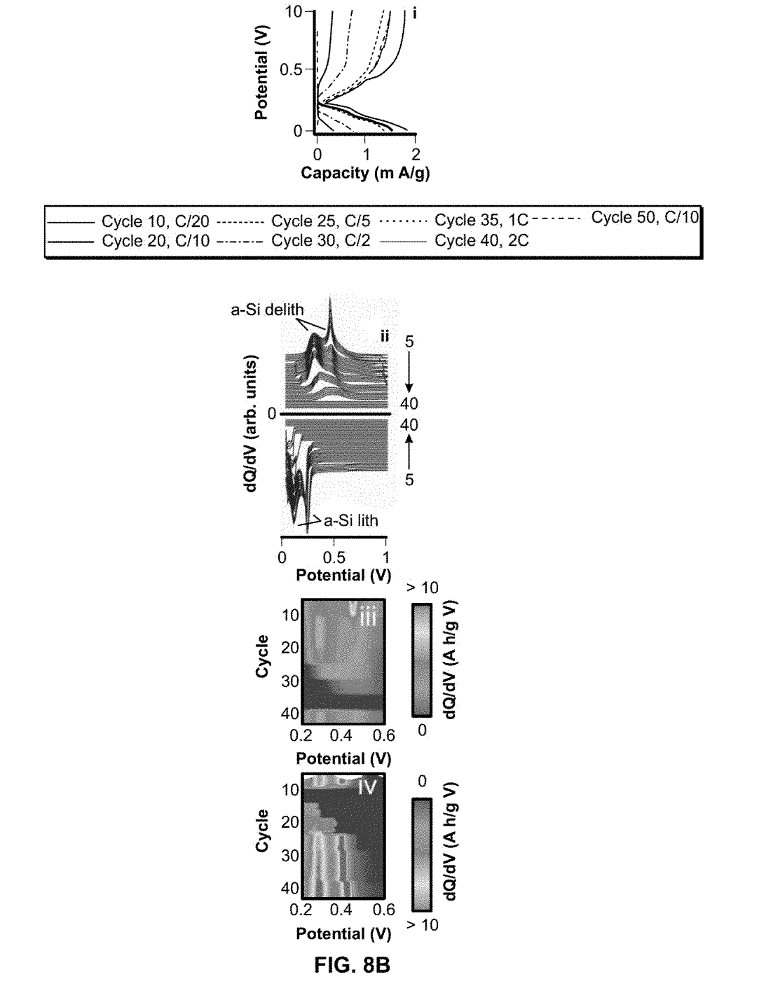

FIG. 8A shows long term cycle stability of battery c and FIG. 18B shows long term cycle stability of battery d of Example 4.

FIG. 19A is a Si—Sn phase diagram and illustration of the Sn-seeded Si nanowire growth pathway by in situ decomposition of Sn(HMDS)₂ and Si₃H₈; FIG. 19B shows SEM image of silicon nanowires obtained using Sn:Si ratios of 1:400 of Example 5.

FIG. 20A, FIG. 20B, FIG. 20C, FIG. 20D, FIG. 20E, FIG. 20F, FIG. 20G, and FIG. 20H show SEM, TEM and XRD analysis of Si nanowires formed by Sn-seeded SFLS growth from trisilane with Si:Sn mole ratio of 20:1 of Example 5.

FIG. 21A, FIG. 21B, FIG. 21C, and FIG. 21D show SEM and TEM data for crystalline-amorphous core-shell Si nanowires of Example 5.

FIG. 22A, FIG. 22B, FIG. 22C, FIG. 22D, and FIG. 22E show the phase diagrams for Au and Si and the growth process of nanowires.

FIG. 23 shows TEM data for amorphous Si nanowires of Example 5.

FIG. 24A, FIG. 24B, and FIG. 24C show dark field STEM images of (FIG. 24A a) Sn-seeded crystalline-amorphous core-shell Si nanowires, (FIG. 24B b) Sn-seeded Si nanowires, and (FIG. 24C c) Au-seeded Si nanowires of Example 5.

FIG. 25A, FIG. 25B, FIG. 25C, FIG. 25D, FIG. 25E, and FIG. 25F show the cycling results from Sn-seeded Si nanowires of example 5 assembled in the batteries of example 6 in various electrolytes solvents.

FIGS. 26Ai, 26Bi, 26Ci, 26Di, and 26Ei show charge and discharge capacities plotted with Coulombic efficiencies, (ii) FIGS. 26Aii, 26Bii, 26Cii, 26Dii, and 26Eii show voltage profiles and (iii) FIGS. 26Aiii, 26Biii, 26Ciii, 26Diii, and 26Eiii show corresponding differential capacity curves for Ge nanowire batteries a-e correspond to the battery data in FIG. 25A, FIG. 25B, FIG. 25C, FIG. 25D, FIG. 25E, and FIG. 25F.

FIG. 27A, FIG. 27B, FIG. 27C, FIG. 27D, and FIG. 27E show differential capacity (panels i and iii) color maps and (panel ii) waterfall plots correspond to the battery data in FIG. 25A-25F.

FIG. 28A and FIG. 28B show discharge capacity of batteries of Example 6 cycled at different rates.

FIGS. 29Ai, 29Bi, 29Ci, 29Di, and 29Ei show charge and discharge capacity (Q), Coulombic efficiency, FIGS. 29Aii, 29Bii, 29Cii, 29Dii, and 29Eii show (ii) voltage profiles, and (iii) FIGS. 29Aiii, 29Biii, 29Ciii, 29Diii, and 29Eiii show differential capacity of batteries of Example 6 correspond to the battery data in FIG. 28A and FIG. 28B.

FIG. 30A, FIG. 30B, FIG. 30C, FIG. 30D, and FIG. 30E show differential capacity (panels i and iii) color maps and (panel ii) waterfall plots for batteries of Example 6 correspond to the battery data in FIG. 28A and FIG. 28B.

FIG. 30A, FIG. 30B, and FIG. 30C show the capacity cycle data for crystalline, crystalline-amorphous core-shell, and amorphous Si nanowires of Example 7.

### DETAILED DESCRIPTION

The materials, compounds, compositions, articles, devices, and methods described herein may be understood more readily by reference to the following detailed description of specific aspects of the disclosed subject matter and the Examples included therein and to the Figures.

Before the present materials, compounds, compositions, articles, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

### Li-Ion Battery

Li-ion batteries comprise a cathode, an anode, and an electrolyte. In most Li-ion batteries, the anode is graphite (Goodenough Chem. Mater. 2009, 22, 587-603; Hayner et al., Annu. Rev. Chem. Biomol. Eng. 2012, 3, 445-471). Si has been explored as an alternative anode material but has limited utility due to its significant volume expansion upon lithium uptake. Si nanomaterials have been reported to tolerate these changes. (See e.g., Yao et al., Nano Lett. 2011, 11, 2949-2954; Zhang et al., J. Electrochem. Soc. 2007, 154, A910-A916; Ryu et al., J. Mech. Phys. Solids 2011, 59, 1717-1730; Kim et al., Nano Lett. 2008, 8, 3688-3691; Gao et al., Adv. Mater. 2001, 13, 816-819; Huang et al., Appl. Phys. Lett. 2009, 95, 133119; Cui et al., Nano Lett. 2008, 9, 491-495; Ruffo et al., J. Phys. Chem. C 2009, 113, 11390-11398; Kang et al., Appl. Phys. Lett. 2010, 96, 053110; Cho et al., J. Phys. Chem. C 2011, 115, 9451-9457; Föll et al., ECS Trans. 2010, 33, 131-141; Chakrapani et al., J. Phys. Chem. C 2011, 115, 22048-22053; Hu et al., Chem. Commun. 2010, 47, 367-369; Chockla et al., J. Am. Chem. Soc. 2011, 133, 20914-20921; Laïk et al., Electrochim. Acta 2008, 53, 5528-5532; Peng et al., Appl. Phys. Lett. 2008, 93, 033105; Chan et al., ACS Nano 2010, 4, 1443-1450; Chan et al., J. Power Sources 2009, 189, 34-39; Liu et al., Nano Lett. 2011, 11, 2251-2258.) However, the integrity of the entire battery must also be preserved, which leads to challenges in formulating the anode. For instance, one of the most common binders, polyvinylidene fluoride (PVdF), is too stiff and not sufficiently adherent to Si to prevent battery failure. Alternative binders like polyacrylic acid (PAA), carboxymethyl cellulose (CMC) and sodium alginate (NaAlg) on the other hand have shown relatively good results (Kovalenko et al., Science 2011, 334, 75-79; Mazouzi et al., Electrochem. Solid St. 2009, 12, A215-A218; Magasinski et al., ACS Appl. Mater. Interfaces 2010, 2, 3004-3010; Bridel et al., Chem. Mater. 2009, 22, 1229-1241; Komaba et al., J. Phys. Chem. C 2012, 116, 1380-1389; Ge et al., Nano Lett. 2012, 12, 2318-2323).

The solid-electrolyte interphase (SEI) layer chemistry and formation is also not the same on Si as it is on graphite. For Si, fluorinated solvents like fluoroethylene carbonate (FEC) and other alternatives like 1,3-dioxolane have been shown to have stabilizing effects on Si (Etacheri et al., Langmuir 2012, 28, 965-976; Choi et al., J. Power Sources 2006, 161, 1254-1259; Nakai et al., J. Electrochem. Soc. 2011, 158, A798-A801; Etacheri et al., Langmuir 2012, 28, 6175-6184). Good results have been demonstrated with thicker Si anodes made with commercially available Si powder added to more conventional slurry formulations. (See e.g., Kovalenko et al., Science 2011, 334, 75-79; Urbonaite et al., J. Power Sources 2010, 195, 5370-5373; Graetz et al., Electrochem. Solid St. 2003, 6, A194-A197; Ding et al., J. Power Sources 2009, 192, 644-651; Kim et al., Angew. Chem. Int. Ed. 2008, 47, 10151-10154). However, long-term capacity fade is still a significant obstacle and methods for achieving interface and mechanical stability are desired.

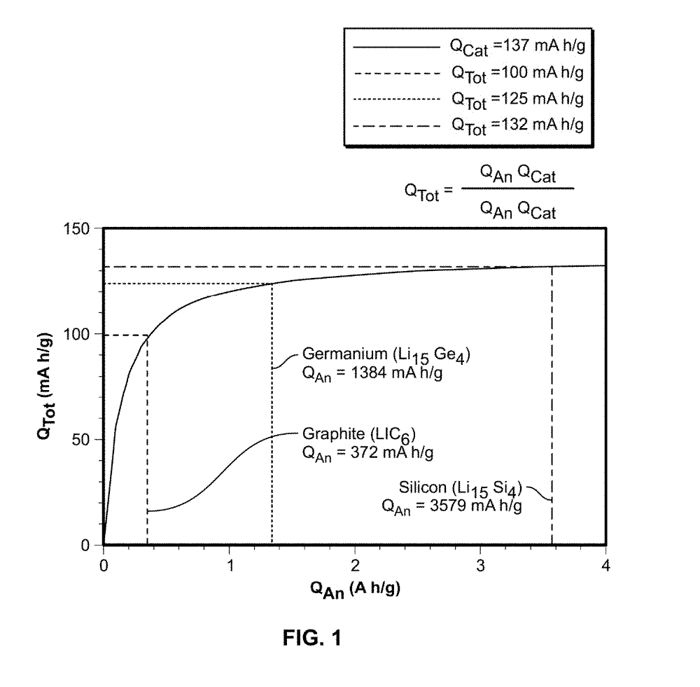

In addition to Si, Ge has also been explored as a replacement for the graphite anode of Li-ion batteries. While Ge has a lower maximum capacity for Li than Si (1,384 mA h g⁻¹ vs. 3,579 mA h g⁻¹), it is still much higher than graphite. Furthermore the current capacity is limited by the capacity of the cathode. For example, as shown in FIG. 1, either Si or Ge would increase the total battery capacity by about 25% for Lithium cobalt cathode material that have a Qtot of about 132 mA h g⁻¹. Si and Ge also have similar volumetric capacity, 7,366 A h L⁻¹ for Ge (based on Li₁₅Ge₄) and 8,334 A h L⁻¹ for Si (based on Li₁₅Si₄). Ge also has some advantages over Si. It is more electrically conductive than Si because of its lower band gap, which provides for more efficient charge injection, especially in thicker anodes. Li diffusion is 400 times faster in Ge than in Si, providing Ge with much higher rate capability than Si (and graphite), which is extremely important in electric vehicle applications that require very high discharge power. There is also evidence that Ge anodes are more stable than Si anodes: Si and Ge both expand considerably upon lithiation (280% for Si and 240% for Ge), but the lithiation pathways are different, with Si lithiation being highly anisotropic and Ge lithiation occurring isotropically (Liu et al., Adv. Energy Mater. 2012, DOI: 10.1002/aenm.201200024).

Ge thin films (Wang et al., J. Mater. Chem. 2011, 22, 1511-1515; Baggetto et al., J. Electrochem. Soc. 2009, 156, A169-A175; Graetz et al., J. Electrochem. Soc. 2004, 151, A698-A702; Hwang et al., Thin Solid Films 2010, 518, 6590-6597; Laforge et al., J. Electrochem. Soc. 2008, 155, A181-A188; Wang et al., Mater. Lett. 2011, 65, 1542-1544; Baggetto et al., Electrochim. Acta. 2010, 55, 7074-7079; DiLeo et al., J. Phys. Chem. C 2011, 115, 22609-22614) nanoparticles (Id.; Cheng et al., CrystEngComm 2012, 14, 397-400; Xue et al., J. Am. Chem. Soc. 2012, 134, 2512-2515), nanowires (Seo et al., Energy Environ. Sci. 2011, 4, 425-428; Liu et al., Nano Lett. 2011, 11, 3991-3997; Ko et al., Nanoscale 2011, 3, 3371-3375; Chan et al., Nano Lett. 2007, 8, 307-309; Chockla et al., J. Phys. Chem. C 2012, ASAP contents), and nanotubes (Park et al., Angew. Chem. Int. Ed. 2011, 50, 9647-9650), have been studied as anodes in Li-ion batteries with good results. However, the thickness of the Ge layer was relatively thin.

Disclosed herein are Li-ion batteries wherein the anode comprises a layer of silicon or germanium nanowires on a conductive substrate.

Anode

Nanowires

The Li-ion batteries disclosed herein contain an anode that comprises a layer of silicon and/or germanium nanowires on a conductive substrate. The layers of nanowires are thick in comparison to other attempts to use Si or Ge materials in the anode and are achieved by the method disclosed herein. For example, the layer of nanowires can be greater than about 10 μm, greater than about 15 μm, greater than about 20 μm, or greater than about 25 μm. Such thick layers of nanowires of Si or Ge allow the disclosed anodes to have higher energy density, better performance, and longer stability than previously available. Also, the disclosed methods are more economical.

The amount of nanowires on the conductive substrate can be expressed in terms of mg of nanowires per cm² of the conductive substrate. For example, the amount of nanowires on the conductive substrate can be from about 0.1 mg cm⁻² to about 1.5 mg cm⁻². For example, the amount of nanowires on the conductive substrate can be from about 0.2 mg cm⁻² to about 1.25 mg cm⁻², from about 0.25 mg cm⁻² to about 1.1 mg cm⁻², from about 0.5 mg cm⁻² to about 1.0 mg cm⁻², or from about 0.5 mg cm⁻² to about 0.75 mg cm⁻².

The nanowires are not nanoparticles in that their average length is much longer than their diameter. The nanowires disclosed herein have a length to diameter aspect ratio of at least 100, for example, at least 100, at least 1000 or, at least 10,000. For example, the nanowires disclosed herein have an average diameter of about 1 nm to about 100 nm and an average length of greater than about 1 μm. In other examples, the nanowires disclosed herein can have an average diameter of from about 60 nm and an average length of at least about 1 μm. In other examples, the disclosed nanowires have an average diameter of from about 10 nm to about 100 nm, from about 20 nm to about 90 nm, from about 30 nm to about 70 nm, from about 40 nm to about 60 nm, or from about 50 to about 70 nm, and an average length of at least about 1 μm, 5 μm, 10 μm, 30 μm, 50 μm, or 70 μm. In some embodiments the nanowires has a diameter in the range from 10 to 50 nm with an average length of 100 μm. The nanowires are also not an anisotropic or amorphous powder of silicon. In some examples, the nanowires can be substantially free of (e.g., less than 0.1 wt. %) metals like gold, aluminum, iron, nickel, manganese, cobalt, copper, silver, tin, or chromium. On other examples, however, the nanowires can be gold-seeded or tin-seeded nanowires and thus can contain a molar ratio of from about 20:5, 20:4, 20:3, 20:2, 20:1, 20:0.5, 20:0.1, or 20:0.05 Si to Sn or Au. For example, the gold-seeded or tin-seeded nanowires can contain gold or tin at about 25, 20, 15, 10, 5, 2, 1, 0.5, or 0.1 mole %, where any of the stated values can form an upper or lower endpoint of a range. The tin-seeded nanowires can also contain tin at each end of the nanowire. In addition to gold or tin-seeded nanowires, other metals can be used for seeding, such as Pb, Bi, Ag, Ni. As such, the disclosed nanowires can be lead, bismuth, silver or nickel-seeded silicon nanowires.

The nanowires disclosed herein can be a mixture of silicon and germanium represented by formula Si_{y}Ge_{1-y}, where y ranges from 0 to 1. For example, the nanowires disclosed herein can be silicon with a germanium shell or vice versa. Further, the nanowires disclosed herein can be an alloy of silicon and germanium, with or without residual gold or tin as detailed herein. Still further, the nanowires can be silicon and/or germanium nanowires with a graphitic shell.

When preparing the anode, the nanowires disclosed herein are slurry cast onto the conductive substrate. This method results in a different configuration of the nanowires in the anode. For example, the slurry casting of the nanowires does not root (attach) the nanowires as growing them on the conductive substrate. As such, the disclosed nanowires are not substantially rooted to the conductive substrate. By “not substantially rooted” is meant that there is less than 2% of the nanowires that are covalently or ionically attached to the conductive substrate. Also, the slurry casting of the nanowires produces a network of intertwined nanowires on the conductive substrate. Thus, the nanowires are not substantially aligned (e.g., like a forest of trees) on the conductive substrate. Instead, the layer contains nanowires that are substantially intertwined with one another. By “substantially intertwined” is meant that at least about 90% of the nanowires are randomly intertwined with each other.

Conductive Carbon

The layer of nanowires can optionally contain conductive carbon mixed with the nanowires. Conductive carbon includes, for example carbon black, graphene, graphite, carbon nanotubes, or a mixture thereof. The layer can comprise about 3.5:1 w/w Si or Ge to conductive carbon. For example, the layer can comprises from about 2:1, 2.5:1, 3:1, 3.5:1, 4:1, or 4.5:1 w/w Si or Ge to conductive carbon. Thus, the predominate component in the layer are the Si or Ge nanowires and not conductive carbon. Various other conductive additives to provide the electrical conductivity needed for efficient charging and discharging have also been tested in thick Si nanowire films. Chan et al., (ACS Nano 2010, 4, 1443-1450) mixed Si nanowires with conductive multiwall carbon nanotubes, graphene has been used as a conductive and structural host for Si nanowires (Chockla et al., J. Phys. Chem. C 2012, 116, 11917-11923). Additionally, Si nanowires have been coated with thin carbon layers by thermal decomposition of polyphenylsilane coating as disclosed in Chockla et al., J. Am. Chem. Soc. 2011, 133, 20914-20921, incorporated herein by reference for its teaching of graphitic carbon coating formation on nanowires. Specifically, when Si nanowires grown by the SFLS process with monophenylsilane as a reactant, a thin polyphenylsilane shell forms on the surface of the nanowires. The polyphenylsilane shell can be converted to a graphitic coating in a reducing environment to form nanowires with a coating of graphitic carbon. Si nanowires with graphitic carbon coating do not further require additional conductive carbon when used as anode active material. The graphitic carbon coating on the nanowires ranges from 1-100 nm (e.g. 2-50 nm, 5-10 nm) in thickness covering the nanowires. These batteries all had lower capacity and more capacity fade than the best results using Si powder. The conductive carbon containing slurries disclosed herein, however, were found to have much better performance. The references disclosed in this paragraph are incorporated by reference for their teaching of methods combining conductive carbon with Si nanowires.

Binder

The layer of nanowires can optionally contain a binder. The binder can be polyvinylidene fluoride (PVdF), sodium alginate (NaAlg), polyacrylic acid (PAA), carboxymethylcellulose (CMC), sodium CMC, polyacylamide, styrene-butadiene copolymers (SBR), crosslinked sodium alginate and polyacrylic acid, or crosslinked carboxymethyl cellulose and polyacrylic acid.

Dopant

The lay of nanowires can also optionally contain a dopant to alter the electrical properties of the nanowires. For example, the disclosed nanowires can contain a p-type dopant or n-type dopant. In further examples, dopants such as Al, As, B, Ga, In, P, Sb, or Ti can be used. In some specific examples, the dopant can be B₂H₆, GaH₃, GaCl₃, Ga₂Cl₆, PH₃, POCl₃, AsH₃, SbH₃, or SbF₃.

Methods of Making Nanowires

Typical vacuum-based vapor-liquid-solid (VLS) growth by chemical vapor deposition (CVD) from substrates yields miniscule amounts of nanowires (around a few micrograms) (Ruffo et al., J. Phys. Chem. C 2009, 113, 11390-11398; Kang et al., Appl. Phys. Lett. 2010, 96, 053110; Chakrapani et al., J. Phys. Chem. C 2011, 115, 22048-22053; Laïk et al., Electrochim. Acta 2008, 53, 5528-5532). Solution-based processes on the other hand can yield the significant quantities needed for battery electrodes (>100 mg in laboratory-scale supercritical fluid-liquid-solid [SFLS] reactions for example) (Heitsch et al., Chem. Mater. 2011, 23, 2697-2699). Thus, in one aspect the nanowires used herein are prepared by a solution-based process rather than a vacuum or vapor-based process.

Although similarities between particle- and nanowire-based anodes might be expected (since Si or Ge is the active material), there are substantial differences because, unlike collections of particles, nanowires can form mechanically robust, flexible and even self-supporting films to be used in anodes. This helps provide longer term cycle stability. In fact, nanowire material based anodes have been shown to be able to function even without stabilizing binder (Chockla et al., J. Am. Chem. Soc. 2011, 133, 20914-20921).

For Si, the nanowires disclosed herein can be prepared by injecting a mixture comprising a silicon source like trisilane and gold nanocrystals into supercritical toluene. Supercritical toluene can be produced by heating toluene to 450° C. at a pressure of about 6.9 MPa. After cooling, the nanowires can be extracted with toluene, centrifuged, and isolated. Further washing in toluene and drying can also be performed. As an alternative to toluene, other solvents can be used such as hexane, benzene, xylene, and the like.

It can also be desired to remove any residual gold from the Si nanowires. For this, a two step process for removing gold can be employed. First, the nanowires can be etched by contacting the nanowires in an organic solvent with an etching solution comprising an aqueous HF solution. The resulting etched nanowiers can be isolated and then treated with aqua regia (a 1:3 v/v soluion of nitric acid and hydrochloric acid) to remove the gold. The aqua regia can be removed and the nanowires, which are substantially free of gold, can be isolated and washed.

Tin (Sn)-seeded Si nanowires are an alternative to Au-seeded Si nanowires. To avoid Au contamination, a Sn-seeded supercritical fluid-liquid-solid (SFLS) synthesis of Si nanowires was developed and is disclosed herein. Sn forms a low temperature (232° C.) eutectic with Si and also has a relatively high lithium storage capacity of 992 mA h g⁻¹. The SFLS process is a solution-phase approach based on the vapor-liquid-solid (VLS) mechanism that can produce significant quantities of nanowires since reactions can be carried out continuously in the bulk volume of a reactor. In the SFLS synthesis, the metal seed particles are synthesized and then injected into the SFLS reactor along with the Si source. In this case, however, Sn seed particles are generated in situ in the reactor by simultaneously injecting a reactant for Sn along with trisilane, the Si reactant. This approach eliminates a nanocrystal synthesis step and the possible oxidation of Sn that can occur during transfer of the seed particles to the reactor. Thus, disclosed herein the Si nanowires can be prepared by injecting a mixture comprising a silicon source like trisilane and an organotin compound into supercritical toluene. Examples of organotin compounds that can be used include bis(bis(trimethylsilylamino)tin, tin bis(hexamethyldisilazide). After cooling, the nanowires can be extracted with toluene, centrifuged, and isolated. Further washing in toluene and drying can also be performed.

As noted, other metals can also be used for seeding the generation of the silicon nanowires. For example, Pb, Bi, Ag, or Ni can be used.

For Ge, the nanowires can be prepared by heating a mixture comprising a germanium source like diphenylgermanium (DPG) and gold nanocrystals in a reaction medium that is a high boiling hydrophobic liquid, such as squalane or other terpenes. These methods produce large amounts of Ge nanowires using a colloidal solution-phase process.

Conductive Substrate

In the anodes disclosed herein, the nanowires are coated on to a conductive substrate. The conductive substrate can be copper, nickel, aluminum, chromium, boron, cadmium, cobalt, gallium, gold, hafnium, iron, indium, manganese, molybdenum, niobium, palladium, platinum, silver, tantalum, tin, titanium, tungsten, vanadium, zinc, or zirconium, including alloys of and from such materials. In other examples, the conductive substrate can comprise indium tin oxide (ITO), fluorine tin oxide (FTO), indium zinc oxide (IZO), or molybdenum oxide. Glassy carbon, metal oxides, CsCO₃, metal borides, metal carbides, graphite, graphene, graphene oxide, nickel mesh, carbon mesh, and the like can also be used. In other examples, the conductive substrate can comprise an aluminum alloy, a silver alloy, a copper alloy, lithium alloy, a molybdenum alloy, a chromium/aluminum-neodymium alloy, or a molybdenum/aluminum alloy. Generally, any substrate material used in Li-ion anodes can be used herein as the conductive substrate for the nanowires.

The nanowires can be applied on to the conductive substrate as slurry-cast films. This method also can be modified by including conductive carbon with the nanowires (e.g., 3.5:1 w/w Si or Ge to carbon). The anodes are made by mixing the nanowires in a liquid media, with optional binder, conductive carbon, and/or dopants into a slurry (paste) and casting this onto the conductive substrate. The slurry can comprise a combination of the nanowires, binders, conductive carbon, and/or dopants disclosed herein. Casting the slurry is accomplished for example by pumping this slurry to a coating machine. The coating machines spread the mixed slurry (paste) on one or both sides of the conductive substrate to form a coated substrate. The coated substrate is subsequently calendared to make the electrode thickness more uniform, followed by a slitting operation for proper electrode sizing. In some embodiments, the binder of the anode is annealed (heat-treated) on the conductive substrate. For example, PVdF binder is heat treated on the anode.

Cathode

The cathode of the disclosed Li-ion battery can be made from lithium cobalt dioxide (LiCoO₂), lithium manganese dioxide (LiMnO₂), a mixed lithium metal oxide, a lithium phosphate, a lithium fluorophosphates, a lithium silicate, or layers of any combination of these. Lithium-containing mixed metal oxides examples include lithium-rich metal oxide represented by formula Li₁₊ₓM₁₋ₓO₂ where M=Mn,Ni,Co and 0≤x<0.3, LiNiₓCo₍₁₋₂ₓ₎MnO₂ (0≤x<0.5), LiNi_{0.5}Mn_{1.5}O₄, Li(Ni_{0.8}Co_{0.15}Al_{0.0.5})O₂, LiMn₂O₄. Lithium phosphates examples include iron olivine (LiFePO₄) and its variants (such as LiFe₁₋ₓMgPO₄ (0≤x<1), LiMoPO₄, LiCoPO₄, LiNiPO₄, Li₃V₂(PO₄)₃, LiVOPO₄, LiMP₂O₇, or LiFe_{1.5}P₂O₇. Lithium fluorophosphates examples include LiVPO₍₄₎F, LiAlPO₍₄₎F, Li₍₅₎V(PO₍₄₎)₍₂₎F₍₂₎, Li₍₅₎Cr(PO₍₄₎)₍₂₎F₍₂₎, Li₍₂₎CoPO₍₄₎F, or Li₍₂₎NiPO₍₄₎F. Lithium silicates examples include Li₂FeSiO₄, Li₂MnSiO₄, or Li₂VOSiO₄.

Electrolyte

The electrolyte of the disclosed Li-ion battery comprises at least one lithium containing salt and at least one aprotic solvent. The electrolyte is in contact with the cathode and anode of the battery. Suitable salts for example include LiPF₆, LiAsF₆, LiClO₄, lithium tris(trifluoromethyl sulfonyl)methide, lithium tetrachloroaluminate, lithium chloride, lithium difluoro oxalato borate, LiBF₄, LiC₄BO₈, Li(C₂F₅SO₂)₂N, Li[(C₂F₅)₃PF₃], LiCF₃SO₃, LiCH₃SO₃, LiN(SO₂CF₃)₂, and LiN(SO₂F)₂. Generally, the salt is present in the electrolyte at about 1.0 M, though concentrations of from about 0.5 M to about 1.5 M can be used. Aprotic solvents examples include alkyl carbonates or cyclic alkylcarbonate such as ethylene carbonate (EC), propylene carbonate (PC), dimethyl carbonate (DMC), diethyl carbonate (DEC), methyl carbonate (MC), fluoroethylene carbonate (FEC), and the like.

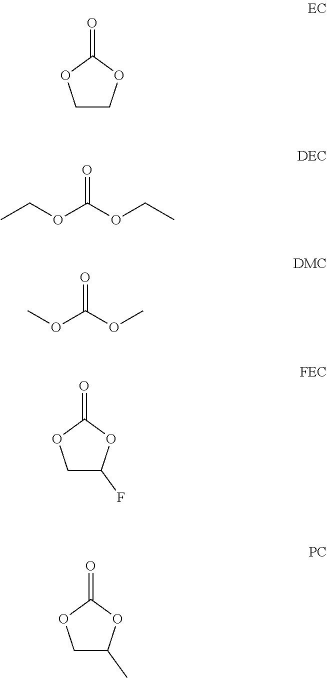

In some aspects, the aprotic solvent comprises a fluorinated compound such as FEC. In further examples, the electrolyte further comprises combinations of these aprotic solvents, such as an about mixtures of EC:DEC, EC:DMC, FEC:DEC, FEC:DMC, MC:DEC, MC:DMC, PC:DEC, or PC:DMC, or an mixture of EC:DEC:DMC, FEC:DEC:DMC, MC:DEC:DMC, or PC:DEC:DMC. Any of these combinations of aprotic solvents can further include small amounts (from about 1 to about 5 wt. %) of fluorinated solvent additive such as FEC. For example, a suitable aprotic solvent system for the electrolyte comprises EC:DEC, EC:DMC, MC:DEC, MC:DMC, PC:DEC, or PC:DMC with about 3% FEC. Additional fluorinated additives include, for example, fluorinated vinyl carbonate, monochloro ethylene carbonate, monobromo ethylene carbonate, 4-(2,2,3,3-tetrafluoropropoxymethyl)-[1,3]dioxolan-2-one, 4-(2,3,3,3-tetrafluoro-2-trifluoro methyl-propyl)-[1,3]dioxolan-2-one, 4-trifluoromethyl-1,3-dioxolan-2-one, bis(2,2,3,3-tetrafluoro-propyl)carbonate, bis(2,2,3,3,3-pentafluoro-propyl)carbonate, or mixtures thereof.

The Li-ion battery can also contain a separator. The separator is located between the positive electrode and the negative electrode. The separator is electrically insulating while providing for at least selected ion conduction between the two electrodes. A variety of materials can be used as separators. For example, the separator can be a solid polymer such as a polyolefin like polypropylene or polyethylene, or combinations thereof. Glass fibers formed into a porous mat can be used as a separator. Commercial separator materials are generally formed from polymers, such as polyethylene and/or polypropylene that are porous sheets that provide for ionic conduction. Commercial polymer separators include, for example, the Celgard® line of separator material from Hoechst Celanese, Charlotte, N.C. Also, ceramic-polymer composite materials have been developed for separator applications. These composite separators can be stable at higher temperatures, and the composite materials can significantly reduce the fire risk. Polymer-ceramic composites for lithium ion battery separators are sold under the trademark SEPARION™ by Evonik Industries, Germany.

The lithium ion batteries disclosed herein can be assembled by techniques known in the art using the anodes disclosed herein. Devices containing the lithium ion batteries and/or anodes disclosed herein are also disclosed. For example, any device that operates on energy supplied, in whole or in part, from a Li-ion battery can use the Li-ion batteries disclosed herein. To name but a few examples, disclosed are photovoltaic devices, field effect transistors, mobile telecommunication devices, laptop and tablet computers, medical devices, electronic toys, water desalination devices, watches, lights, and the like that contain a Li-ion battery as disclosed herein.

In the anode active material disclosed herein, the nanowire comprises LiₓSi, LiₓGe, or a combination thereof where x ranges from 0 to 4.4. In one example, the nanowire comprises Liₓ(Si_{y}Ge_{1-y}), where x ranges from 0 to 4.4 and y ranges from 0 to 1.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present disclosure which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

All reagents and solvents were used as received without further purification. Dodecanethiol (DDT, ≥98%), tetrachloroaurate trihydrate (≥99.9%), sodium borohydride (≥98%), toluene (anhydrous, 99.8%), propylene carbonate (PC, anhydrous, 99.7%), ethanol (EtOH, 99.9%), tetraoctylammonium bromide (TOAB, 98%), lithium hexafluorophosphate (LiPF₆, ≥99.99%), polyvinylidene fluoride (PVdF, avg MW about 534,000 by GPC), alginic acid sodium salt (NaAlg), 1-methyl 2-pyrrolidinone (NMP, 99.5%), chloroform (99.8%), squalane (99%), and bis(bis(trimethylsilyl)amino)tin ((CH3)₃Si]2N]2Sn or Sn bis(hexamethyldisilazide), Sn(HMDS)₂, lot 10396PKV) were purchased from Sigma-Aldrich. Trisilane (Si₃H₈, 100%) was purchased from Voltaix. Diphenyl germane (DPG, ≥95%) was purchased from Gelest. Conductive carbon super C65 was supplied by TIMCAL. Hydrofluoric acid (HF, 48%) was purchased from EMD Chemicals. Hydrochloric (HCl, 12.1 N) and nitric (HNO₃, 15.8 N) acids were purchased from Fisher. Dimethyl carbonate (DMC, ≥99%, anhydrous) and diethyl carbonate (DEC, ≥99%, anhydrous) were purchased from Sigma. Fluoroethylene carbonate (FEC, ≥98%) was obtained from TCI America. Electrolyte solutions of 1.0 M LiPF₆ in 1:1 w/w ethyl carbonate (EC):diethyl carbonate (DEC) and 1.0 M LiPF₆ in 1:1 w/w EC:dimethyl carbonate (DMC) were purchased from Novolyte and EMD Chemicals, respectively. Electrolyte solutions were also prepared by dissolving LiPF₆ at a concentration of 1.0 M in 1:1 w/w mixtures of FEC:DEC or FEC:DMC. Another electrolyte solution was made by adding 3% w/w FEC to 1:1 w/w EC:DMC. Celgard 2400 membranes (25 μm) were purchased from Celgard and Li metal foil (1.5 mm, 99.9%) from Alfa Aesar. Dodecanethiol-capped Au nanocrystals (2 nm diameter) were synthesized following Saunders et al., J. Phys Chem. B 2003, 108, 193-199, and stored in a nitrogen-filled gloved box dispersed in toluene at a concentration of 50 mg mL⁻¹ prior to use.

Scanning electron microscopy (SEM) images were acquired using a Zeiss Supra 40 SEM with an in-lens arrangement, a working voltage of 5 keV and a working distance of 5 mm. Transmission electron microscopy (TEM) images were digitally acquired using either a FEI Tecnai Spirit BioTwin TEM operated at 80 kV or a field emission JEOL 2010F TEM operated at 200 kV. TEM samples were prepared by drop-casting from chloroform dispersions onto 200 mesh lacey-carbon copper TEM grids (Electron Microscopy Sciences).

Energy-dispersive X-ray spectroscopy (EDS) was performed with an Oxford Inca EDS detector on the JEOL 2010F TEM. X-ray diffraction (XRD) was performed with a Rigaku R-Axis Spider Diffractometer with Image plate detector with Cu-k_{α} (λ=1.5418 Å) radiation operated at 40 kV and 40 mA. Samples were measured on a 0.5 mm nylon loop, scanning for 10 min with 1° per second sample rotation under ambient conditions. The diffraction data were integrated with subtraction of the background scattering from the nylon loop.

Galvanostatic measurements were made using an Arbin BT-2143 test unit with cycling between 0.01 and 2 V vs Li/Li⁺. Capacities are reported based on the active material only and the rates are reported based on the theoretical capacity of Si, i.e., 1C=3,579 mA h g⁻ⁱ, or Ge, i.e., 1C=1,384 mA h g⁻¹.

### Example 1: Silicon Nanowire Synthesis

Si nanowires were synthesized by supercritical fluid-liquid-solid (SFLS) growth in toluene with trisilane and Au nanocrystals using a home-built flow-through high pressure sealed titanium reactor within a nitrogen-filled glove box (Heitsch et al., Chem. Mater. 2011, 23, 2697-2699). The reactor is pre-heated to 450° C. and pressurized with toluene to 6.9 MPa. A reactant solution of 0.25 mL trisilane, 0.55 mL of the 50 mg mL⁻¹ Au nanocrystal stock dispersion (in toluene) and an additional 0.3 mL toluene is injected over the course of 1 min with a closed effluent line. The reactor pressure increases to 15.2 MPa. Immediately after injecting the reactant solution, the inlet line is closed and the reactor is removed from the heating block and allowed to cool to room temperature. The reactor is removed from the glove box and opened to extract the nanowires with additional toluene (about 15 mL). The crude reaction product is precipitated by centrifugation at 8000 rpm for 5 min. The supernatant is discarded. The nanowires are redispersed in 20 mL toluene and centrifuged again. This solvent washing procedure was followed two times before drying the nanowires by rotary evaporator. The nanowires are dispersed in a solvent such as chloroform or ethanol and stored under ambient conditions prior to use. A typical reaction yields 100 mg of nanowire product. This method provides a convenient route to generating significant quantities of Si nanowires without significant particulate impurity in a short time period.

Au Removal from Sinanowires:

A two-step etching process is used to remove Au from Si nanowires. Approximately 100 mg of crude nanowire product are dispersed in 80 mL of CHCl₃ and added to 40 mL of 1:1:1 v/v/v HF:H₂O:EtOH in a plastic beaker. The mixture is emulsified with vigorous stirring for 30 minutes. After stirring is stopped, the chloroform and etching solutions separate with nanowires accumulating at the liquid-liquid interface. The top phase (aq) is extracted with a plastic pipette, being careful not to disturb the nanowire layer at the interface. The organic phase is then poured into a plastic centrifuge tube with 10 mL of DI H₂O. The centrifuge tube is shaken vigorously, then let stand to allow phase separation. This process is repeated once more and EtOH is added to the remaining solution prior to centrifugation at 8000 rpm for 5 minutes. The solution is washed three additional times by centrifugation and redispersion in CHCl₃, discarding the supernatant each time before finally dispersing the nanowires in CHCl₃ to form a Si nanowire suspension.

The Si nanowire suspension is then added to a glass beaker containing a 50 mL aqua regia solution (1:3 HNO₃:HCl v/v). The mixture is emulsified with vigorous stirring for 2 hours to etch the nanowires. After etching, the stirring is stopped to allow phase separation. The CHCl₃ phase is removed via pipette and the remaining Si nanowire suspension in aqua regia is centrifuged at 8000 rpm for 5 minutes. After centrifugation, the aqua regia is carefully removed with a pipette and the Si nanowires are redispersed in 10 mL DI H₂O. The wires are washed twice with DI H₂O and twice with EtOH. The solvent is evaporated on a rotary evaporator before making slurry solutions in a solvent such as chloroform or ethanol.

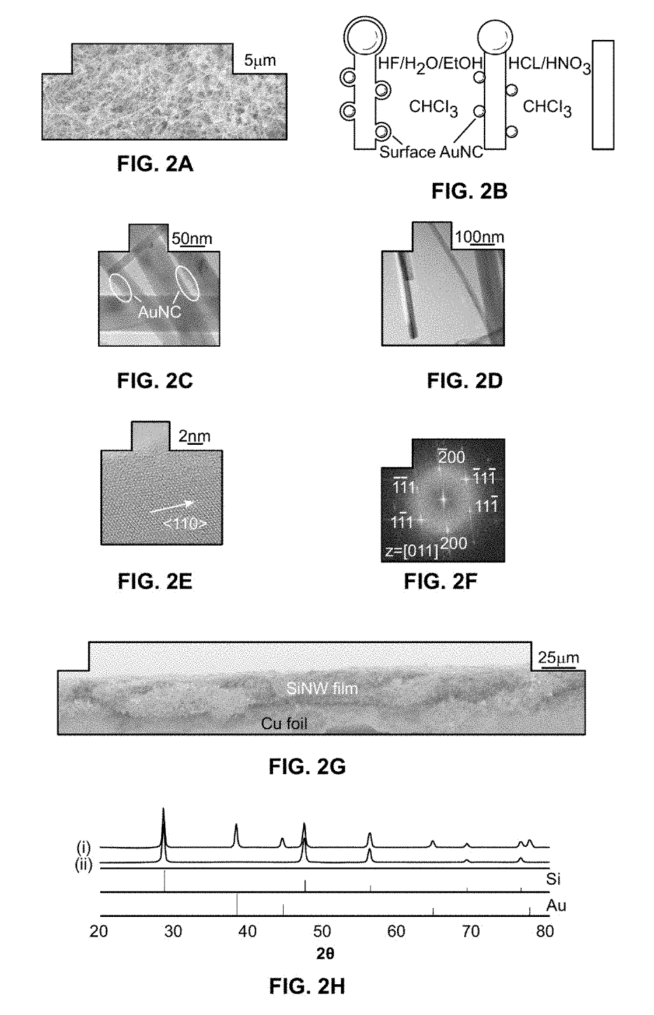

SEM, TEM and XRD analysis of Si nanowires formed by Au-seeded SFLS growth from trisilane with or without removal of Au were performed and the results presented in FIGS. 2A-2H. Specifically, FIG. 2A is an SEM image of SFLS-grown Si nanowires used to form Li-ion battery anodes. FIG. 2B is an illustration of two-step Au etching. TEM images of Si nanowires before (FIG. 2C) and after (FIG. 2D) removing Au. FIG. 2E is a high resolution TEM image of a Si nanowire with <110> growth direction and (FIG. 2F) corresponding Fast Fourier transform (FFT) indexed to diamond cubic Si (imaged down the [011] zone axis). FIG. 2G is an SEM image of an anode film of Si nanowires (with Au removed) with PVdF on Cu foil. FIG. 2H shows the XRD of Si nanowires (i) before and (ii) after Au removal (Si JCPDS: 00-027-1402, Au JCPDS: 00-004-0784). The nanowires are crystalline diamond cubic Si, with an average diameter of 60 nm and lengths of tens of micrometers. The Si nanowire anode films are typically 20 μm thick as shown in FIG. 2G with a mass loading of about 1 mg cm⁻², which is much higher than known Si nanowire Li-ion battery studies, which is only 0.02-0.1 mg cm⁻² (Wu et al., Nature Nanotechnology 2012, 7, 310-315).

The nanowires also contain a significant amount of residual Au, which is clearly evident in XRD as shown in FIG. 2H spectrum (i). Because trisilane is so reactive, large quantities of Au seeds—up to 25% by weight compared to Si—are needed to prevent homogeneous particle formation and produce a high yield of nanowires (Heitsch et al., Chem. Mater. 2011, 23, 2697-2699; Heitsch et al., Nano Lett. 2009, 9, 3042-3047; Hessel et al., Nano Lett. 2009, 10, 176-180). A significant amount of unreacted Au seed particles accumulate on the nanowire surfaces, as highlighted in the TEM image in FIG. 2C. The effect of this residual Au was studied. As illustrated in FIG. 2B, two etching solutions are needed because the Au particles are coated with a thin layer of Si. Initial exposure to HF removes the thin Si coating and subsequent addition of aqua regia dissolves the Au (TEM, FIG. 2D; XRD, FIG. 2H spectrum (ii).

### Example 2: Si Nanowire Anode Preparation, Battery Assembly, and Testing

Slurries of Si nanowires (70% w/w), conductive carbon (10% w/w) and binder (either PVdF or NaAlg, 20% w/w) were prepared by combining 80-100 mg of Si nanowires dispersed in 4-5 mL of EtOH with conductive carbon and either PVdF dispersed in NMP (2 mL) or NaAlg dispersed in water (2 mL). After bath sonication for 1 hour and wand sonication for 30 min, the slurries were doctor-bladed (200 μm gap) onto Cu foil and dried under vacuum overnight at 100° C. Individual 1 cm diameter circular electrodes were hole-punched from the coated Cu foil. The anodes were weighed and the mass of the Cu foil was subtracted to determine the mass of the nanowire film. Typical mass loadings were 0.25-1 mg cm⁻². In some instances, PVdF-containing films were annealed under nitrogen for 12 hours at 300° C. prior to punching electrodes, but the PVdF-containing anodes exhibited similar battery performance regardless of whether annealing at 300° C. was performed.

The electrodes were brought into an Ar-filled glove box (<0.1 ppm O₂) for coin cell assembly. 2032 stainless steel coin cells were used for electrochemical testing and Li foil was used as the counter electrode. 1.0 M LiPF₆ in 1:1 w/w mixtures of carbonates (EC:DEC, EC:DMC, EC:DMC+3% w/w FEC, FEC:DEC, FEC:DMC, or PC:DMC) were used as the electrolyte. The battery is assembled from the Li counter electrode by placing a few drops of electrolyte, followed by the Celgard 2400 separator membrane (25 μm thick, Celgard), another few drops of electrolyte, and then working electrode. The battery is crimped and removed from the glove box for testing.

Galvanostatic measurements were made using an Arbin BT-2143 test unit that was cycled from 0.01-2 V vs Li/Li⁺ at various cycle rates, determined using 3,579 mA h g⁻¹ as the theoretical maximum capacity of Si and 372 mA h g⁻¹ for carbon additives. Capacities are reported based on the mass of Si nanowires in the anodes. Coulombic efficiencies are calculated from the ratio of the discharge to charge capacity for each cycle.

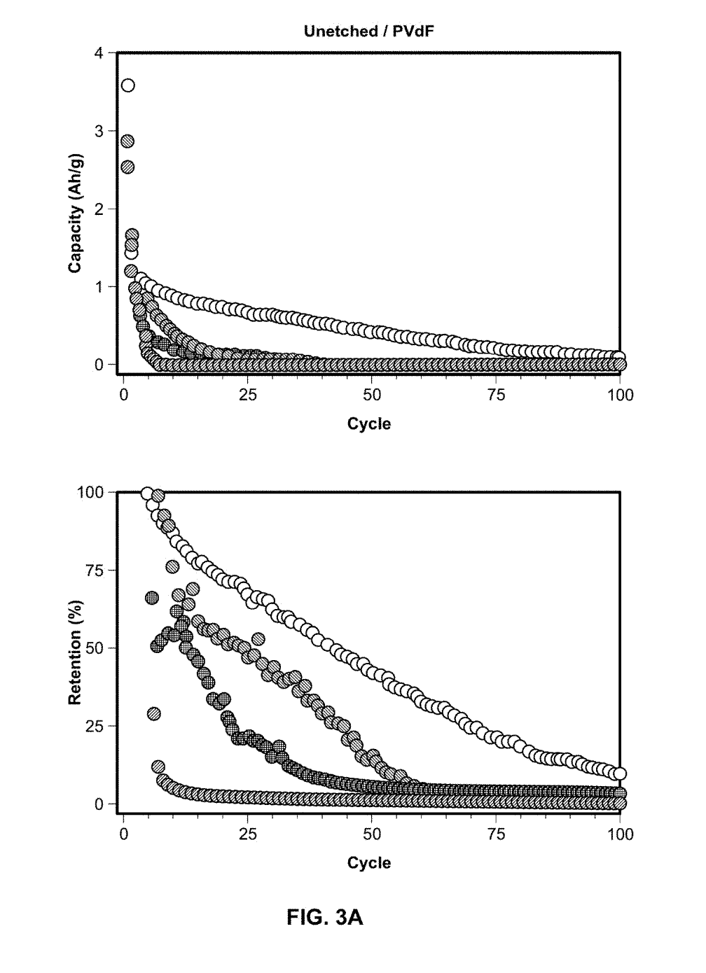

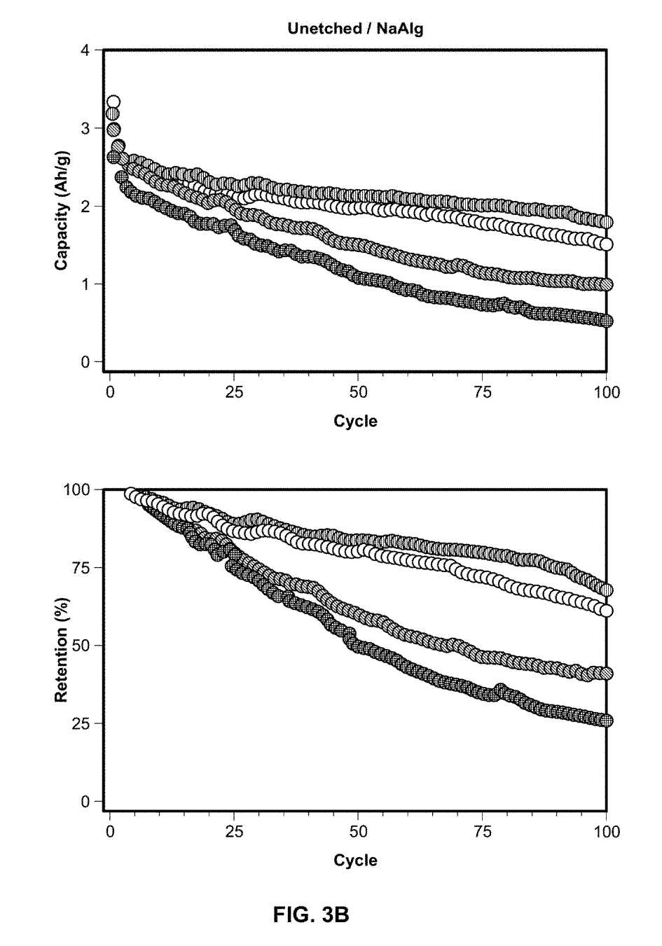

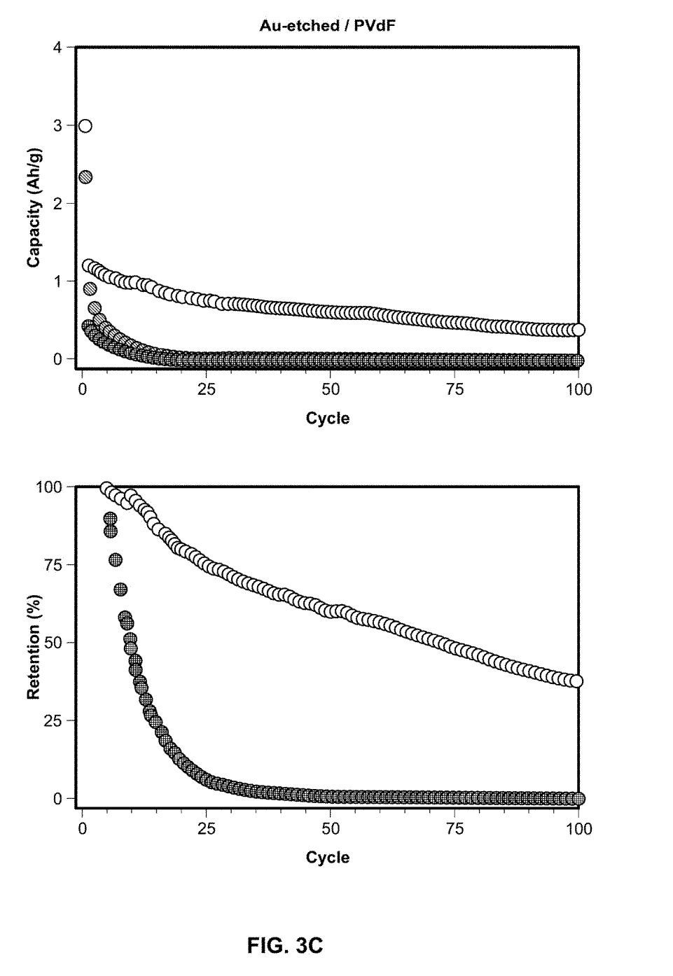

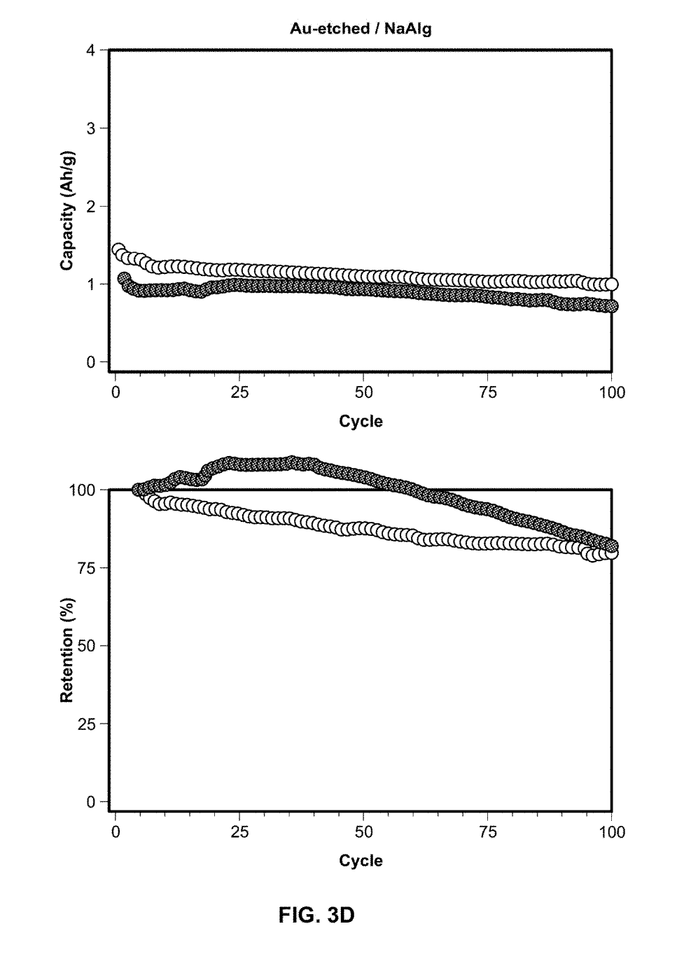

Various Si nanowire Li-ion battery formulations 1-14 listed in Table 1 were tested and the specific charge capacity cycling and percentage capacity retention data are presented in FIGS. 3A-3D and Table 1 below. Specifically, FIGS. 3A and 3B show discharge capacity cycle data for as-prepared and FIGS. 3C and 3D show discharge capacity cycle data for Au-removed Si nanowires mixed with conductive carbon and (FIGS. 3A and 3C) PVdF or (FIGS. 3B and 3D) NaAlg using various 1:1 w/w electrolyte solvent combinations, including: EC:DMC; EC:DEC, EC:DMC+3% w/w FEC, FEC:DEC, FEC:DMC, and PC:DMC, and cycled against Li foil from 0.01 to 2 V vs Li/Li+ at a rate of C/10. The top figure in each panel shows the capacity data and the bottom shows capacity retention relative to the 5th cycle charge capacity. The best results were obtained using NaAlg binder and some additional FEC in the electrolyte (formulations 11-14). Also, batteries without Au exhibited the superior cycle stability (formulations 13 and 14).

TABLE 1
Summary of Si nanowire anode performance with various binder
and electrolyte solvent formulations (C/20 cycle rate)

| | | | Capacity (mA h g⁻¹) | | | | | | |
|---|---|---|---|---|---|---|---|---|---|
| | | Electrolyte | Cycle | 1^{st} cycle | | Cycle | Cycle | Retention (%) | |
| | Binder | Solvent | 1 | loss (%) | | 5 | 100 | Qᵣₑₜ₁^{a} | Qᵣₑₜ₅^{b} |
| 1 | PVdF | EC:DEC | 2838 | 1151 | (40.6) | 310 | 3 | 0.1 | 1.0 |
| 2 | PVdF | EC:DMC | 3564 | 1391 | (39.0) | 337 | 13 | 0.4 | 3.8 |
| 3 | PVdF | EC:DMC + FEC | 2873 | 1143 | (39.8) | 858 | 3 | 0.1 | 0.3 |
| 4 | PVdF | FEC:DMC | 3572 | 1557 | (43.6) | 1038 | 100 | 2.8 | 9.6 |
| 5 | PVdF | PC:DMC | 2534 | 1260 | (49.7) | 366 | 5 | 0.2 | 1.3 |
| 6 | PVdF^{†} | EC:DEC | 2358 | 1240 | (52.6) | 438 | 3 | 0.1 | 0.8 |
| 7 | PVdF^{†} | EC:DMC | 1109 | 656 | (59.2) | 247 | 1 | 0.1 | 0.6 |
| 8 | PVdF^{†} | FEC:DMC | 3013 | 2048 | (68) | 1103 | 390 | 12.9 | 35.4 |
| 9 | NaAlg | ED:DEC | 2978 | 443 | (15.9) | 2503 | 1012 | 34.0 | 40.4 |
| 10 | NaAlg | EC:DMC | 2650 | 446 | (16.8) | 2171 | 560 | 21.1 | 25.8 |
| 11 | NaAlg | EC:DMC + FEC | 3172 | 512 | (16.1) | 2589 | 1815 | 57.2 | 70.1 |
| 12 | NaAlg | FEC:DMC | 3362 | 718 | (21.3) | 2528 | 1526 | 45.4 | 60.3 |
| 13 | NaAlg^{†} | FEC:DEC | 1455 | 372 | (25.6) | 1317 | 1017 | 69.9 | 77.3 |
| 14 | NaAlg^{†} | FEC:DMC | 1466 | 695 | (47.4) | 955 | 751 | 51.2 | 78.6 |

^{†}Au-removed Si nanowires
^{a}Discharge capacity retention of the 100^{th} cycle relative to the 1^{st} cycle
^{b}Discharge capacity retention of the 100^{th} cycle relative to the 5^{th} cycle

Batteries with PVdF binder failed after only tens cycles. Si nanowire/PVdF films annealed for 12 hours under N₂ flow at 300° C. still showed poor performance. The highest performing Si nanowire anodes with PVdF binder had Au removed and FEC:DMC as solvent for electrolyte, but the retention after 100 cycles was still only 35.4% relative to cycle 5 (formulation 8).

Sodium Alginate Binder.

In contrast to PVdF, NaAlg binder gave very good battery stability and high capacity. Kovalenko et al. (Science 2011, 334, 75-79) first showed that NaAlg binder provides good stability and high capacity for Si powder-based anodes. In comparison to PVdF, NaAlg contains a high concentration of carboxyl groups that can hydrogen bond to the oxidized Si surface and undergo a self-healing process during lithium insertion and extraction (Bridel et al., Chem. Mater. 2009, 22, 1229-1241), and more suitable mechanical properties for coping with the volume expansion and contraction upon cycling. While other binders, such as poly (acrylic acid) (PAA) and carboxymethyl cellulose (CMC) have also exhibited better performance than PVdF (Mazouzi et al., Electrochem. Solid St. 2009, 12, A215-A218; Magasinski et al., ACS Appl. Mater. Interfaces 2010, 2, 3004-3010; Bridel et al., Chem. Mater. 2009, 22, 1229-1241), NaAlg has a higher elastic modulus and the most carboxylic acid groups of these other binders and have exhibited the good performance.

FEC Electrolyte.

In addition to using NaAlg binder, it was beneficial to add FEC to the electrolyte solvent to obtain stable cycling. FEC-based electrolytes were not used in the study by Kovalenko et al. (Science 2011, 334, 75-79) (they used NaAlg binder and 1:1:1 DMC:EC:DEC electrolyte) and they still obtained stable high capacity cycling with Si powder. In the Si nanowire anodes tested here with NaAlg binder, only the batteries with FEC added performed well (formulations 11-14). In other studies of Si particle-based anodes, FEC has also provided good cycle stability for up to several hundred cycles before battery failure (Etacheri et al., Langmuir 2012, 28, 6175-6184). FEC-containing electrolytes have been found to form SEI layers that are more stable, more transparent to electron and Li ion flow, and less porous for better Si protection from competing side reactions than non-FEC-containing electrolytes (Choi et al., J. Power Sources 2006, 161, 1254-1259). The Si nanowire results here confirm the value in using FEC-containing electrolyte in Si-based anodes. The Au-removed Si nanowire anodes with FEC:DEC as electrolyte solvent (formulation 13) exhibited nearly 80% capacity retention (1,017 mA h g⁻¹) after the first 100 cycles.

Impact of Au on Si Nanowire Cycling Performance.

Au is an electrochemically active yet poor Li insertion material (Yuan et al., J. New Mat. Elect. Syst. 2007, 10, 95-99; Taillades et al., Solid State Ionics 2002, 152-153, 119-124). For example, a drop in capacity at high cycle rate was observed in graphene-supported Si nanowires and attributed to the presence of gold (Chockla et al., J. Phys. Chem. C 2012 116, 11917-11923). When the Au present in the nanowires was removed, the capacity fade and irreversible capacity loss have been observed to be significantly reduced. Although in FIGS. 3A-3D, the Au-containing anodes had higher capacity than the anodes without Au, the capacity of the Au-free anodes could be increased significantly by conditioning the electrode with an initial cycle at slow rate of C/20. With this conditioning step, the capacities at C/10 of Au-free anodes were just over 2,000 mA h g⁻¹, with low capacity fade. When Au was still present in the electrodes, conditioning with an initial slow cycling had no impact on the nanowire electrode performance.

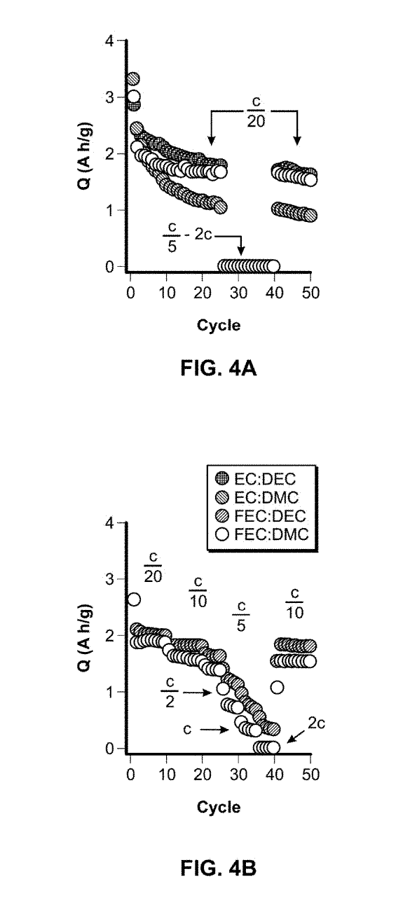

The negative impact of Au on anode performance was especially apparent at faster charge/discharge rates. In FIGS. 4A and 4B, which compares charge capacities of Si nanowire anodes with (FIG. 4A) or without (FIG. 4B) Au cycled at different rates, the electrodes with Au (FIG. 4A) had no charge capacity when the cycle rate was C/5 or faster; whereas, electrodes without Au (FIG. 4B) exhibited measureable charge capacity of 400 mA h g⁻¹ even at a faster cycle rate of 2C.

Differential Capacity Plots.

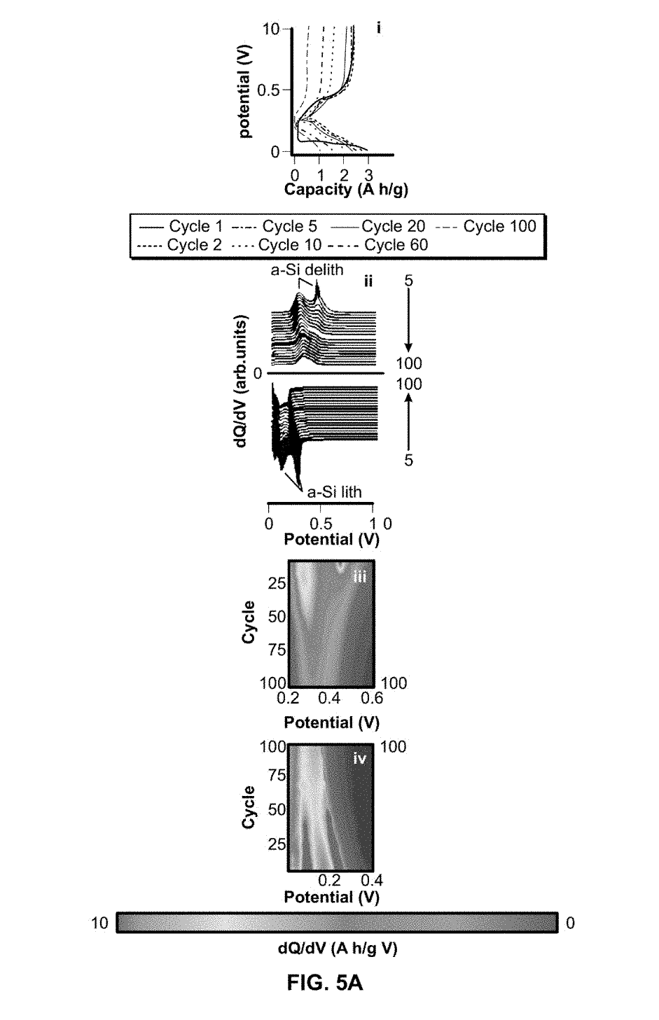

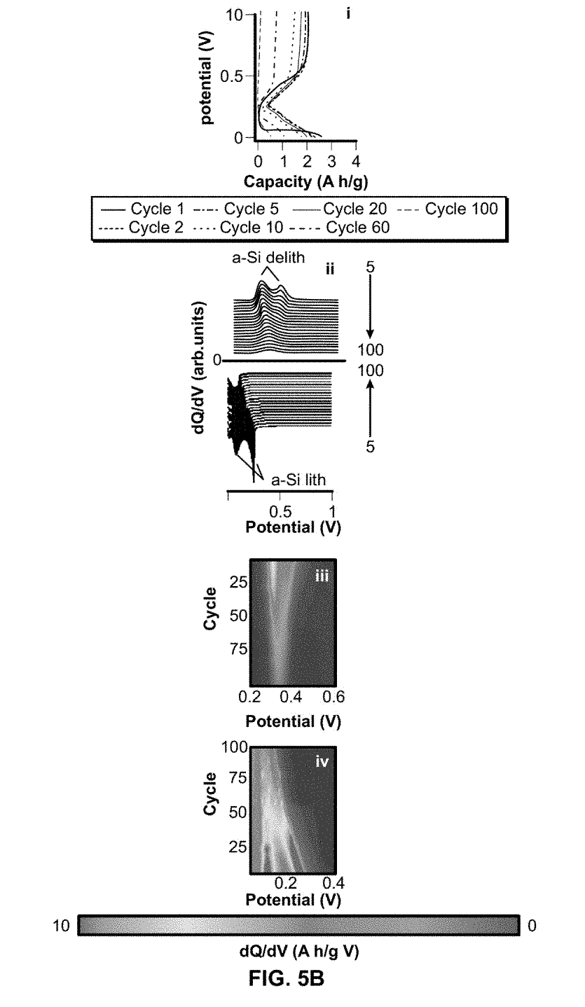

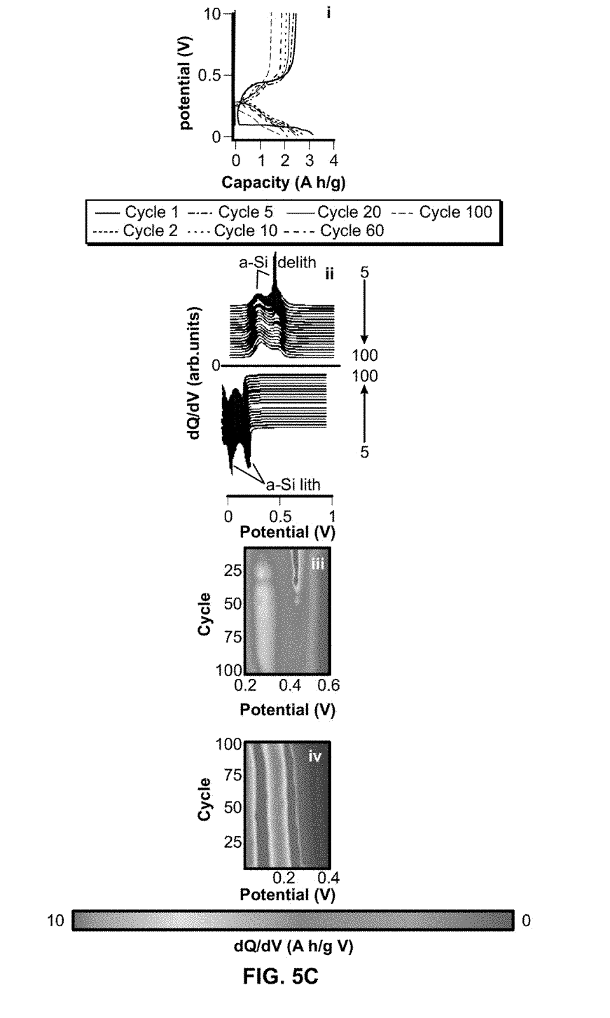

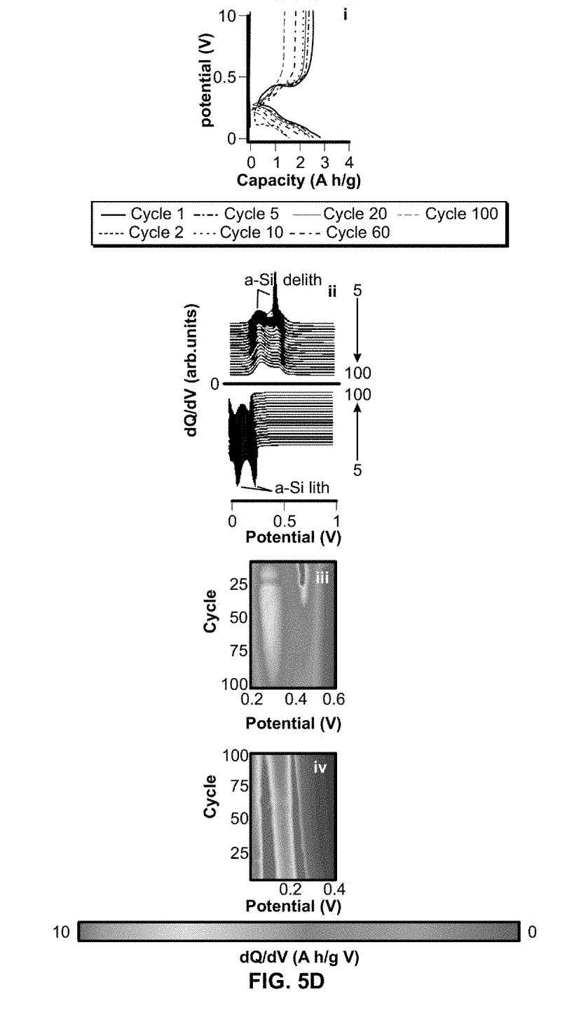

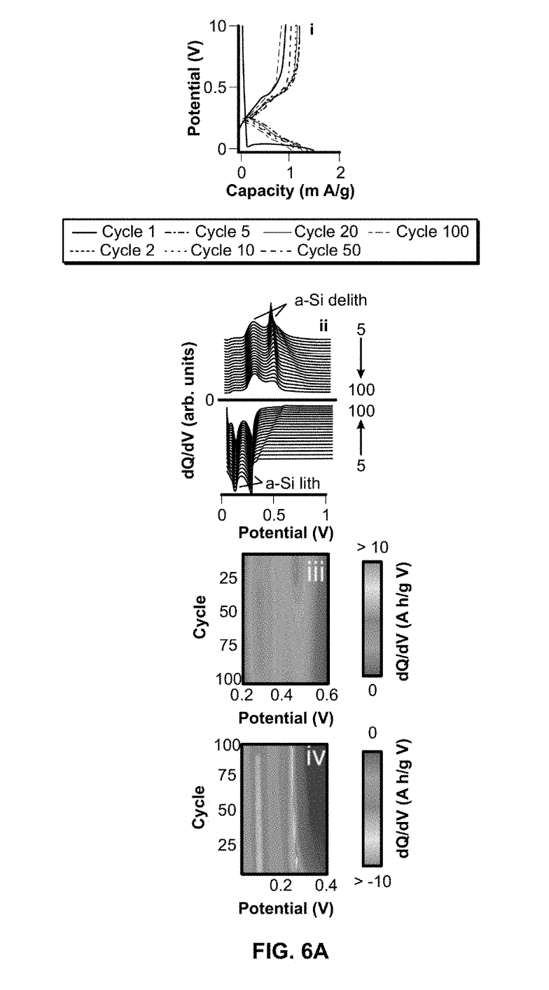

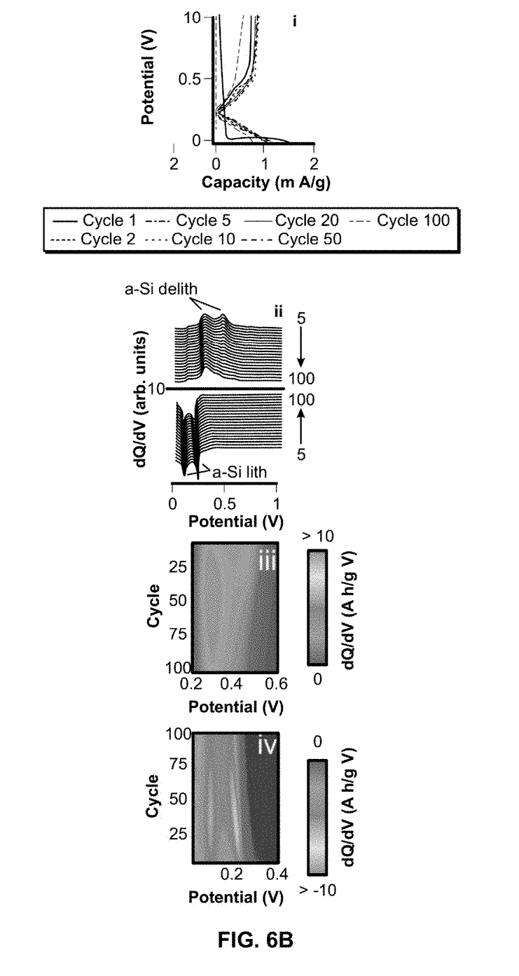

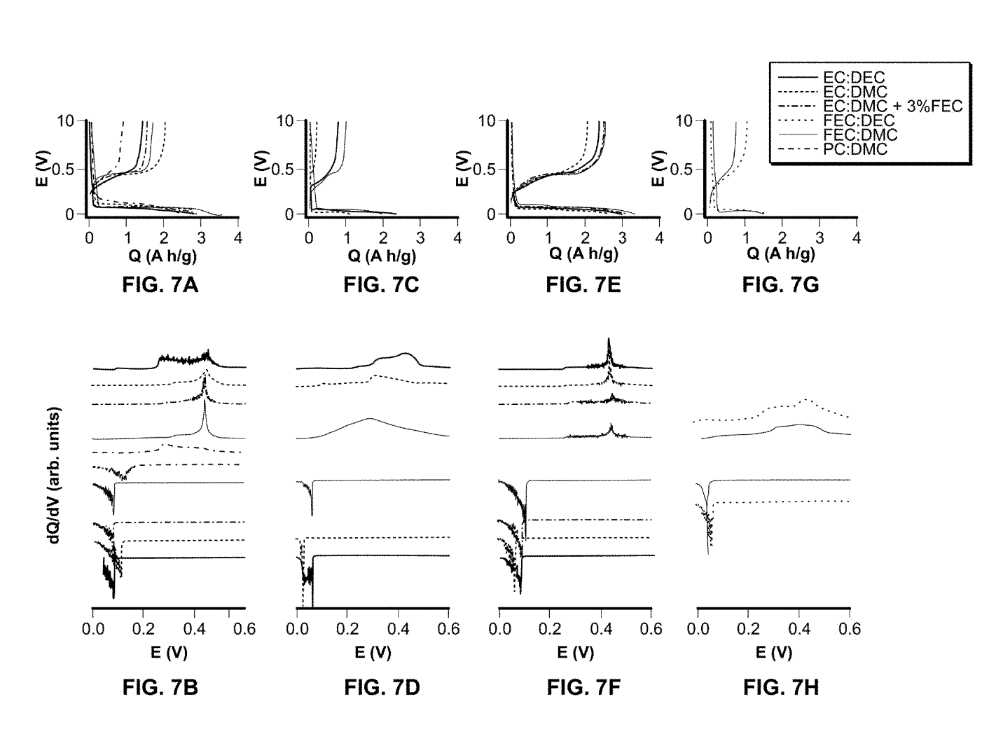

Differential capacity plots provide insight about the electrochemical lithiation processes taking place in the nanowire anode are presented in FIGS. 5A-7H. Specifically, FIGS. 5A-5D show battery performance data for Si nanowires (no Au etching) with NaAlg binder and various electrolyte: FIG. 5A, EC:DEC; FIG. 5B, EC:DMC; FIG. 5C, EC:DMC+3% (w/w) FEC; and FIG. 5D, FEC:DMC; Panel (i), Voltage profiles; Panel (ii), charge and discharge differential capacity waterfall plots, Panel (iii), discharge (delithiation) color maps; and Panel (iv), charge (lithiation) color maps. FIGS. 6A and 6B show battery performance data for Si nanowires with Au removed, NaAlg binder and various electrolyte: FIG. 6A, FEC:DEC; and FIG. 6B, FEC:DMC; Panel (i) Voltage profiles; Panel (ii) charge and discharge differential capacity waterfall plots; Panel (iii), discharge (delithiation) color maps; and Panel (iv), charge (lithiation) color maps. FIGS. 7A-7H show first cycle voltage profiles and differential capacity curves. FIGS. 7A, 7C, 7E, and 7G are Voltage profiles with Q denotes capacity and E denotes potential. FIGS. 7B, 7D, 7F, and 7H are differential capacity plots for the first cycle of Si nanowires. FIGS. 7A and 7C are plots for Si nanowires with Au present. FIGS. 7B and 7D are plots for Si nanowires without Au present. FIGS. 7A-7D are plots for anodes with PVdF as binder. FIGS. 7E-7H are plot for anodes with NaAlg as binder.

Lithiation of crystalline Si leads to amorphization. On the first charge cycle, a single, relatively sharp lithiation peak occurs at 50-100 mV corresponding to lithiation of crystalline Si as shown in FIGS. 7A-7H; whereas, subsequent cycles after Si becomes amorphous, this sharp peak no longer appears and charging produces two broad lithiation peaks at 50-100 mV and 200-250 mV, consistent with reports from Obrovac et al., Electrochem. Solid St. 2004, 7, A93-A96; Hatchard et al., J. Electrochem. Soc. 2004, 151, A838-A842. The reason for two lithiation peaks for a-Si and a-LiₓSi is not known (Obrovac et al., J. Electrochem. Soc. 2007, 154, A103-A108); however, the highest performance batteries all exhibit differential capacity data with these characteristic signatures similar to FIGS. 5A-5D and 6A-6B). Delithiation of a-LiₓSi produces two broad peaks at 250 and 450 mV. If Si has become saturated with Li during charging to form the crystalline phase Li₁₅Si₄, then a sharp delithiation peak occurs at 450 mV. This sharp delithiation peak is observed in several of the battery formulations with good performance, but the feature tends to disappear as the battery is cycled (>20 cycles or so). The reason for this is not clear. FEC-containing batteries generally had good stability, which is reflected in the clean lithiation/delithiation features in the differential capacity plots. As battery capacity faded, the lithiation peaks were found to shift to slightly higher potential, as in FIGS. 5A, 5D, 6A, and 6B. In batteries with very significant fade, the two lithiation and delithiation peaks merged and decreased significantly in intensity, as in FIGS. 7A and 7B.

Noticeable differences in the first cycle differential capacity curves for anodes with and without Au were observed. The first cycle lithiation peak occurred at slightly higher potential (100 mV vs 50 mV) for anodes with Au and had significant tailing towards lower potential. This might be a signature of Au, since it lithiates in the high potential range (Yuan et al., J. New Mat. Elect. Syst. 2007, 10, 95-99; Taillades et al., Solid State Ionics 2002, 152-153, 119-124). Au-containing Si nanowire anodes also exhibited a sharp delithiation peak at about 450 mV on the first cycle. For anodes without Au, this peak only appeared in later cycles—by about the 5^{th} cycle (FIG. 6B)—indicating that there is an initial barrier to lithiation. This might be from a thicker oxide layer created by the strongly oxidizing Au etching solution. Suboxide (SiOₓ) lithiates with reduced capacity of 1600 mA h g⁻¹ (Miyachi et al., J. Electrochem. Soc. 2005, 152, A2089-A2091; Sun et al., Appl. Surf. Sci. 2008, 254, 3774-3779; Yang et al., Solid State Ionics 2002, 152, 125-129; Nagao et al., J Electrochem. Soc. 2004, 151, A1572-A1575; Hu et al., Angew. Chem. Int. Ed. 2008, 47, 1645-1649) but is mechanically stronger than Si and limits the expansion of the Si core, which in turn may limit lithiation capacity but has been shown to improve cycle life (Wu et al., Nature Nanotechnology 2012, 7, 310-315; McDowell et al., Nano Lett. 2011, 11, 4018-4025; Abel et al., ACS Nano 2012, 6, 2506-2516). If the surface fully oxidizes, SiO₂ is electrochemically inactive (Saint et al., Adv. Funct. Mater. 2007, 17, 1765-1774) in the potential ranges studied here, but can react with Li to form silicates and Li₂O species that are relatively transparent to Li⁺ transport (Miyachi et al., J. Electrochem. Soc. 2005, 152, A2089-A2091; Sun et al., Appl. Surf Sci. 2008, 254, 3774-3779; Nagao et al., J. Electrochem. Soc. 2004, 151, A1572-A1575; Netz et al., J. Power Sources 2003, 119-121, 95-100; McDowell et al., Nano Lett. 2011, 11, 4018-4025). The difference in battery performance between nanowires with and without Au etching might actually relate more to the relative amount of oxidation of the Si nanowire surfaces. An oxidized Si nanowire surface will also interact strongly with NaAlg carboxyl groups to further stabilize the battery.

Influence of Cycle Rate on the Differential Capacity.

Voltage profiles and differential capacity plots for Si nanowire anodes with Au removed, NaAlg binder and 1.0 M LiPF₆ electrolyte in 1:1 (w/w) FEC:DEC or FEC:DMC are presented in FIGS. 8A and 8B. Specifically, FIG. 7A is from battery with FEC:DEC solvent and FIG. 7B is from battery with FEC:DMC solvent. Panel (i) is rate test data, Panel (ii) shows voltage profiles and Panels (iii) and (iv) shows corresponding differential capacity plots. The corresponding charge and discharge capacities are shown in FIG. 4B. At slow cycle rate (C/5 or slower), the differential capacity curves show the two characteristic lithiation and delithiation peaks. The peak intensities diminished once the cycle rate went above C/5, which is consistent with the reduced battery capacity observed in FIGS. 4A and 4B. As the cycle rate increased, the lithiation peaks shifted to lower potential and the delithiation peaks shifted to higher potential. At a rate of 1C, the two peaks had merged into one low potential (about 150 mV) lithiation peak and one high potential (about 450 mV) delithiation peak, indicating that battery charging and discharging was being limited by kinetics. Furthermore, the peak shifts were reversible and the characteristic lithiation and delithiation peaks reappeared once the rate was reduced to C/10 (at cycle 41).

Thick film (>20 μm thick with about 1 mg cm⁻² loading) Li-ion battery anodes of Si nanowires were tested with different binder and electrolyte. PVdF was found to be a poor binder for the Si nanowires tested here even though heat-treated PVdF/Si powder electrodes have been shown to work well (Kovalenko et al., Science 2011, 334, 75-79; Li et al., J. Electrochem. Soc. 2008, 155, A234-A238). In contrast, NaAlg binder provided very stable battery cycling, with capacities of more than 2,000 mA h g⁻¹ after the first 100 cycles. The addition of FEC to the electrolyte was found to be helpful for stable battery cycling. Typical carbonate solvent mixtures did not perform well. Significant excess of Au in the electrodes was also found to be detrimental.

These results emphasize that all of the components in the battery—not just the active Si materials—contribute to its performance. The formulations optimized over many years for graphite do not apply to Si. With the appropriate formulation, thick films of Si nanowires have the potential to be used as a graphite replacement in high capacity Li-ion batteries.

### Example 3: Ge Nanowire Synthesis

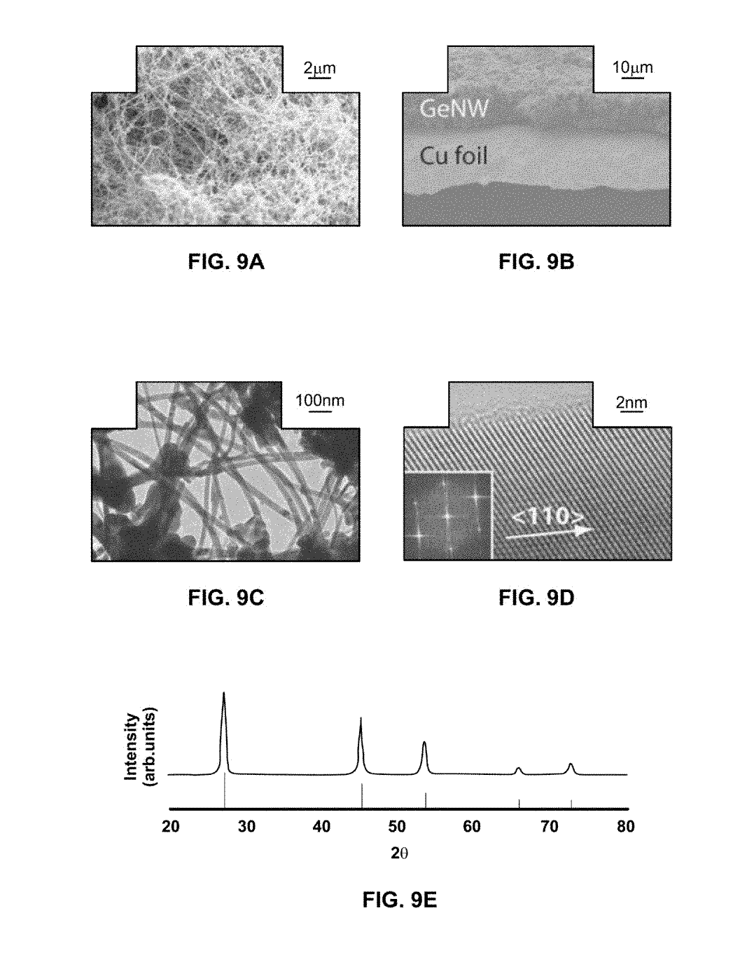

Ge nanowires were produced by solution-liquid-solid (SLS) growth using Au nanocrystal seeds and DPG reactant (Chockla et al., J. Mater. Chem. 2009, 19, 996-1001). In a typical reaction, 10 mL of squalane is added to a 4-neck flask, attached to a Schlenk line and heated to 100° C. with vigorous stirring under vacuum (<500 mTorr) for 30 min, and then blanketed with nitrogen. A DPG reactant solution is prepared in a nitrogen-filled glove box by combining 0.275 mL of the Au nanocrystal stock solution with 0.375 mL DPG and 1 mL squalane. The reactant solution is removed from the glove box in a syringe and rapidly injected into the reaction flask containing the hot squalane. After 5 minutes, the flask is removed from the heating mantle and allowed to cool to room temperature. The reaction mixture is transferred to a centrifuge tube with an additional 10 mL of toluene. The nanowires are precipitated by centrifugation at 8000 rpm for 5 minutes. The supernatant is discarded. The nanowires are redispersed in a mixture of chloroform and ethanol and reprecipitated by centrifugation twice more to remove residual reactant byproducts and squalane. About 40 mg of Ge nanowires are obtained from a single reaction. The SEM and TEM images and XRD data of the Ge nanowires were tested and the results presented in FIGS. 9A-9E. Specifically, FIG. 9A is an SEM image of SLS-grown Ge nanowires; FIGS. 9C and 9D are TEM images of Ge nanowires; the inset in FIG. 9D is the FFT of the TEM image used to determine the <110> growth direction of the nanowire and FIG. 9E shows XRD of Ge nanowires with the reference pattern provided for diamond cubic Ge (JCPDS: 00-004-0545). The nanowires produced were crystalline, diamond cubic Ge, with average diameter of 30 nm and lengths of tens of micrometers. The quantity of Au used in the synthesis was relatively low (1,250:1 Ge:Au) and it did not appear in the XRD pattern.

### Example 4: Ge Nanowire Anode Preparation, Battery Assembly, and Testing

Slurries of 70:20:10 w/w/w Ge nanowires:PVdF:carbon were used in the battery tests. In a typical preparation, Ge nanowires (81.1 mg) are dispersed in 2 mL toluene with 1 hour of bath sonication. 23.2 mg PVdF and 11.6 mg conductive carbon are dissolved in 1 mL NMP with 1 hour of bath sonication. The Ge nanowire and PVdF/carbon black suspensions are mixed and wand sonicated for 30 minutes and then the volume is reduced on a rotary evaporator to form a thick slurry. The slurry is doctor-bladed (200 μm gap) onto Cu foil and vacuum dried overnight at 100° C. The nanowires deposited were relatively thick (about 10 mm) anode films with typical mass loading of 1 mg cm⁻². SEM image of a cross-sectioned Ge nanowire anode is presented in FIG. 9B showing the Ge nanowire layer (GeNW) deposited on the Cu foil. Individual 11 mm diameter circular electrodes were hole-punched from the coated Cu foil.

The Ge-coated Cu films were brought into an Ar-filled glove box (<0.1 ppm O₂) for coin cell assembly. 2032 stainless steel coin cells were used with Li foil as the counter electrode. The battery is assembled from the Li counter electrode by placing a few drops of electrolyte, followed by the Celgard 2400 separator membrane (25 μm thick, Celgard), another few drops of electrolyte, and then the Ge electrode. The battery is crimped and removed from the glove box for testing.

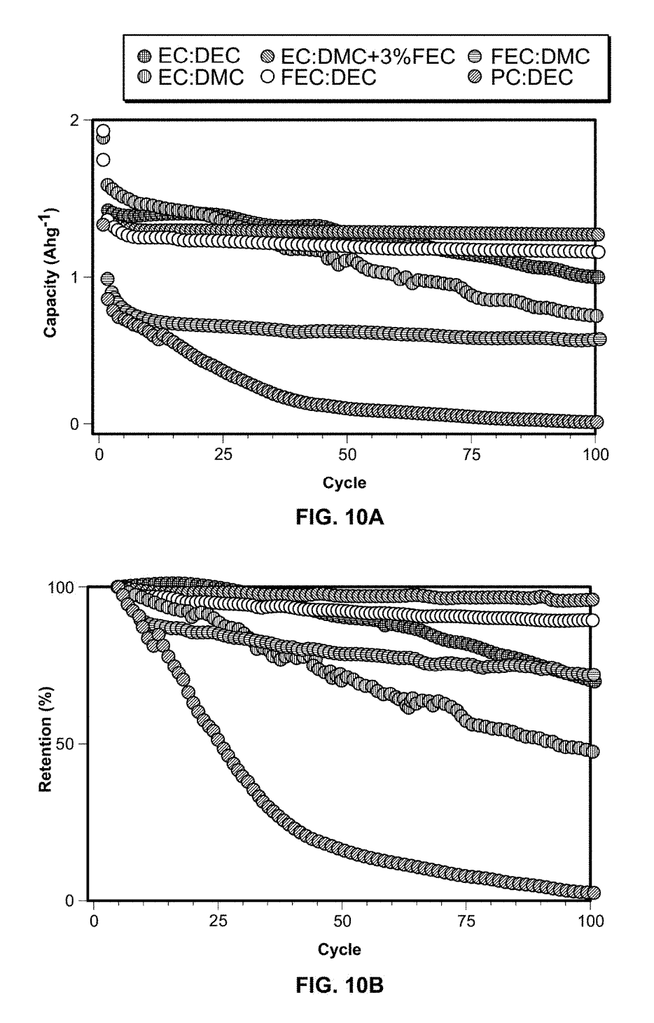

Li-ion batteries with Ge nanowire anodes were tested using PVdF binder, conductive carbon (7:1:2 w/w/w Ge:C:PVdF) and 1.0 M LiPF₆ electrolyte in various mixtures of the carbonates (1:1 w/w mixtures of a) EC:DEC, b) EC:DMC, c) EC:DMC+3% w/w FEC, d) FEC:DEC, e) FEC:DMC). The discharge capacity and capacity retention of batteries a-f cycled between 0.01 and 2 V vs Li/Li⁺ at a rate of C/10 (C=1,384 mA h g⁻¹) were tested and the results shown in FIGS. 10A and 10B. Specifically, FIG. 10A shows discharge capacity and FIG. 10B shows capacity retention (relative to the 5^{th} cycle) of batteries a-f. The cycling results of the batteries a-f are also tabulated in Table 2.

TABLE 2
Summary of Ge nanowire anode battery performance.

| | | Capacity (mA h g⁻¹) | | | | | |
|---|---|---|---|---|---|---|---|
| | | Cycle | 1^{st} cycle | Cycle | Cycle | Retention (%) | |
| | Electrolyte | 1 | loss (%) | 5 | 100 | Qᵣₑₜ₁^{a} | Qᵣₑₜ₅^{b} |
| a | EC:DEC | 1630 | 223 (13.7) | 1382 | 973 | 59.7 | 70.4 |
| b | EC:DMC | 1885 | 311 (16.5) | 1504 | 714 | 37.9 | 47.5 |
| c | EC:DMC + FEC | 1639 | 301 (18.4) | 1303 | 1248 | 76.1 | 95.8 |
| d | FEC:DEC | 1738 | 385 (22.2) | 1271 | 1131 | 65.0 | 89.0 |
| e | FEC:DMC | 1933 | 975 (50.5) | 774 | 561 | 29.0 | 72.5 |
| f | PC:DMC | 1313 | 484 (36.8) | 699 | 15 | 1.2 | 2.2 |

^{a}Discharge capacity retention of the 100^{th} cycle relative to the 1^{st} cycle
^{b}Discharge capacity retention of the 100^{th} cycle relative to the 5^{th} cycle

FEC addition (EC:DMC+3% FEC) in battery c appeared to provide a stabilizing effect that yielded capacity of 1,248 mA h g⁻¹ after 100 cycles, corresponding to only a 4.2% loss in capacity relative to the 5^{th} cycle. These values are higher than recent reports for Ge nanowires used as Li-ion battery negative electrodes. For example, Seo et al. recently reported capacities of about 700 mA h g⁻¹ for SLS-grown Ge nanowires after 100 cycles using a current density of 400 mA g⁻¹ (˜C/3) (Energy Environ. Sci. 2011, 4, 425-428). Chan et al. reported capacities of 1000 mA h g⁻¹ after 20 cycles at a current load of 80 mA h g⁻¹ (rate of C/20) for Ge nanowires grown directly from steel substrates using a CVD process (Chan et al., Nano Lett. 2007, 8, 307-309). Batteries a and d with DEC as solvent for the electrolytes outperformed those with DMC (batteries b, c, and e) and battery f with PC:DMC as solvent had the worst performance.

PVdF appears to be much more effective as a binder for Ge than Si. PVdF was found to be a poor binder for Si nanowire anodes, but the performance here for Ge nanowires with PVdF is very good. PVdF has achieved some good results with Si particles, but only with high temperature (300° C.) annealing to improve the interfacial chemistry and a help distribute the binder and conductive carbon throughout the active material (Li et al., J. Electrochem. Soc. 2008, 155, A234-A238; Chen et al., Electrochem. Commun. 2003, 5, 919-923), and several other binders like sodium alginate have been shown to work better much better for Si (Kovalenko et al., Science 2011, 334, 75-79; Mazouzi et al., Electrochem. Solid St. 2009, 12, A215-A218; Magasinski et al., ACS Appl. Mater. Interfaces 2010, 2, 3004-3010; Bridel et al., Chem. Mater. 2009, 22, 1229-1241). Ge on the other hand appears to interface well with PVdF.

Voltage Profiles and Differential Capacity Plots

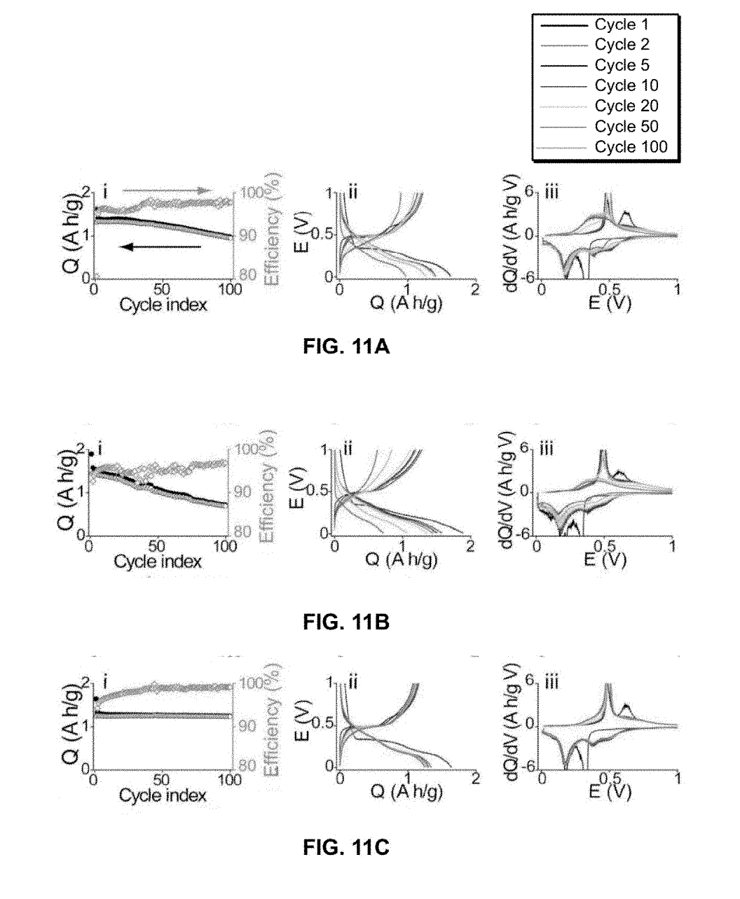

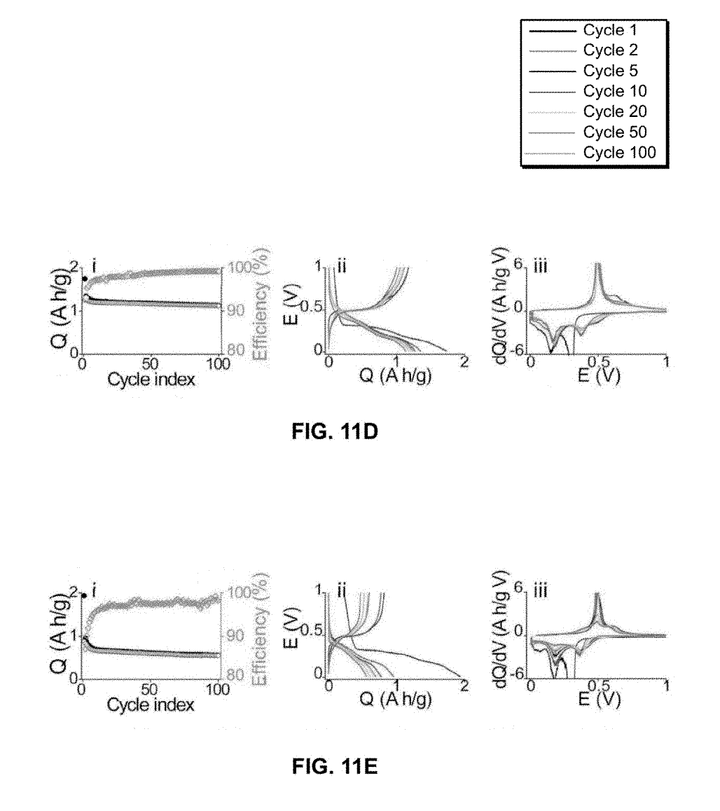

The charge and discharge capacities, Coulombic efficiency (ratio of discharge to charge capacity at each cycle), voltage profiles and differential capacity plots for the batteries a-e correspond to the battery data in FIGS. 10A and 10B are presented in FIGS. 11A-11E. Specifically, FIGS. 11A-11E show (i) charge and discharge capacities plotted with Coulombic efficiencies, (ii) charge and discharge voltage profiles and (iii) corresponding differential capacity curves for Ge nanowire batteries a-e cycled galvanostatically. The electrochemical data for battery f was not included in FIGS. 11A-11E because of its poor cycle stability. The Coulombic efficiencies after the first few cycles were greater than 95% for all of the batteries a-e, even those with the more significant capacity fade.

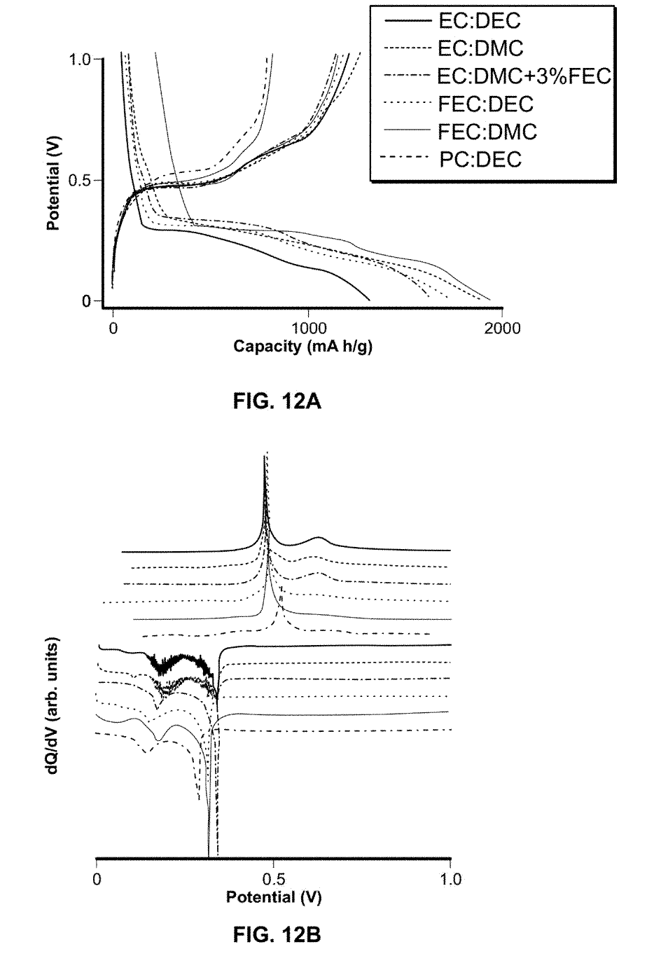

Differential capacity plots provide detailed information about the electrochemical processes in the battery and their stability. The first cycle charge and discharge capacity between 0 to 1.0 V and differential capacity of the batteries a-f correspond to the battery data in FIGS. 10A and 10B is presented in FIGS. 12A and 12B. Specifically, FIG. 12A shows the first cycle voltage profiles and FIG. 12B shows the differential capacity plots for batteries a-f. As shown in FIG. 12B, during the first cycle, the differential capacity plots show a sharp lithiation peak near 350 mV with a smaller, yet still reasonably sharp peak at 150-200 mV. The sharp peak at 350 mV corresponds to the lithiation of crystalline Ge, consistent with reports from Graetz et al., J. Electrochem. Soc. 2004, 151, A698-A702. Lithiation amorphizes Ge and this sharp lithiation peak no longer appears in subsequent cycles. Instead, lithiation produces three relatively broad lithiation peaks at 500 mV, 350 mV and 200 mV, characteristic of lithiation of amorphous Ge (a-Ge) as shown in FIGS. 11A and 11B panel (iii), consistent with those reported by Yoon et al., Electrochem. Solid St. 2008, 11, A42-A45.

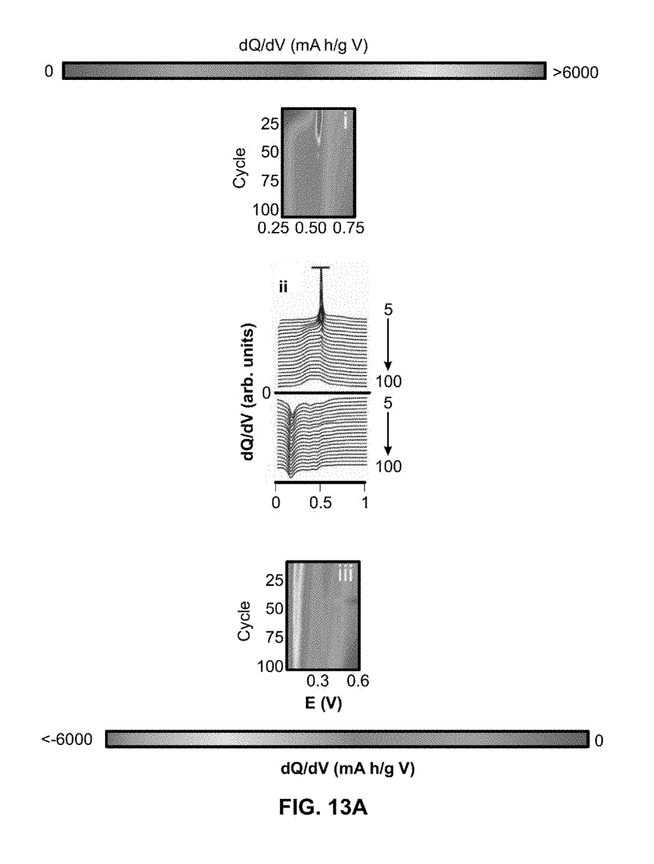

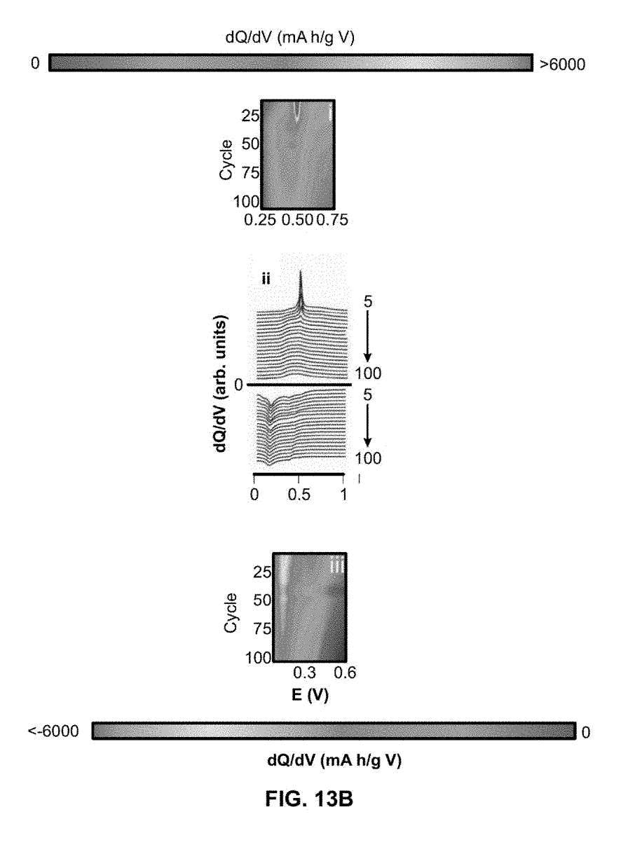

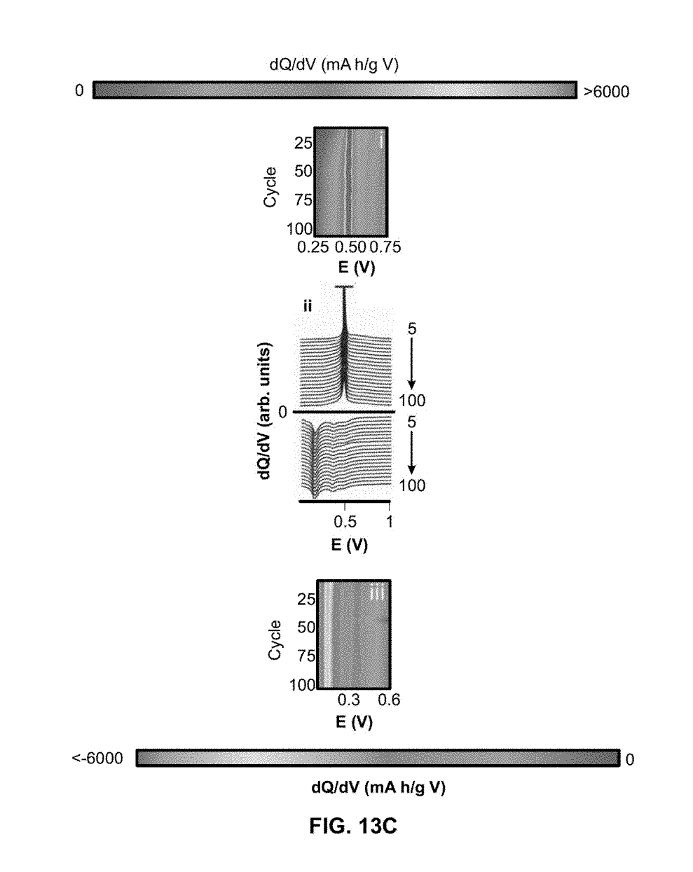

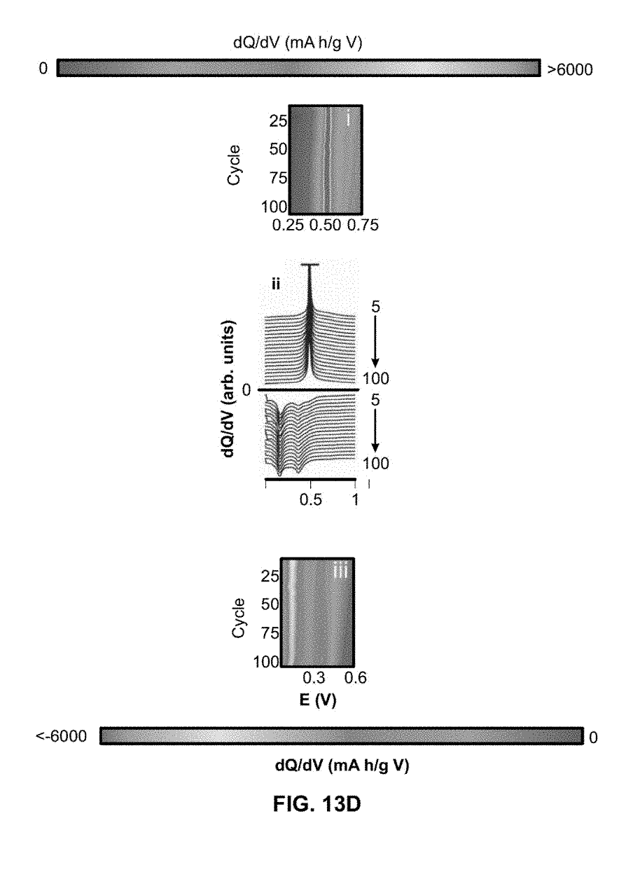

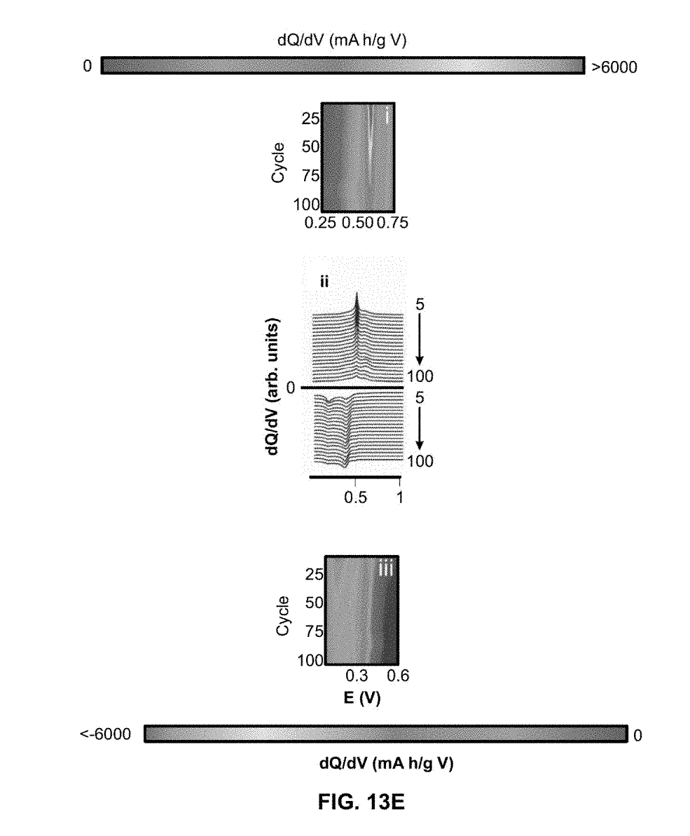

Delithiation gives rise to a very prominent sharp peak at 500 mV, which is consistent with other reports for Ge delithiation. On the first delithiation cycle (FIG. 12B), this sharp peak is also accompanied by a lower intensity, broad peak at 600 mV. At later cycles in the more stable batteries, this 600 mV peak is still present but with very weak intensity as shown in FIGS. 11A and 11B panel (iii). The differential capacity and water fall plots for Ge nanowire batteries a-e correspond to the battery data in FIGS. 10A and 10B are further presented in FIGS. 13A-13E. Specifically, the differential capacity during discharge or delithiation is shown in the top two rows (panel i and top panel of ii) and charge or lithiation is shown in the bottom two rows (bottom panel ii and panel iii). One of the clearest signatures of capacity fade was the disappearance of the sharp delithiation peak at 500 mV. This is more clearly viewed in waterfall plots of FIGS. 13A-13E panel (ii). The batteries electrolyte and b had significant capacity fade and lost the sharp delithiation peak at later cycles, which was replaced by a broad, less intense delithiation peak at lower voltage at about 400 mV. In Si anodes, there is a sharp delithiation peak in the differential capacity corresponding to the delithiation of crystalline Li₁₅Si₄. Delithiation of amorphous LiₓSi produces broader peaks. The sharp delithiation peak observed for the most stable Ge nanowire anodes might indicate that the highest capacities are achieved when Ge is fully lithiated reversibly to crystalline Li₁₅Ge₄.

Rate Capability.

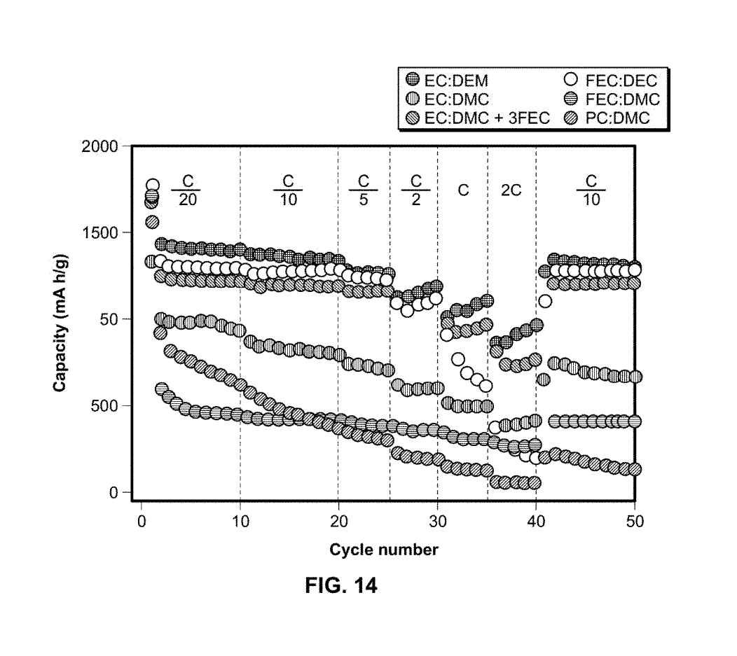

The rate capability of Ge nanowire batteries a-f was also tested. FIG. 14 shows discharge capacity data for batteries a-f cycled at different rates. Battery c again gave the best performance. Battery a also exhibited good performance, with high capacity even at faster cycle rates. But battery was only cycled ten times at each rate and had significant drift, indicating relative instability. Battery c exhibited high capacity of about 700 mA h g⁻¹ at 2C without similar drift. Battery d also performed very well at the slow cycle rates, but the capacity dropped sharply once the rate exceeded C/2.

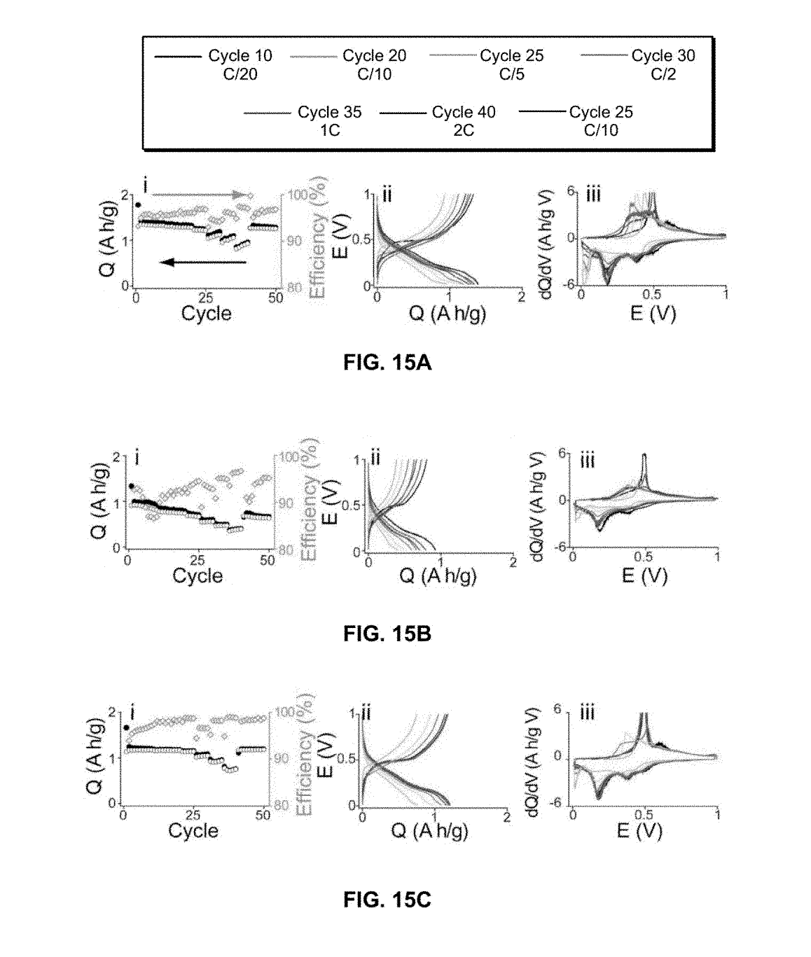

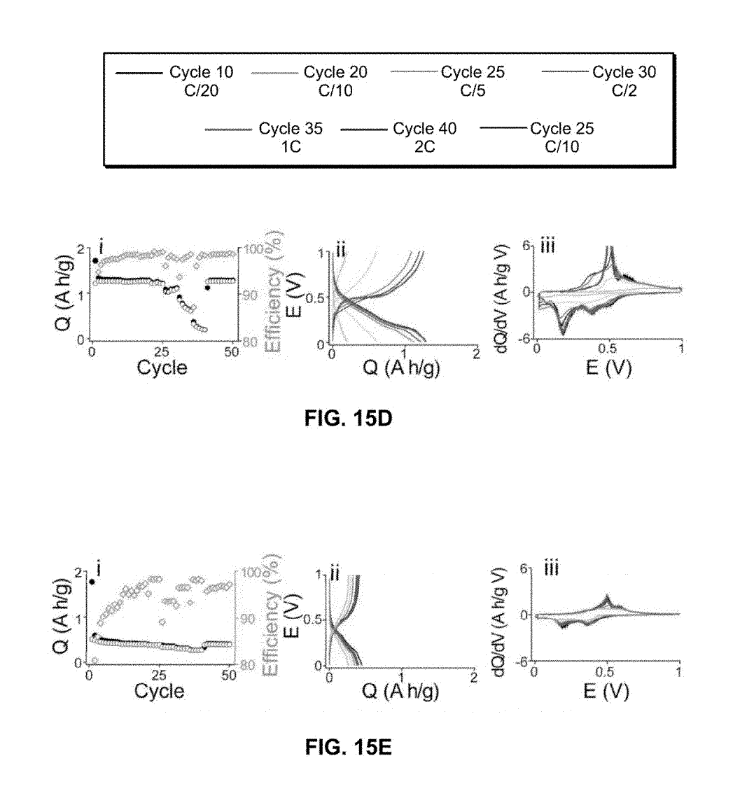

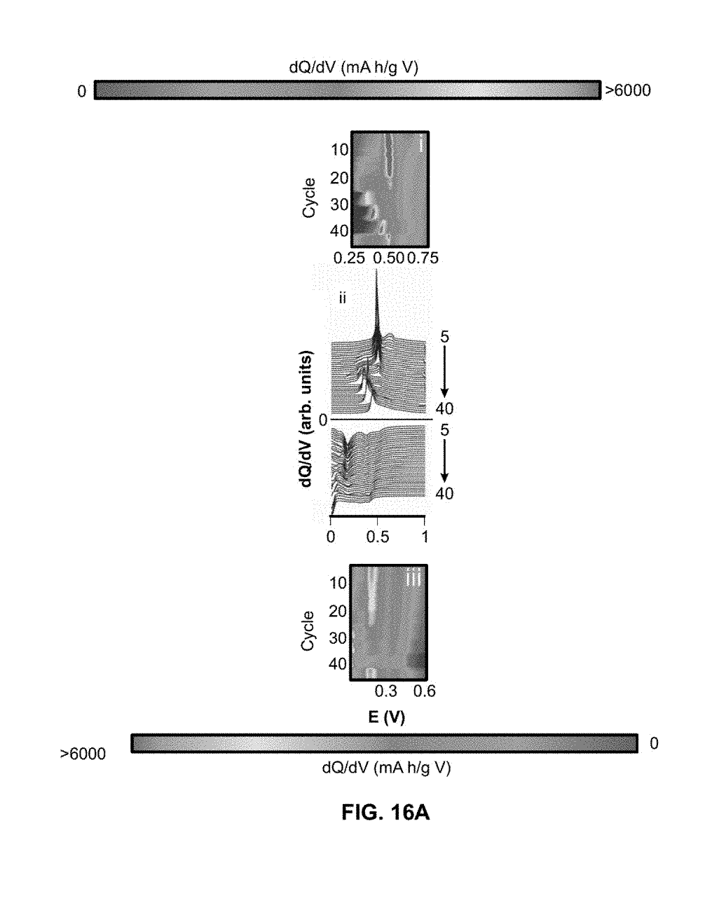

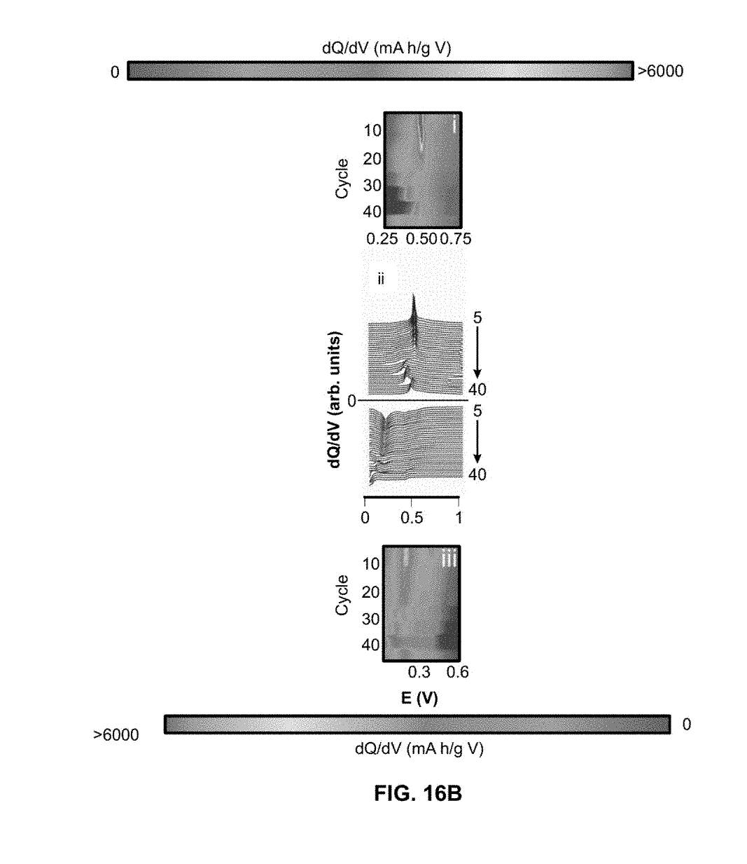

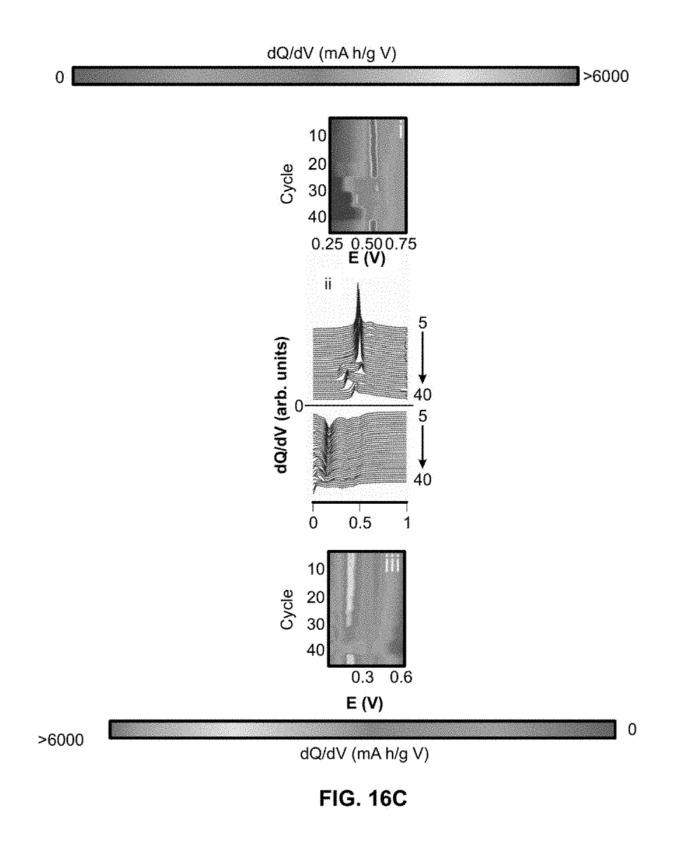

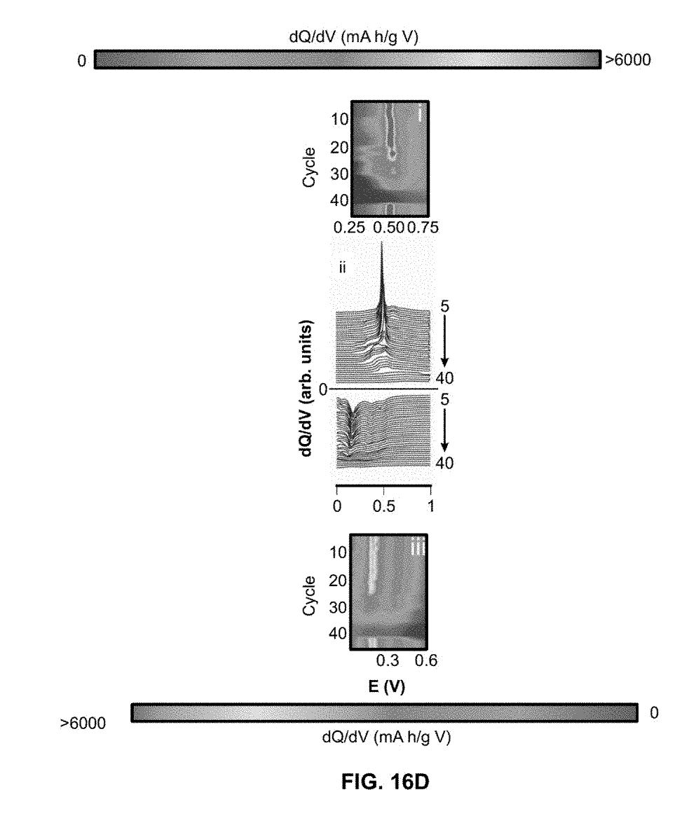

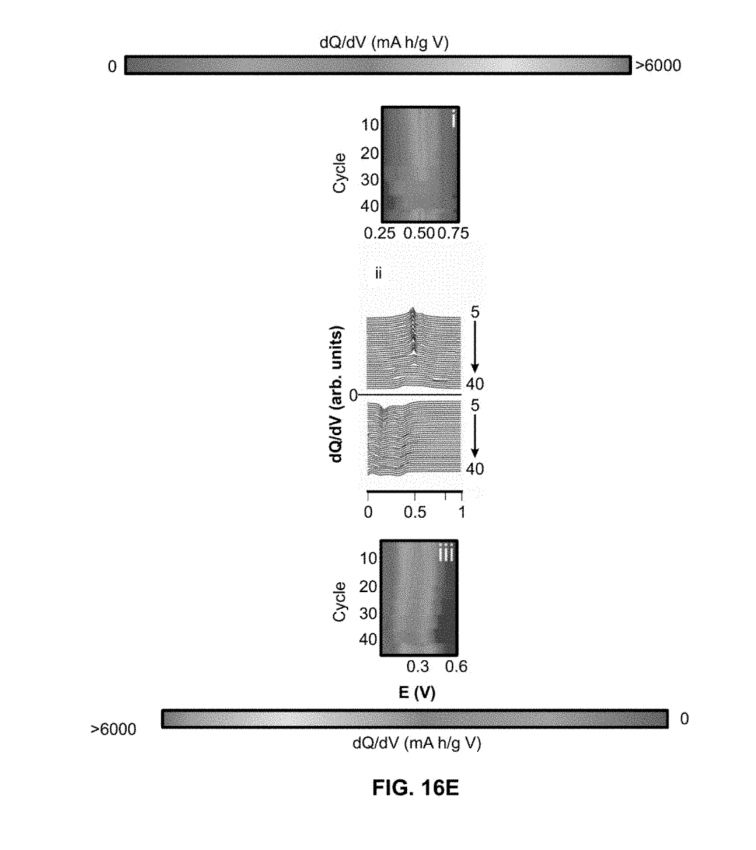

The voltage profiles and differential capacity plots that correspond to the battery data in FIG. 14 are further presented in FIGS. 15A-15E and 16A-16E. Specifically, FIGS. 15A-15E show (i) charge and discharge capacity (Q), Coulombic efficiency, (ii) voltage profiles, and (iii) differential capacity and FIGS. 16A-16E show differential capacity (panels i and iii) color maps and (panel ii) waterfall plots with the differential capacity during discharge or delithiation shown in the top two rows (panel i and top panel of ii) and charge or lithiation shown in the bottom two rows (bottom panel ii and panel iii). As shown in FIGS. 15A-15E and 16A-16E, when cycle rate was increased above C/5 and the capacity dropped, the sharp delithiation peak at 500 mV decreased significantly in intensity and shifted to lower potential. This distinct shift in the delithiation peak to lower potential might indicate a slightly altered delithiation pathway at the faster cycle rates. As the rate was further increased above C/2, the delithiation peak shifted back toward 500 mV. The shift in the delithiation peak to higher potential and the lithiation peaks to lower potential with faster cycle rates indicate that the kinetic limitations are limiting the capacity of the battery. These changes were reversible for the FEC-containing batteries when the cycle rate returned to C/10. The lithiation and delithiation features, especially the sharp delithiation peak at 500 mV, in the batteries with significant capacity fade, i.e., batteries a and b, did not return when the cycle rate returned to C/10.

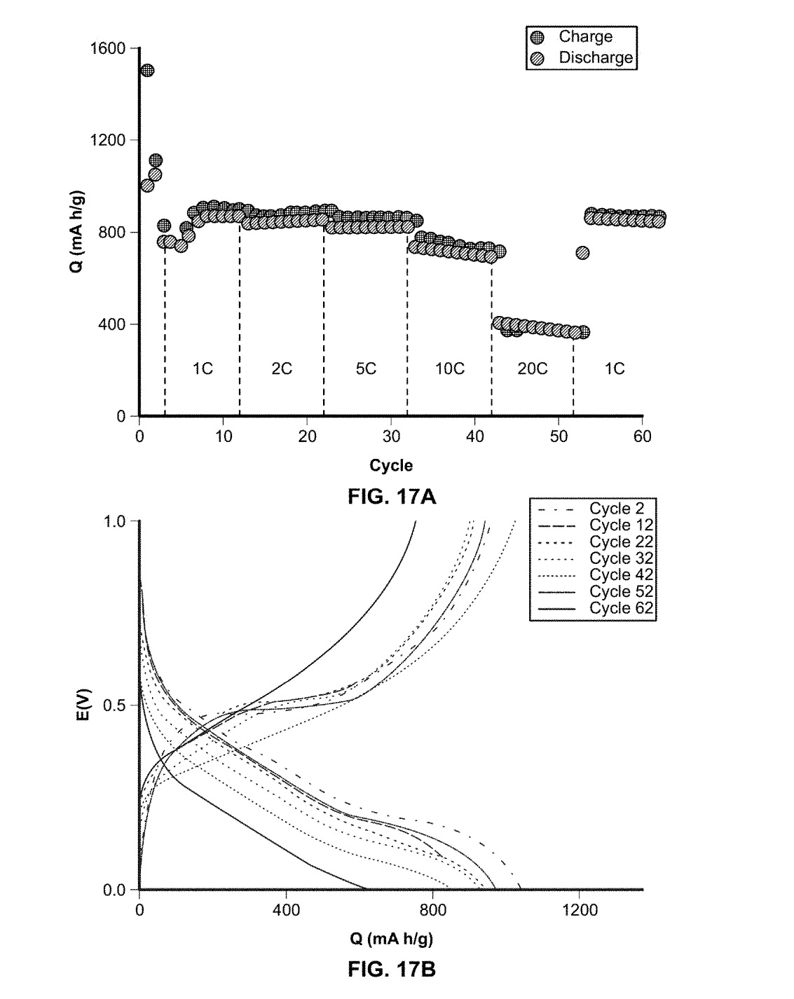

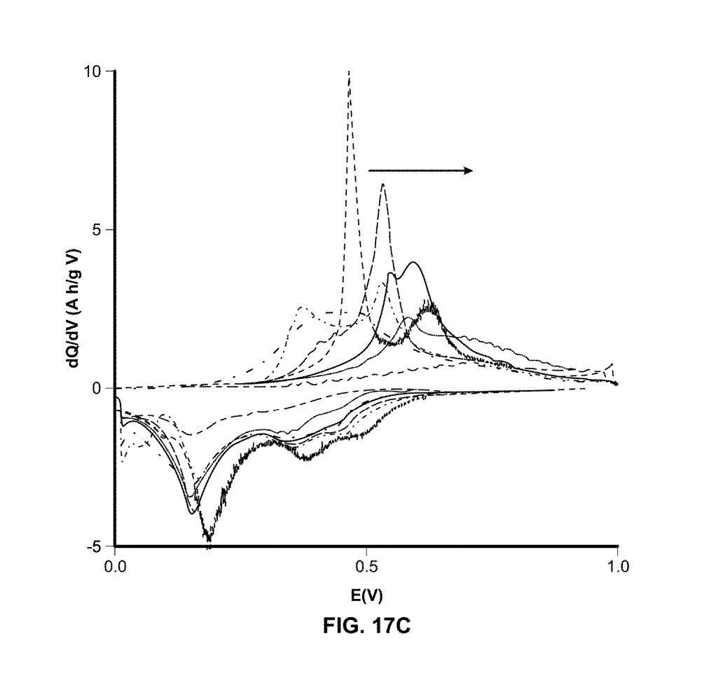

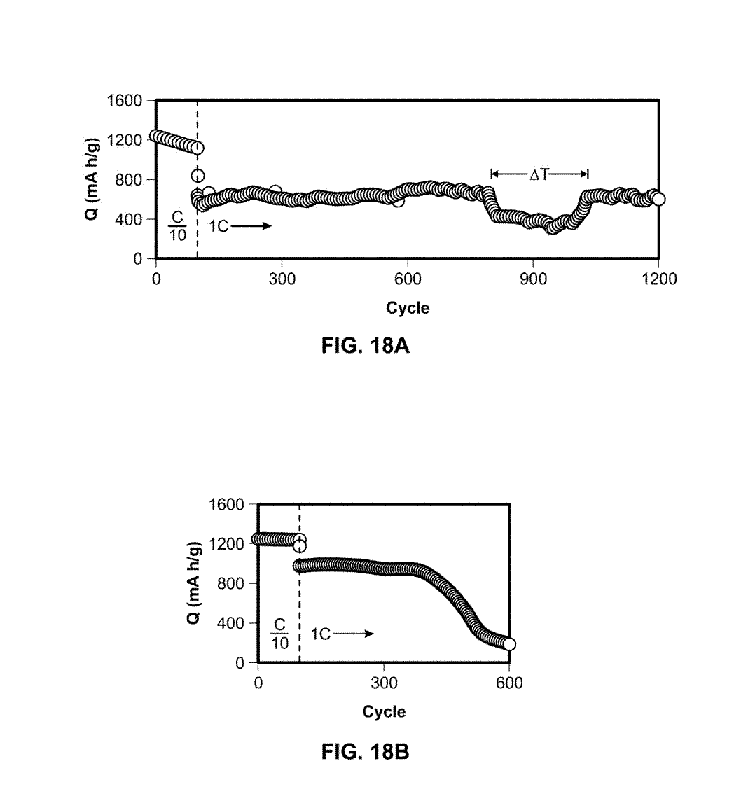

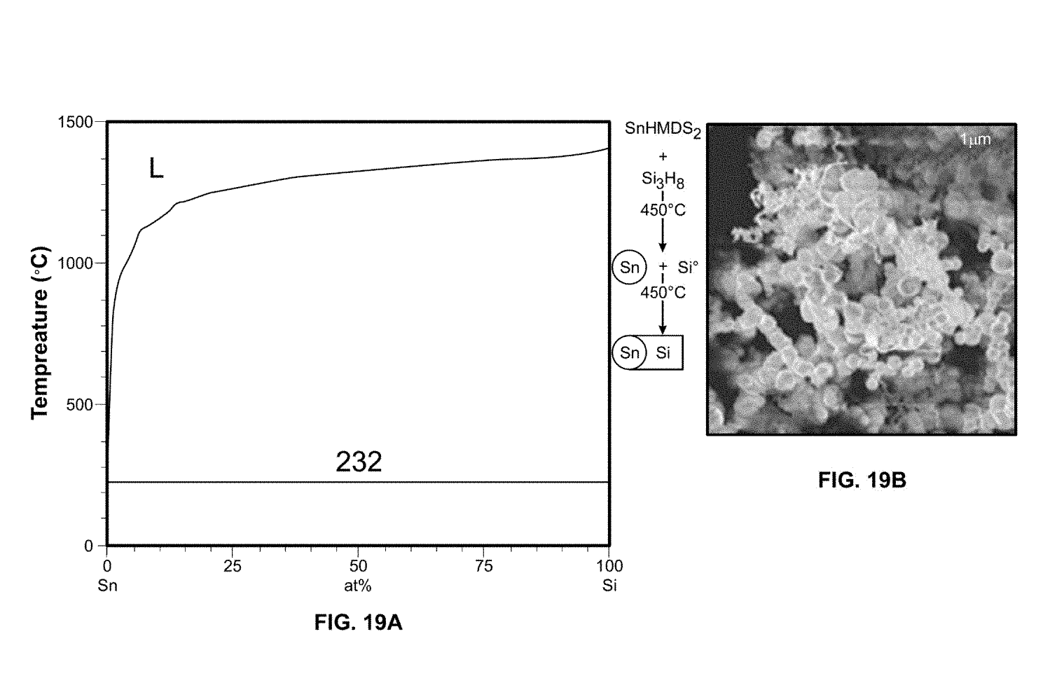

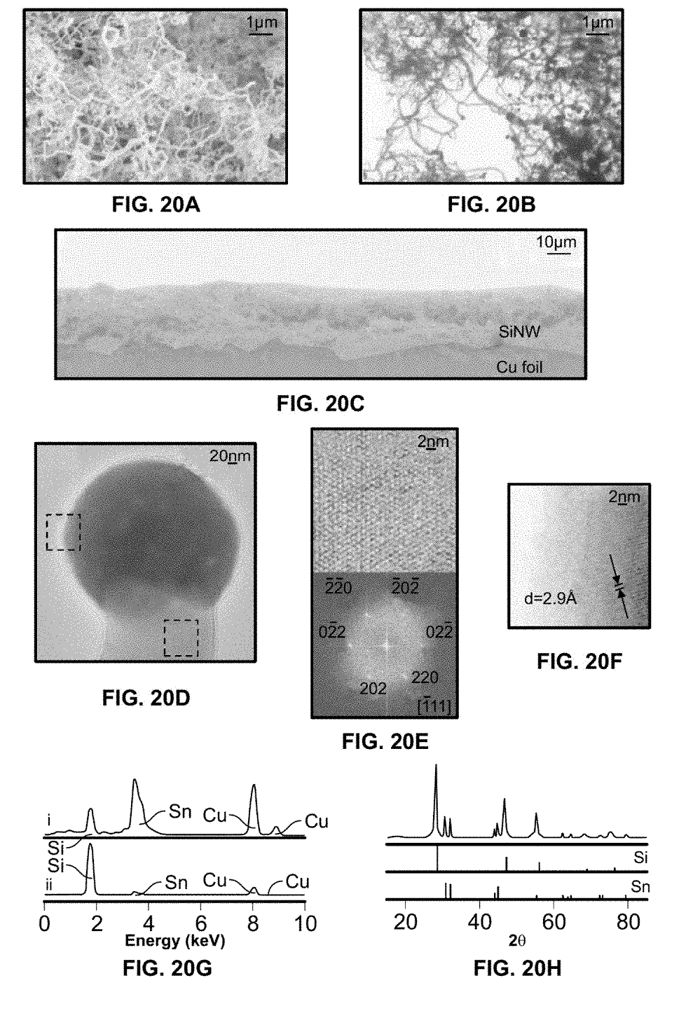

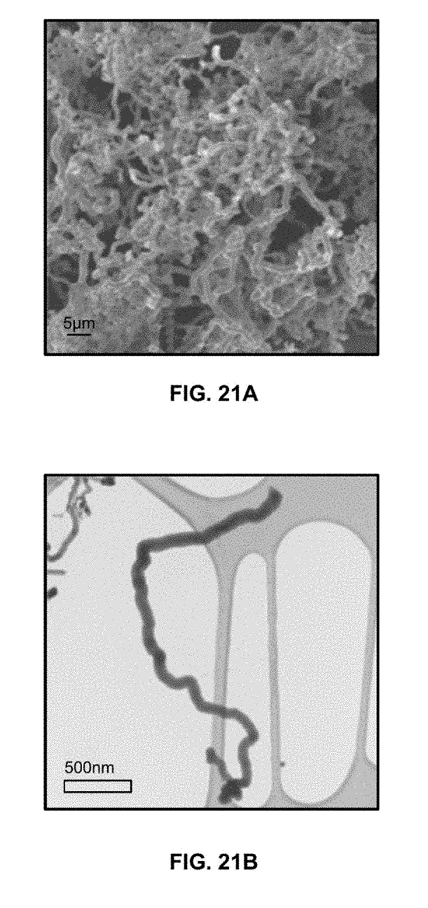

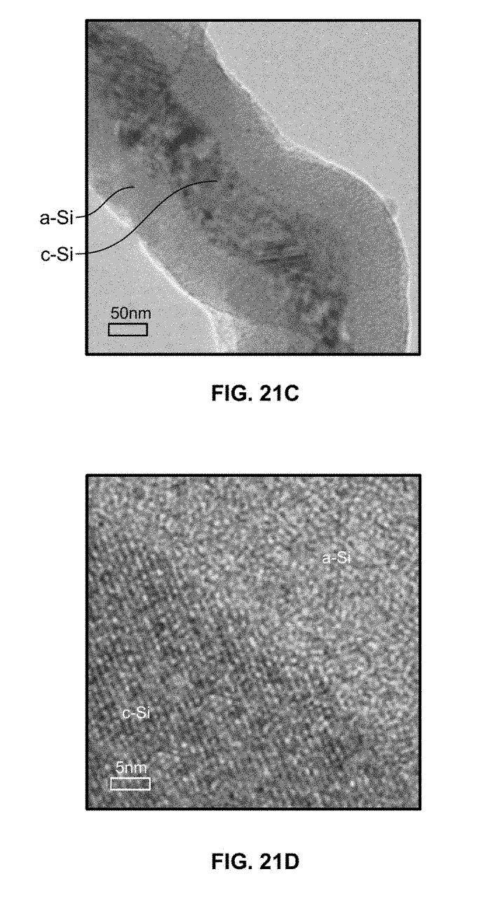

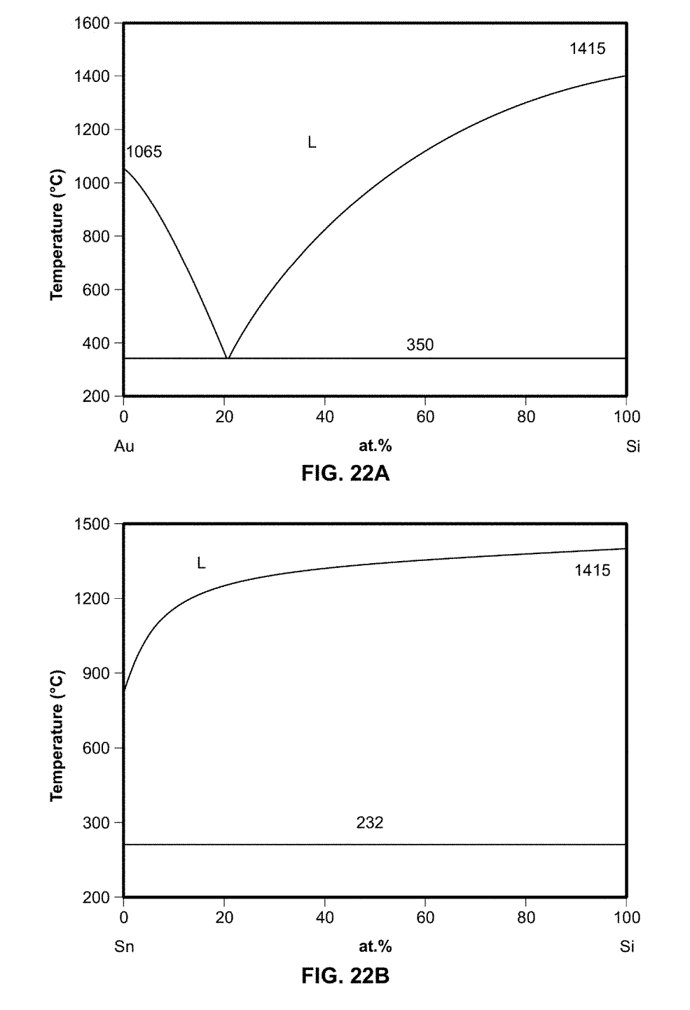

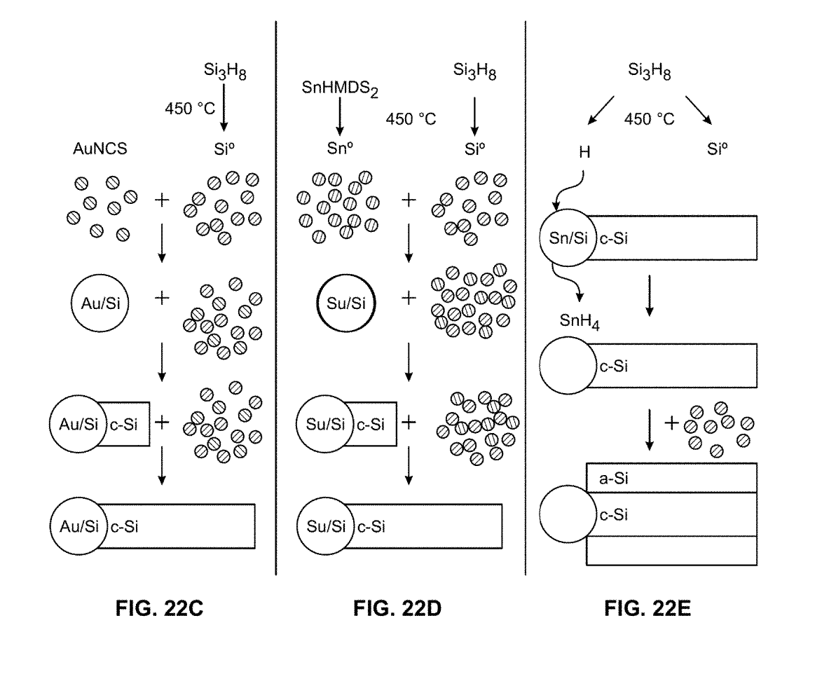

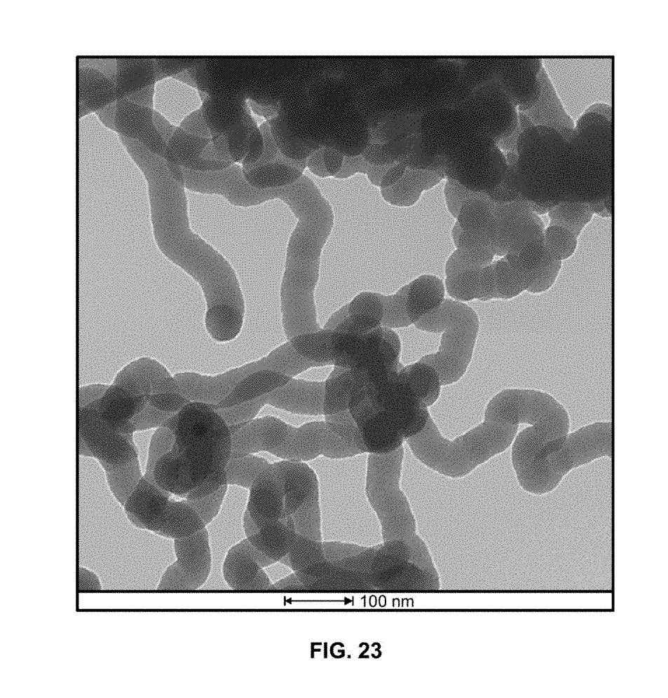

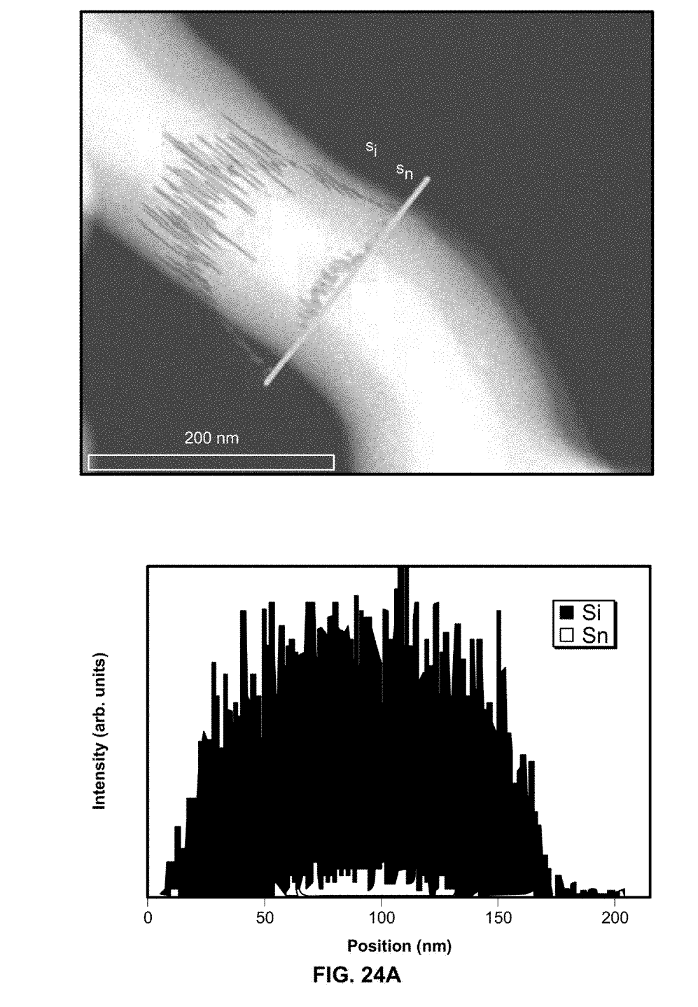

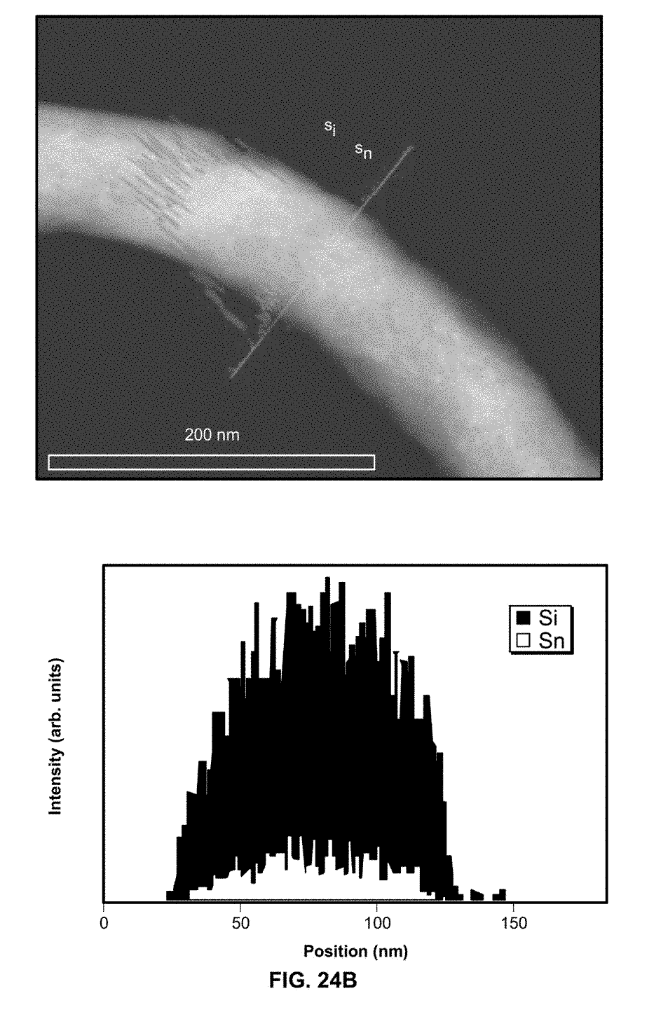

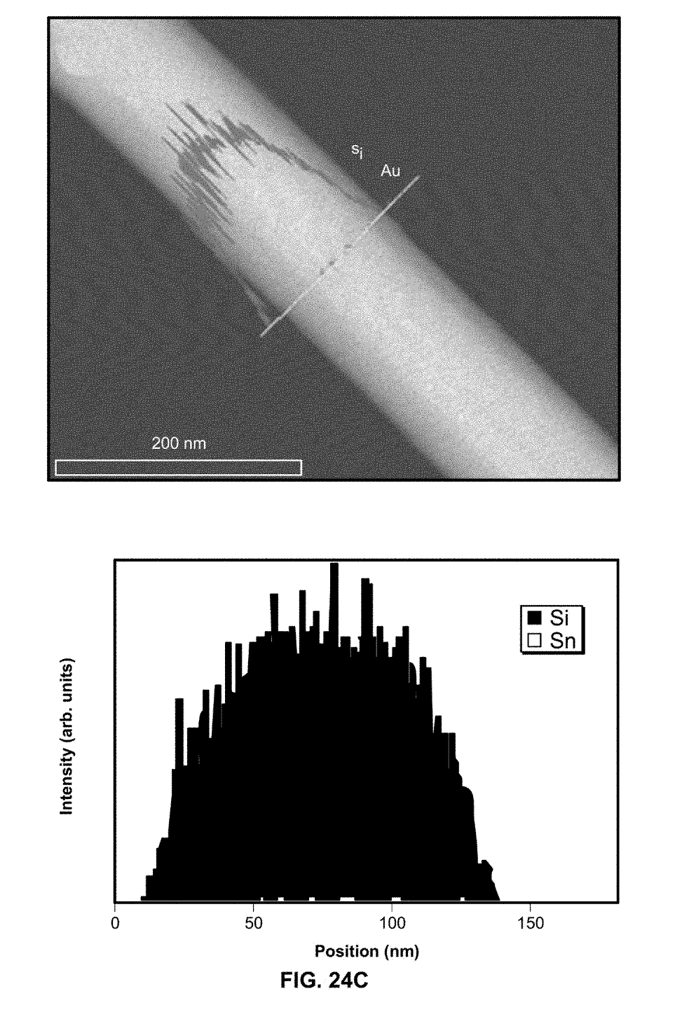

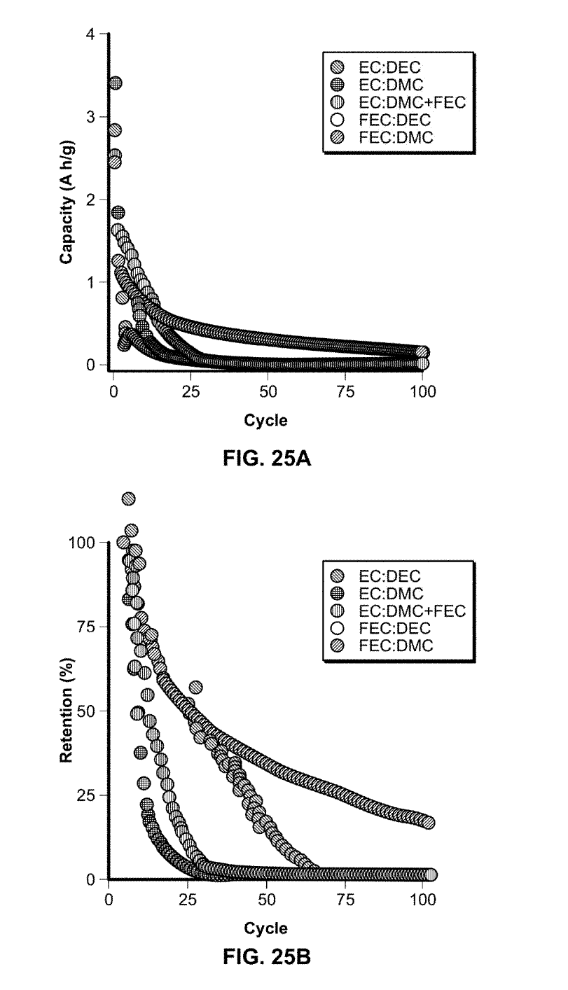

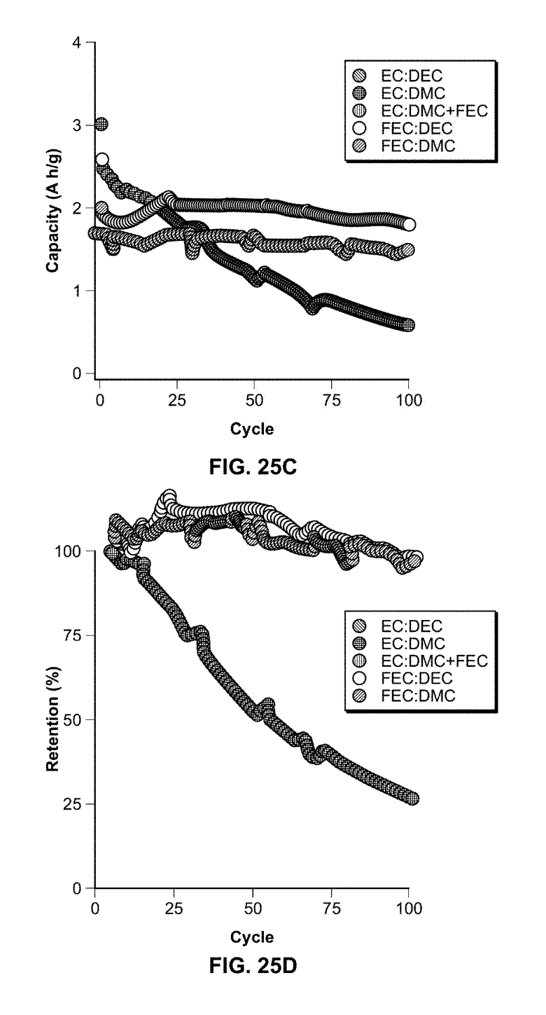

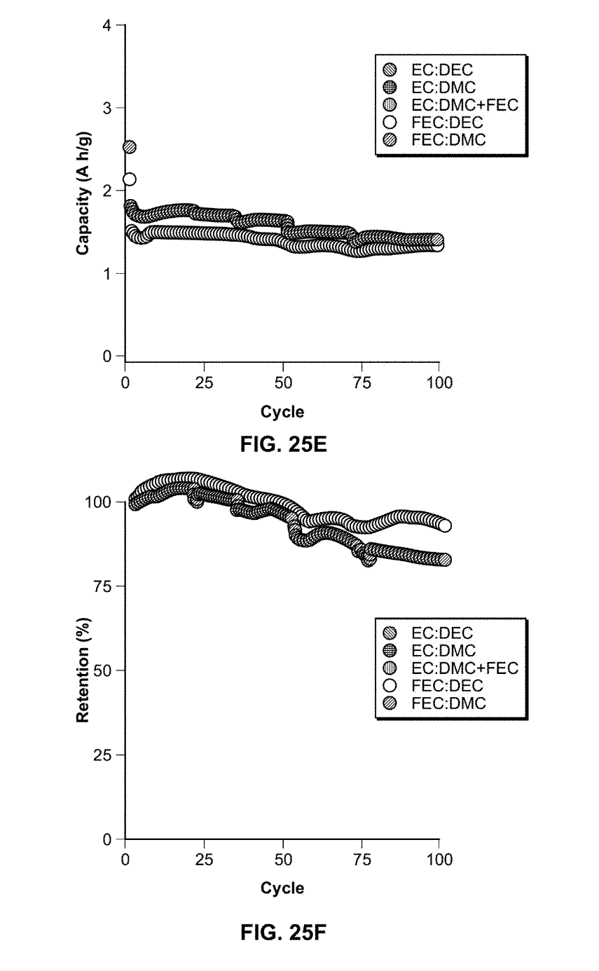

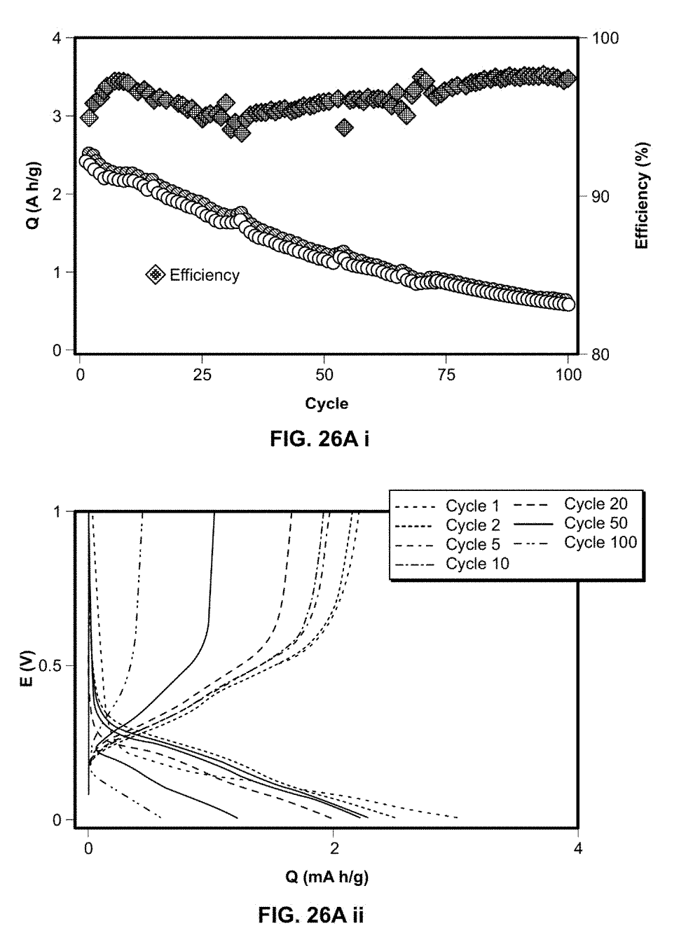

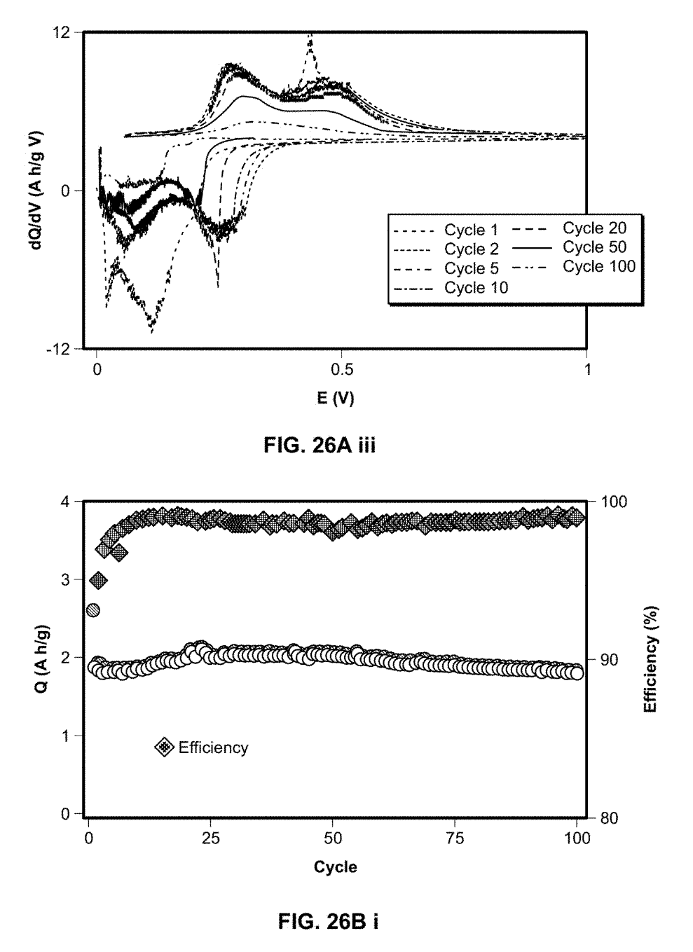

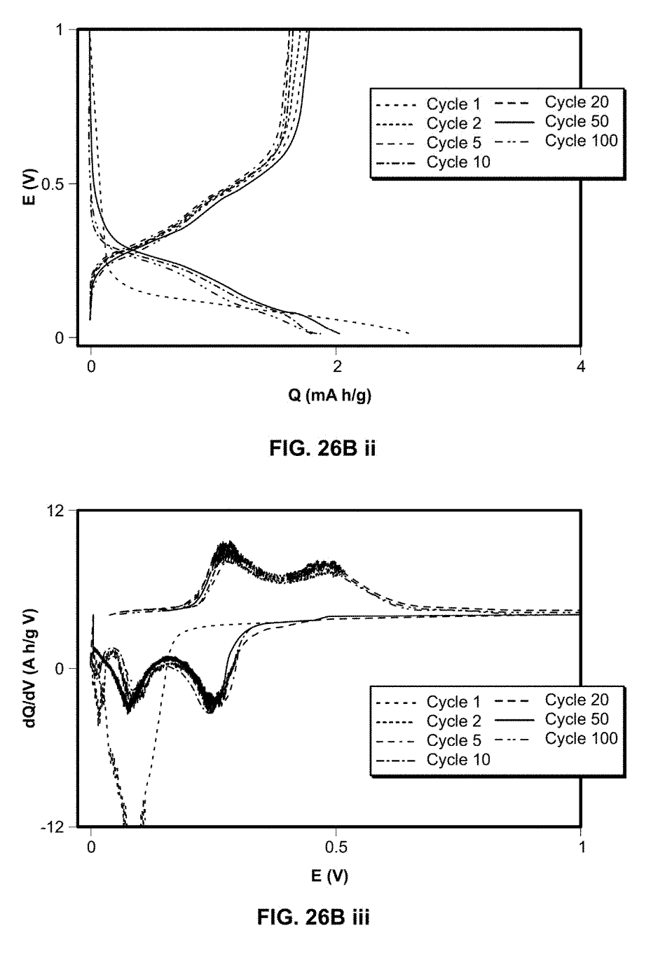

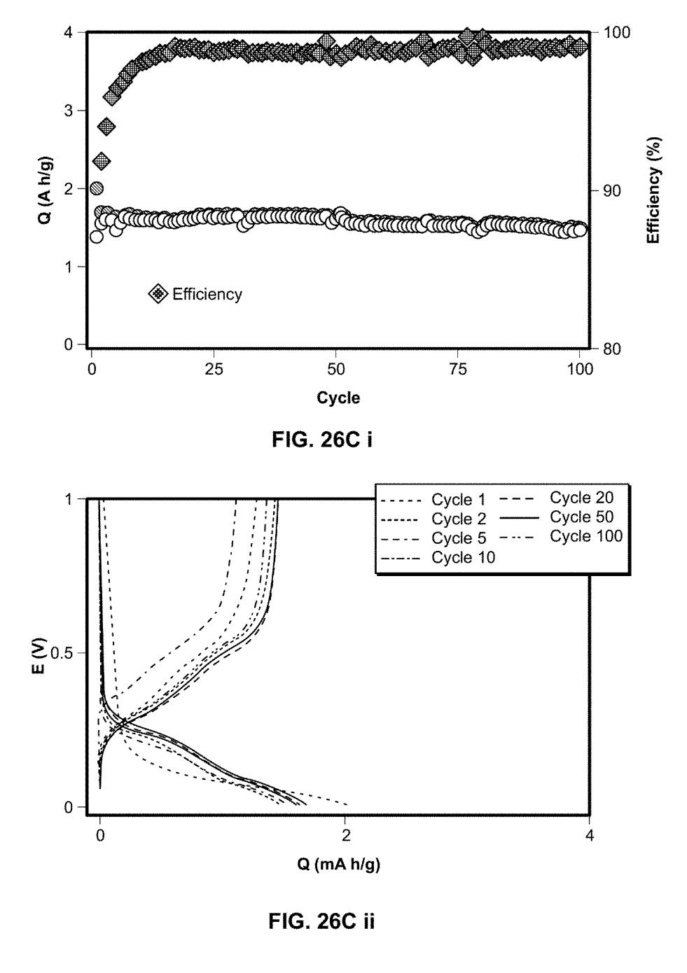

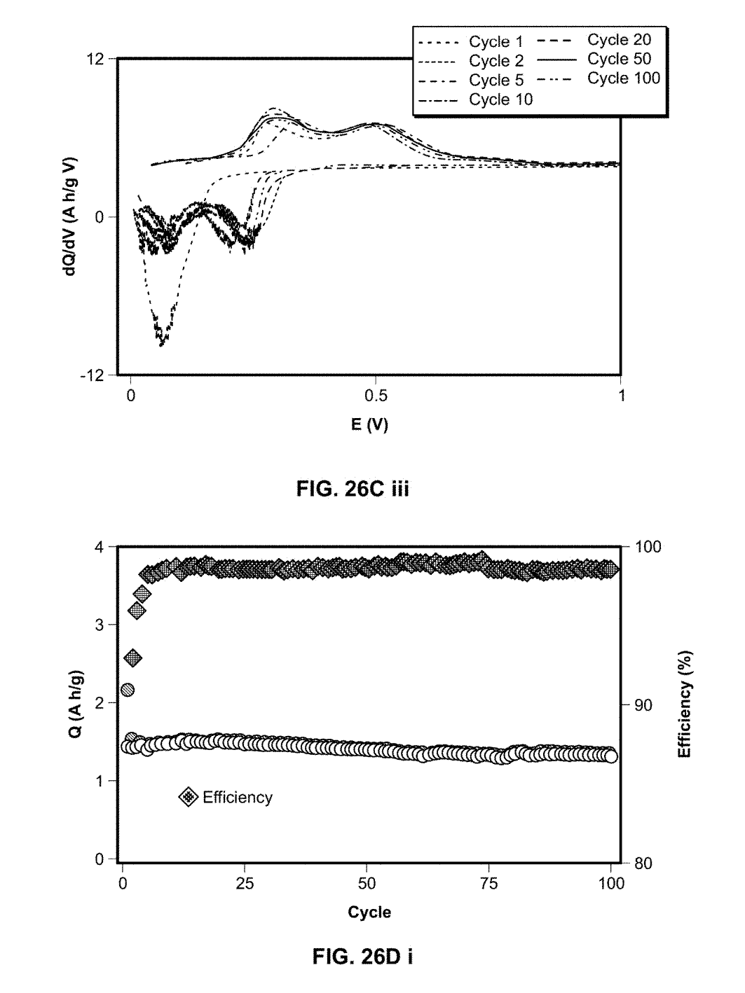

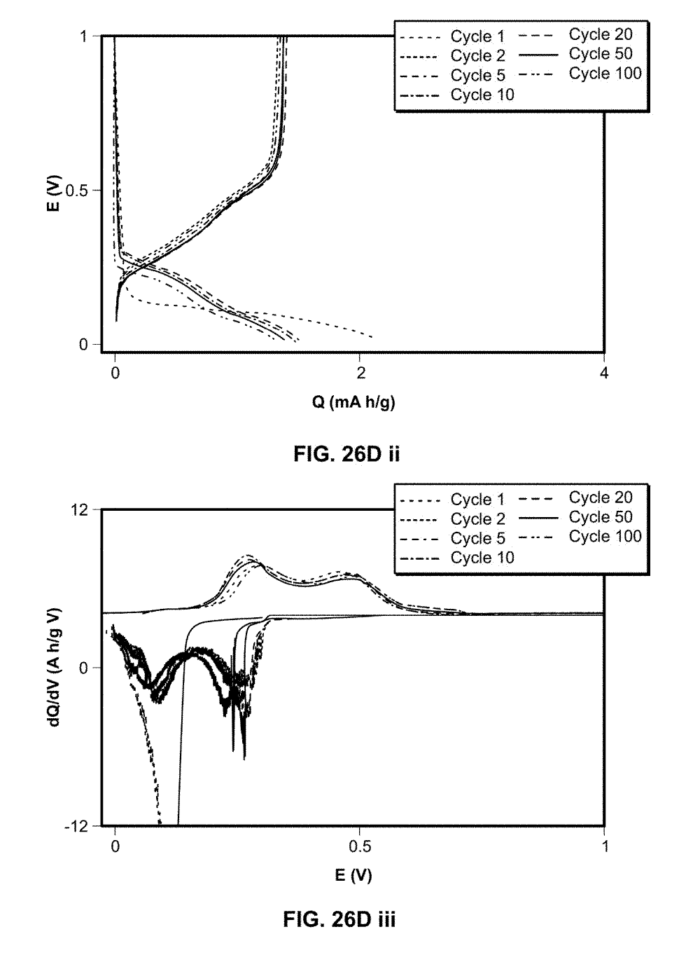

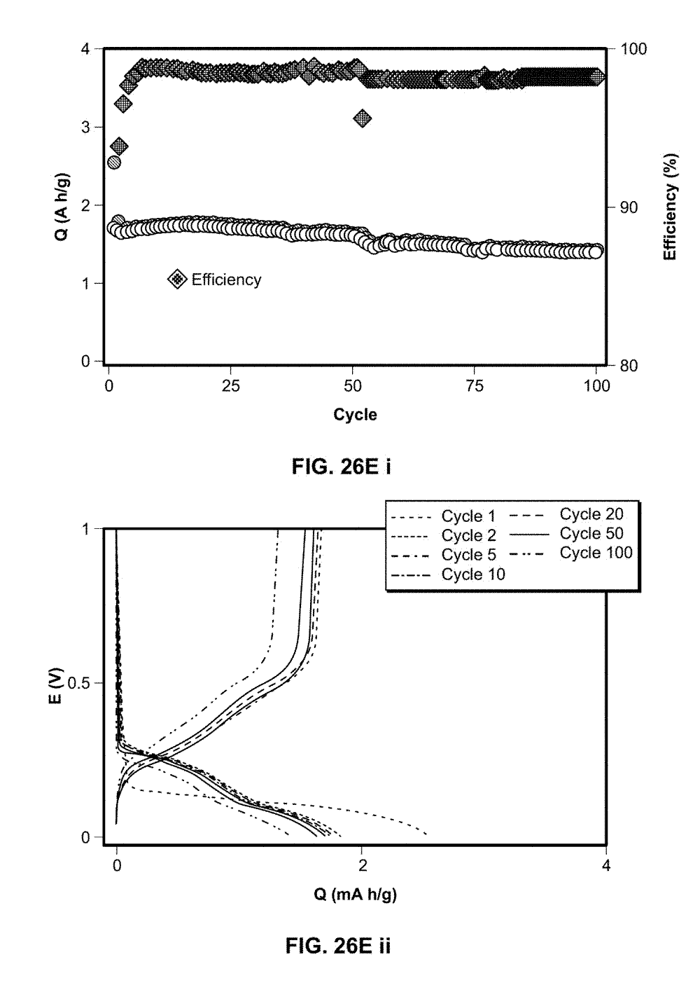

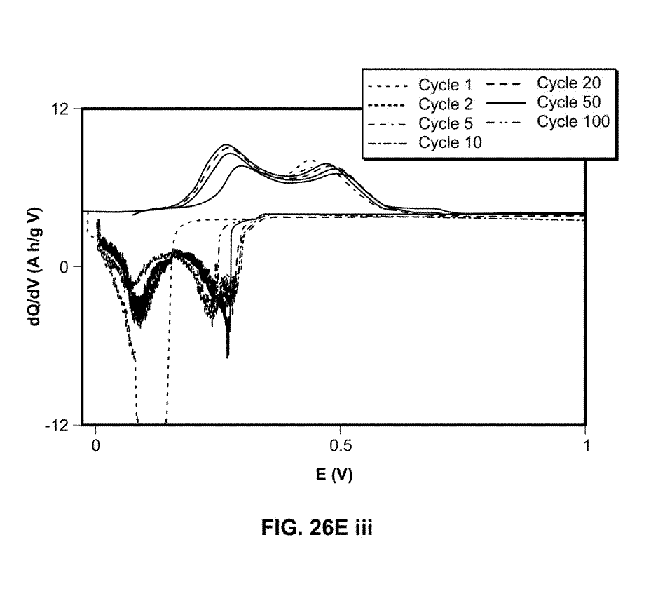

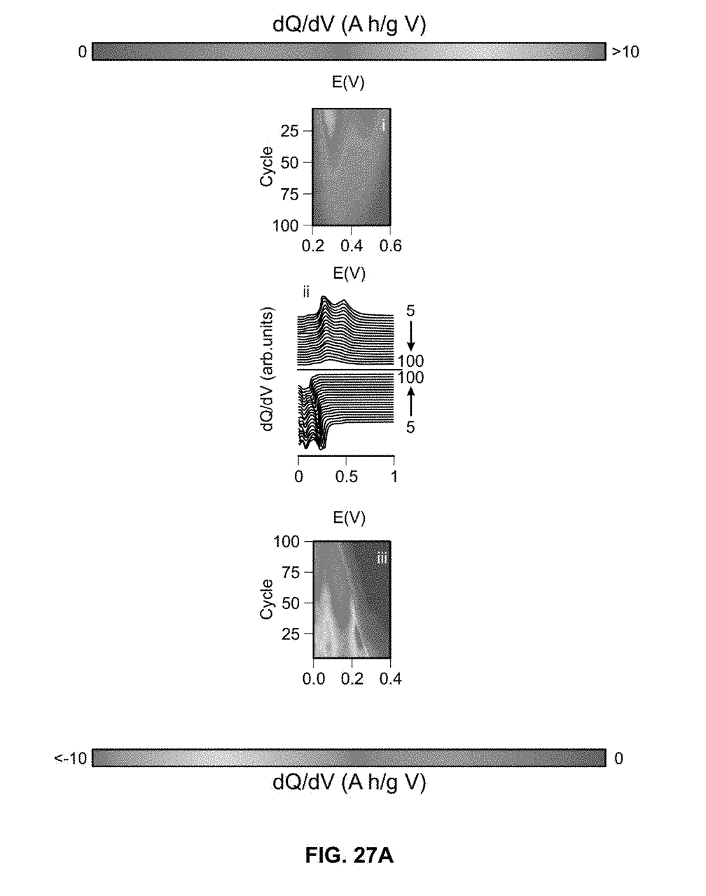

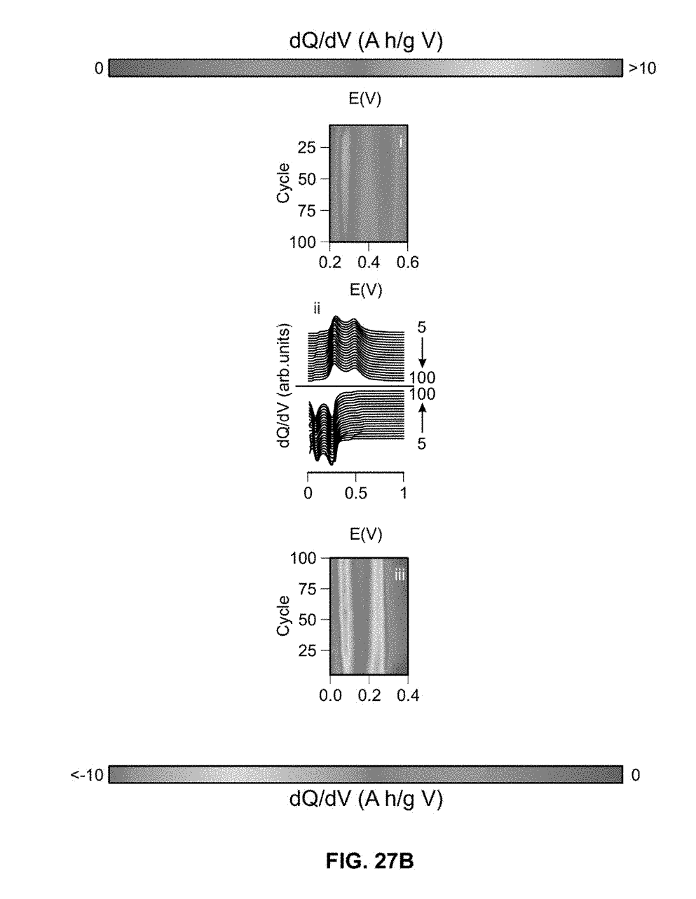

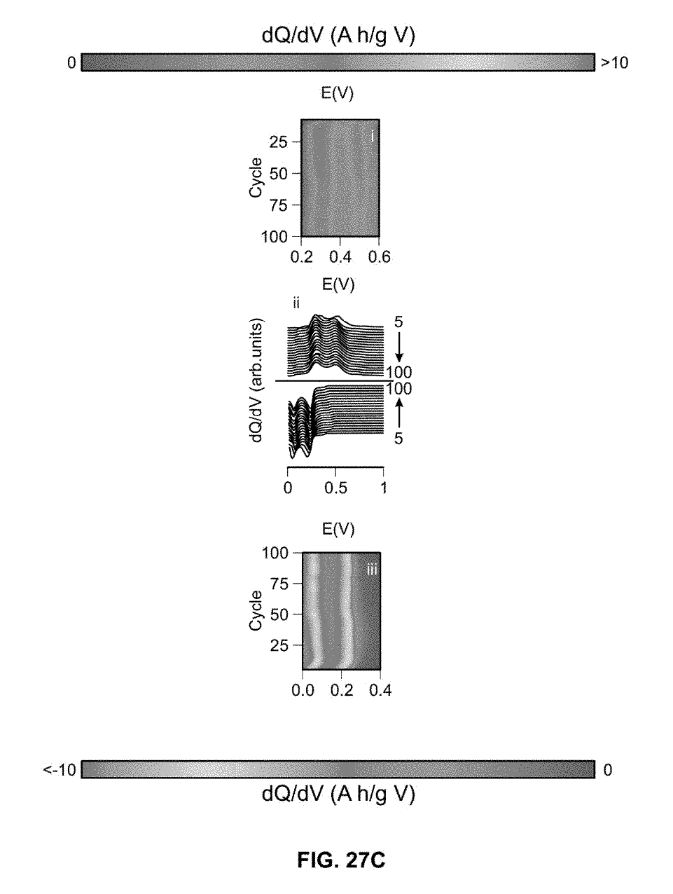

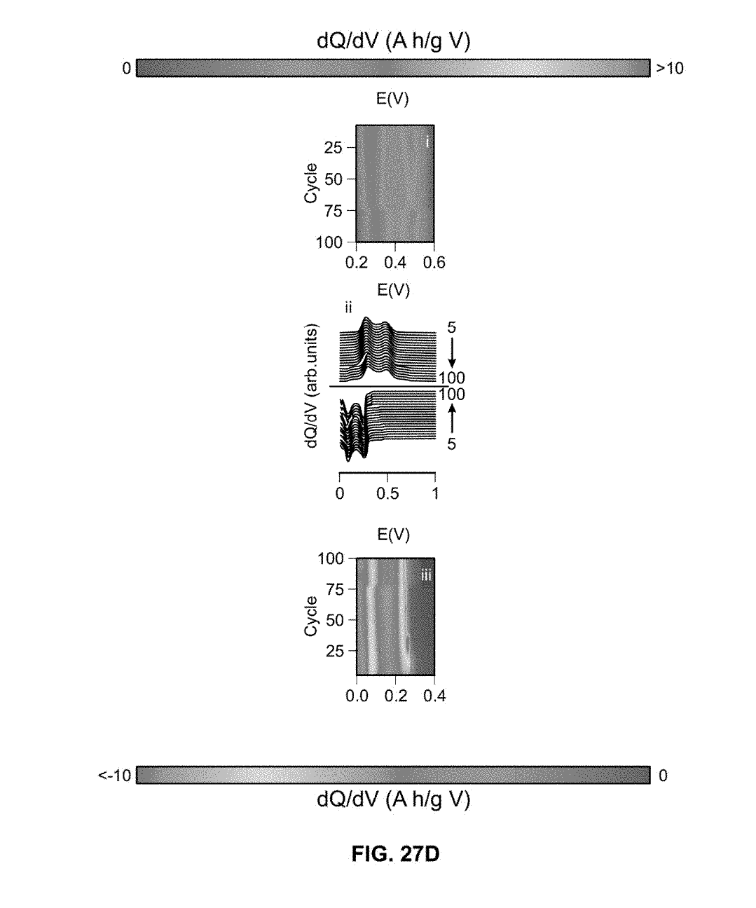

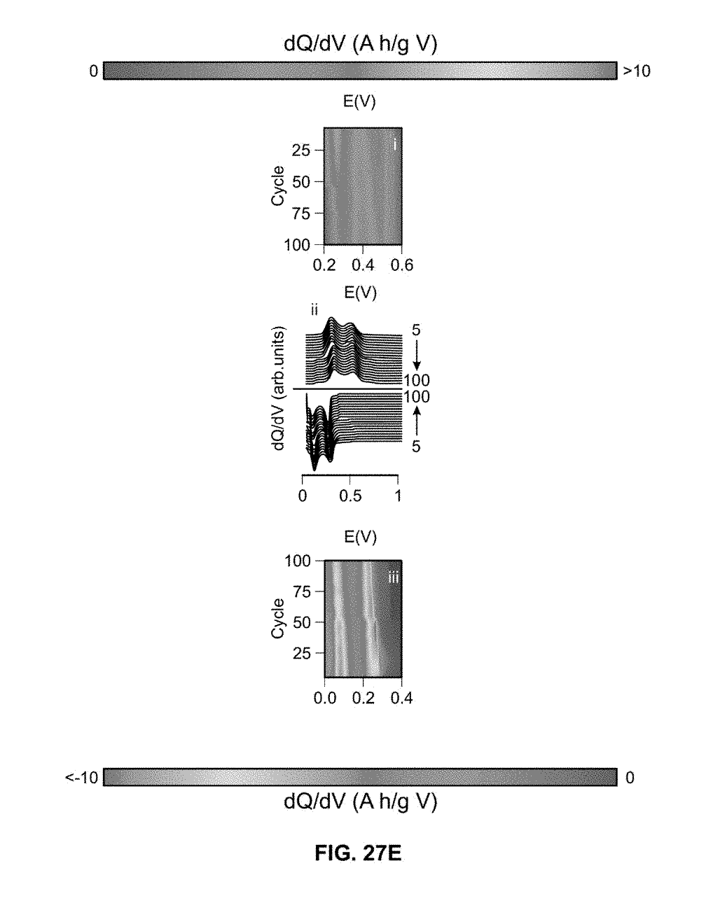

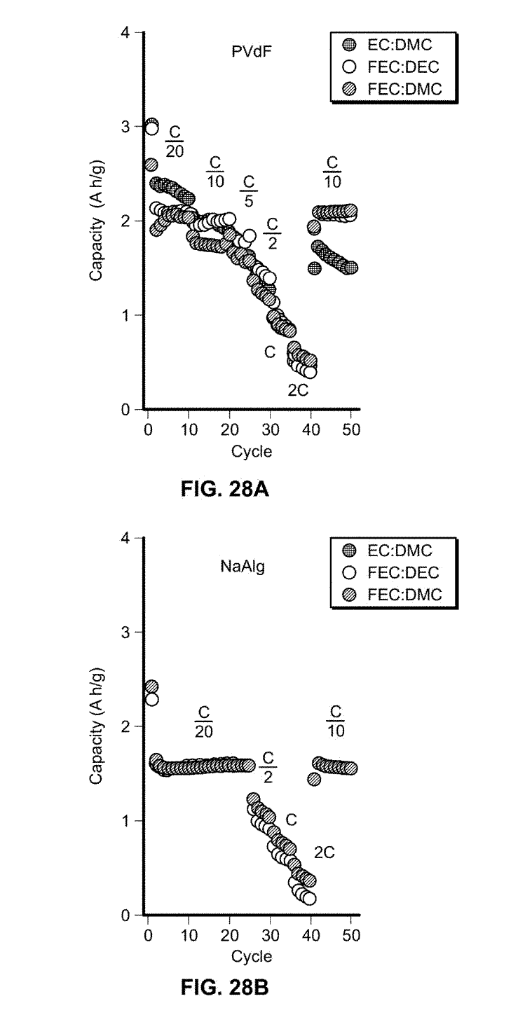

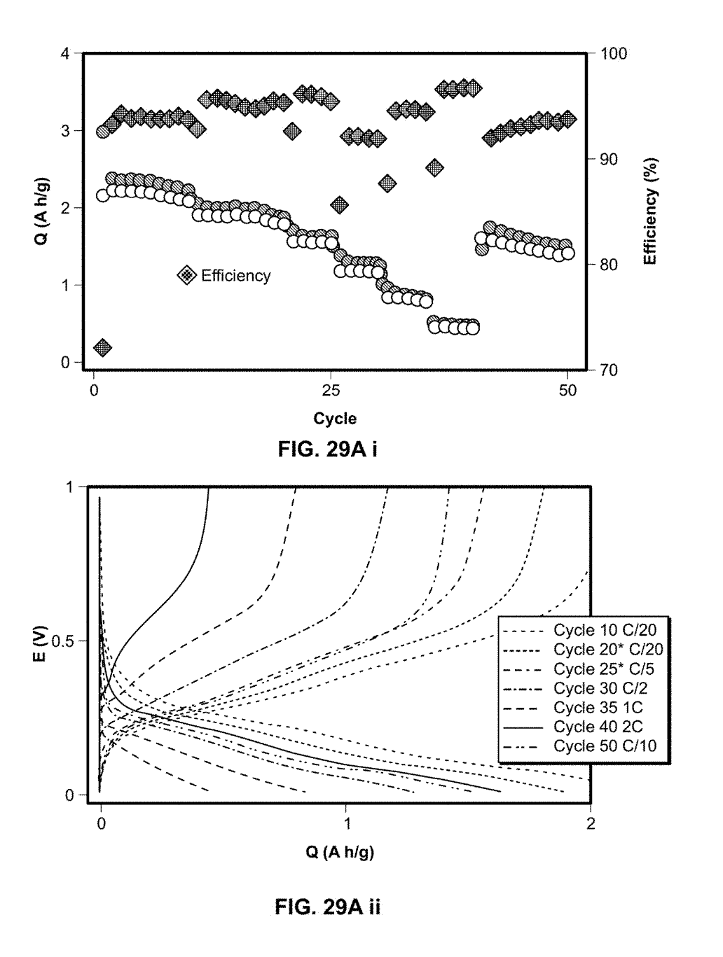

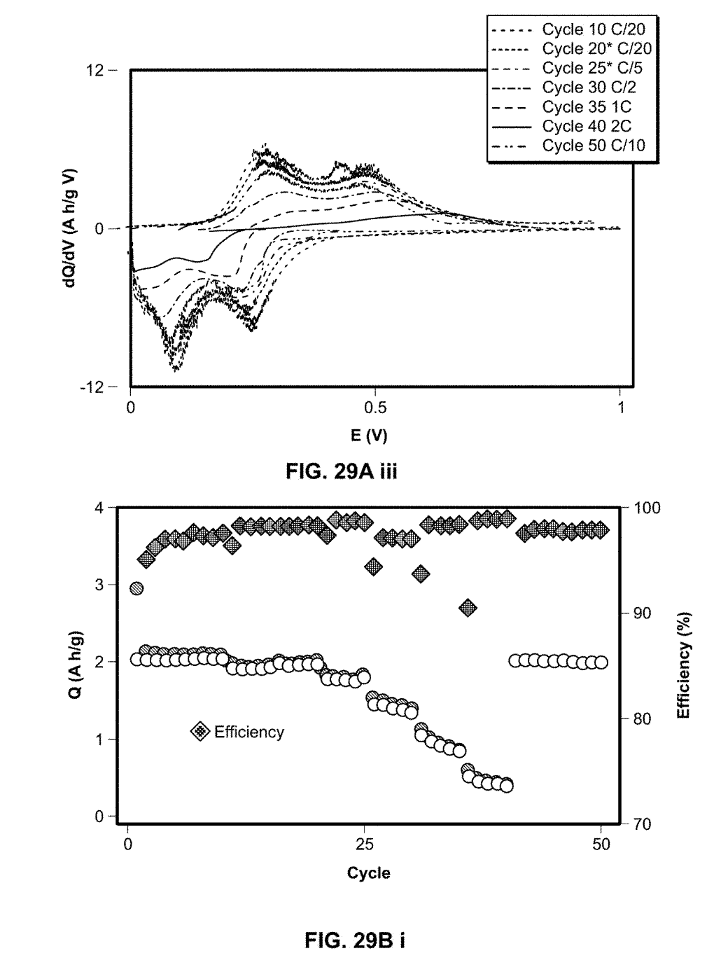

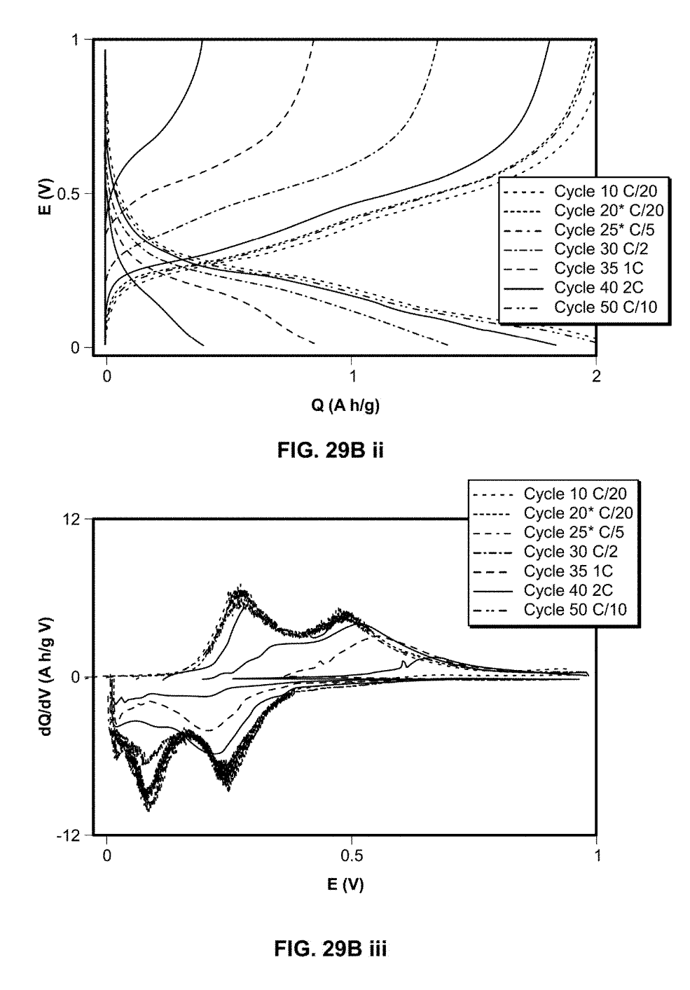

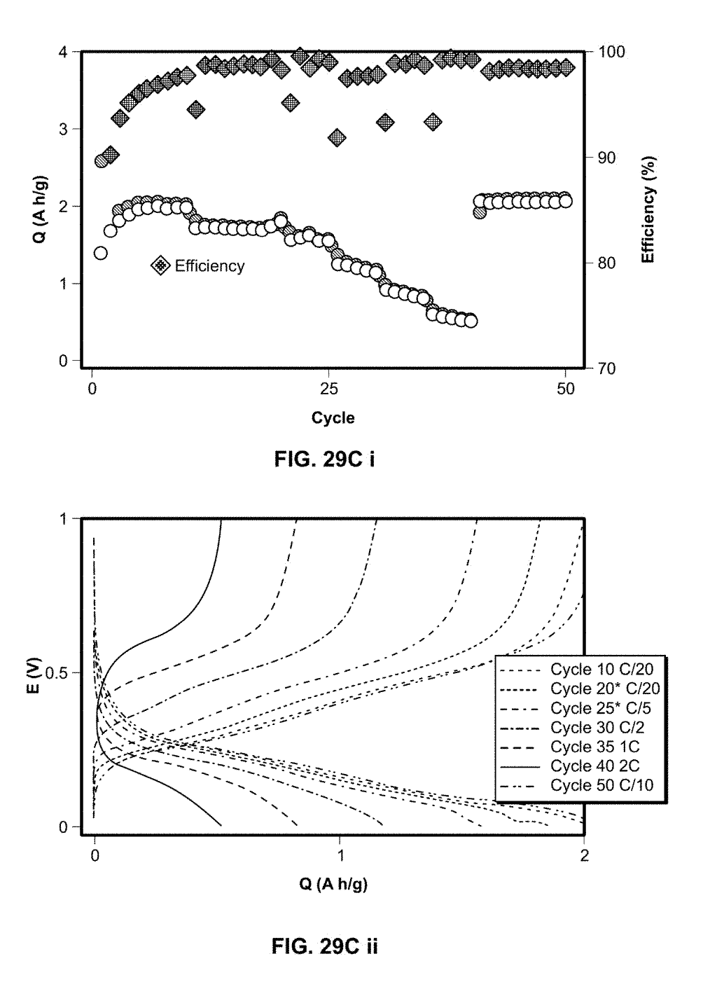

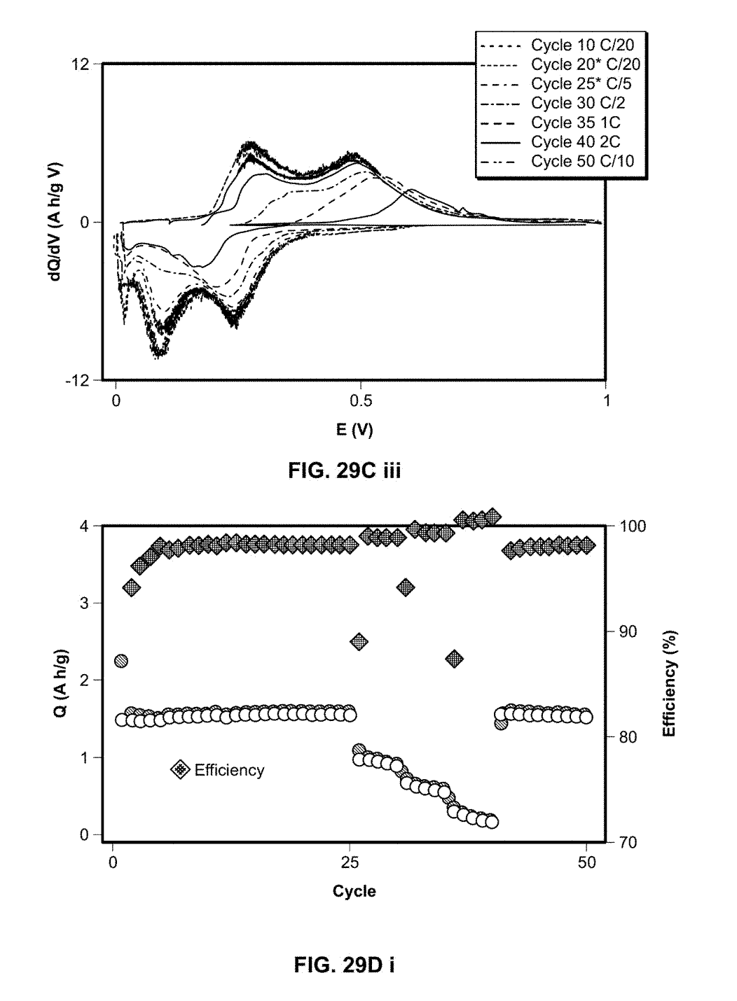

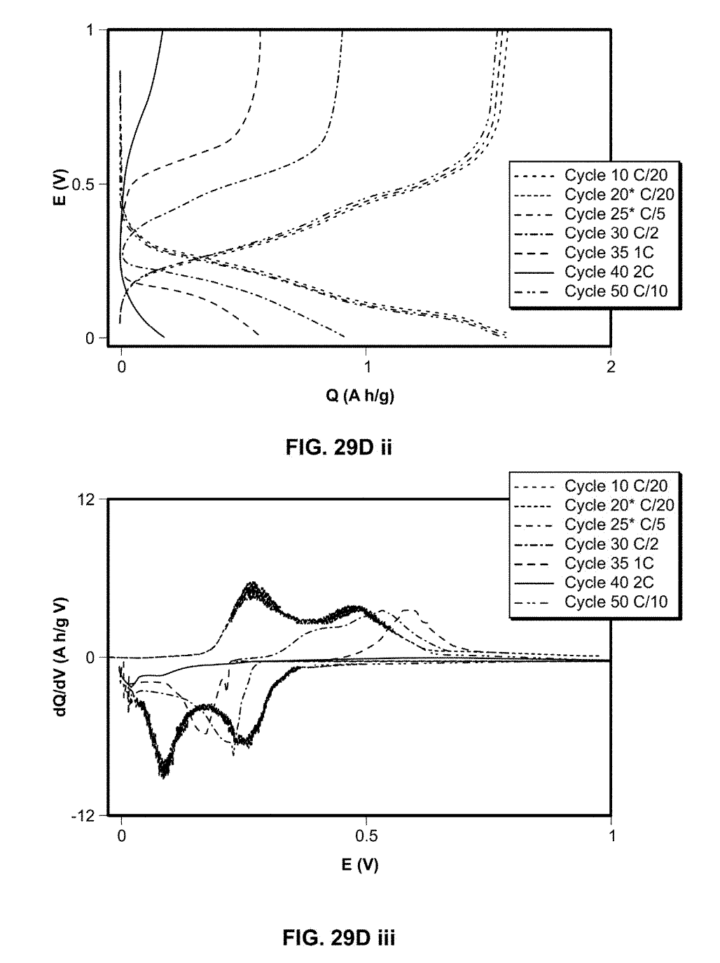

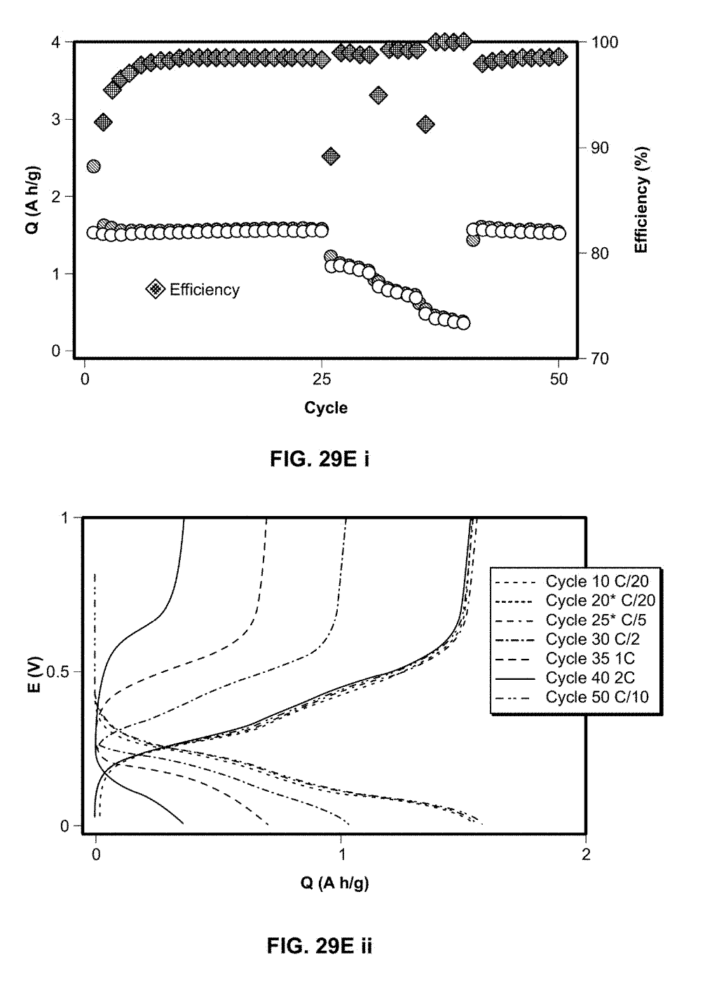

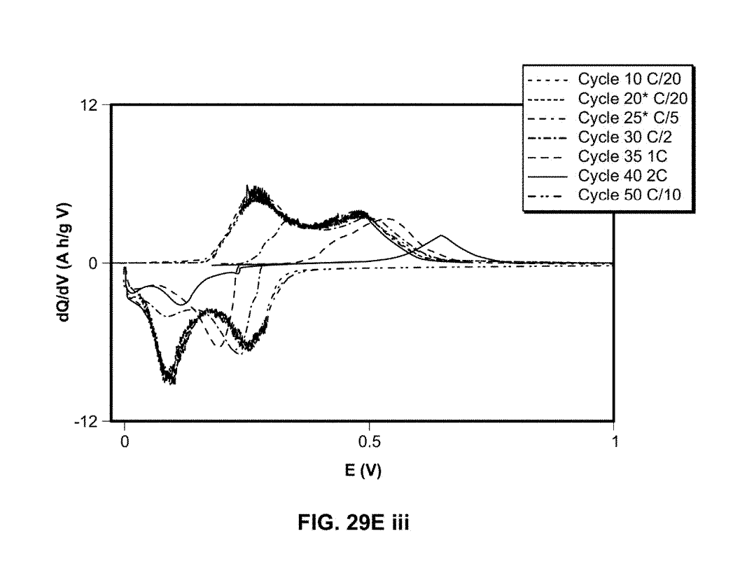

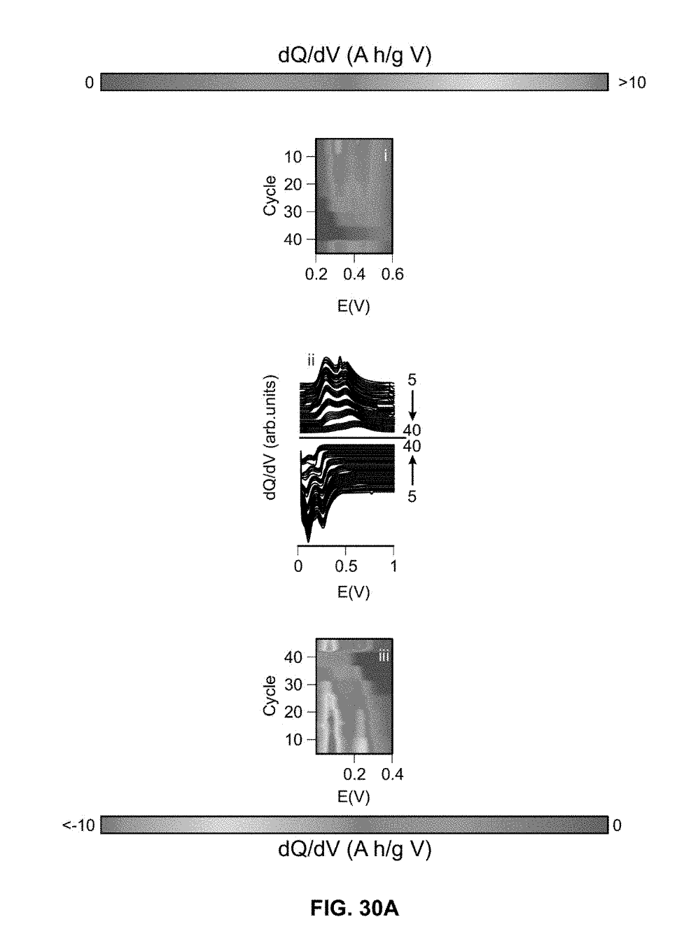

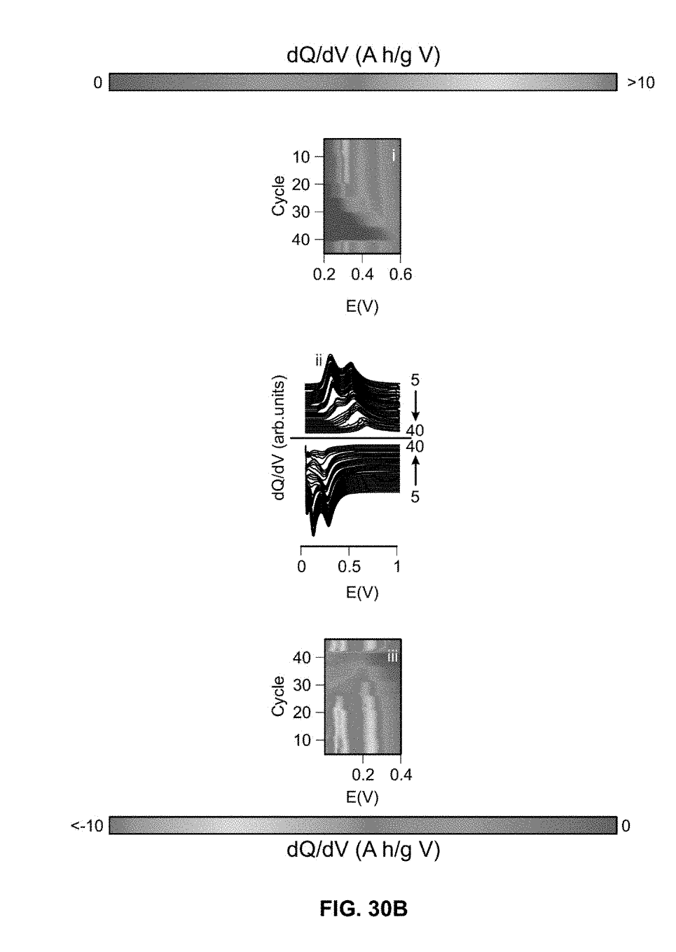

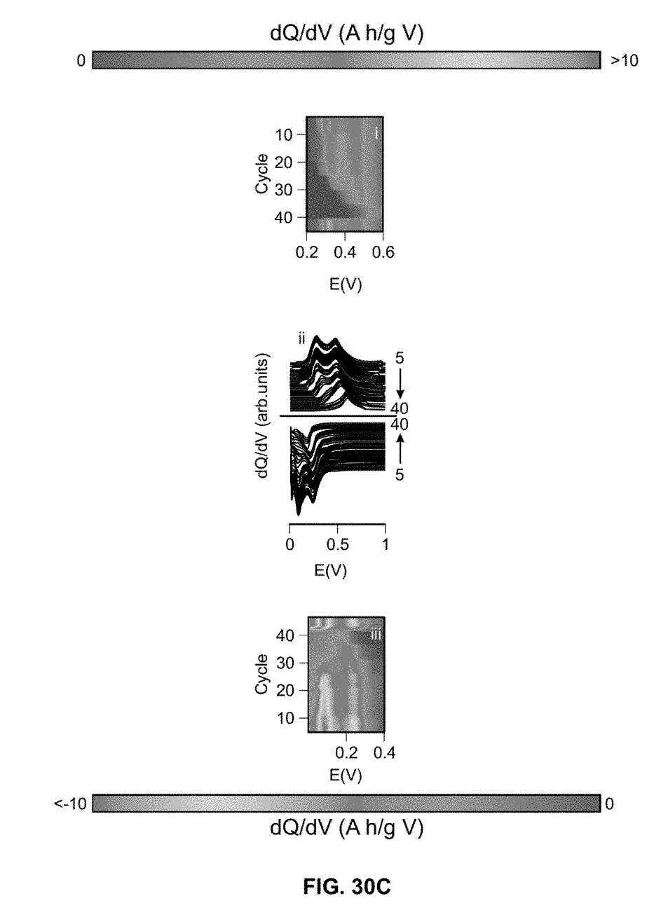

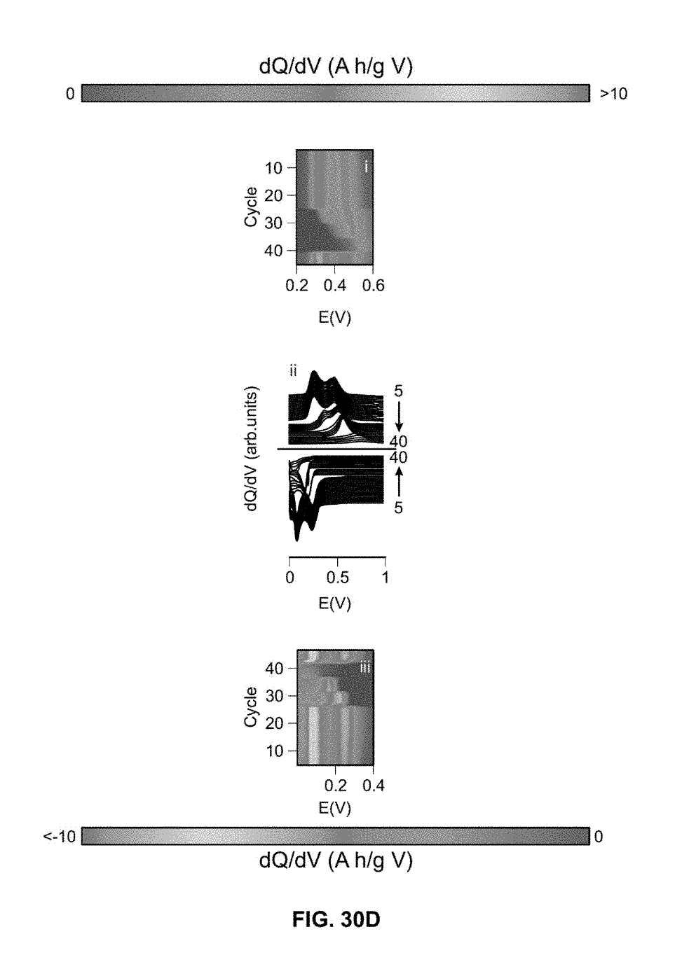

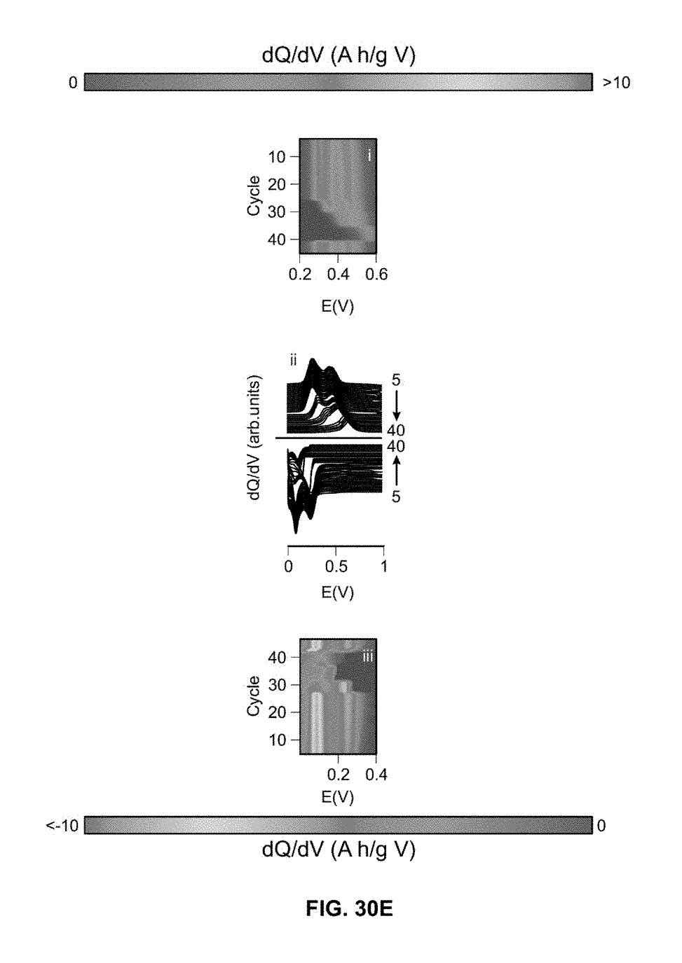

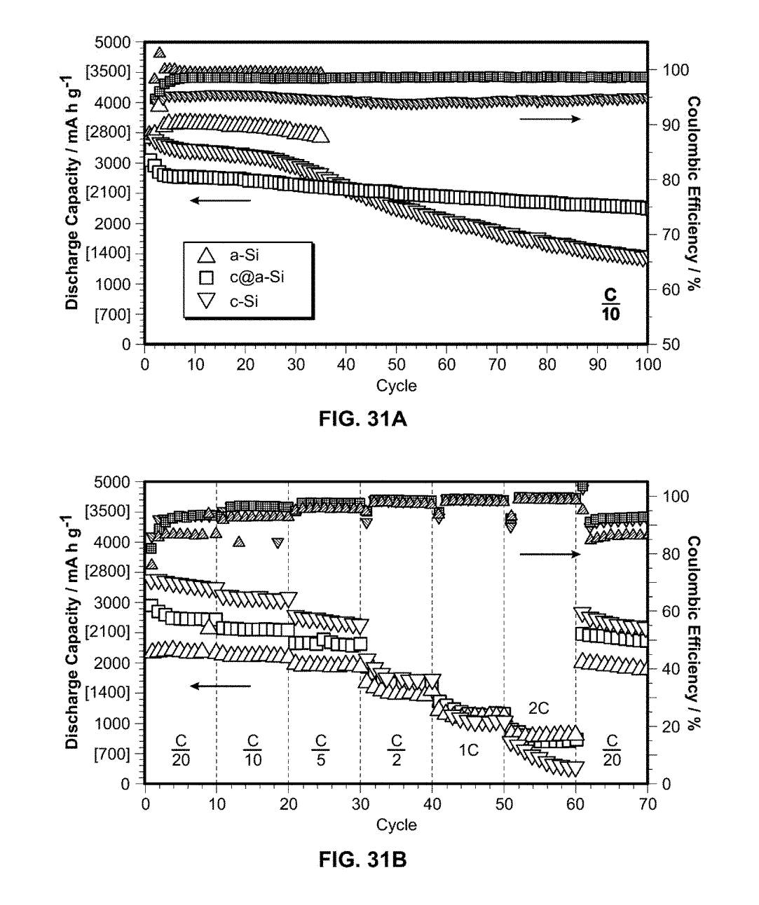

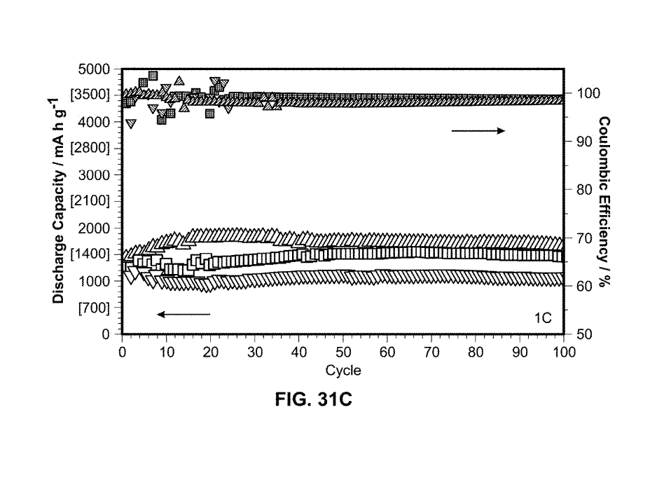

Ge is known to perform very well at high cycle rates (Wang et al., J. Mater. Chem. 2011, 22, 1511-1515; Park et al., Angew. Chem. Int. Ed. 2011, 50, 9647-9650; Graetz et al., J. Electrochem. Soc. 2004, 151, A698-A702); however, the data in FIG. 14 showed that the capacity of the Ge nanowire anodes suffered when the rate exceeded 1C. For many applications the charging and discharging rates do not need to be equivalent. For example, an electrical vehicle might tolerate a slower charge rate, but need in certain situations like rapid acceleration to have a fast burst of discharge. Battery c was tested under a similar condition by charging at a relatively slow rate of 1C, but then discharging at faster rates and the performance is presented in FIGS. 17A-17C. Specifically, FIG. 17A shows charge and discharge capacity Q, for battery c charged at a rate of 1C and discharged at various rates. FIGS. 17B and 17C show the voltage profiles and differential capacity curves corresponding to the cycle data in FIG. 17A. As shown in FIG. 17A, even with a very fast discharge at 10C, the capacity only dropped from 1,050 mA h g⁻¹ to 900 mA h g⁻¹. These values are higher than a recent demonstration of Ge nanotubes cycled at fast rates (10C) with a reported capacity of 650 mA h g⁻¹. A significant drop in capacity was only observed when the rate was increased from 10C to 20C. The 2400 Celgard separator membrane becomes limiting at very fast rates and could explain the significant drop in capacity here when the discharge rate was increased from 10C to 20C. Membranes perform better at higher cycle rates with Ge anodes such as those disclosed in Djiana et al., J. Power Sources 2007, 172, 416-421 can be used to improve the high rate discharge performance of the battery. These data indicate that Ge can be used in applications requiring high power during discharge.

Long Term Cycle Stability.

The long term cycle stability of the batteries were studied. The cycling data in FIGS. 10A and 10B show that very little capacity fade after 100 cycles at a rate of C/10 were exhibited from batteries c and d. To determine the limits of the long-term cycle stability, batteries c and d were further tested with the faster cycling rate of 1C and presented in FIGS. 18A and 18B. Specifically, FIG. 18A shows long term cycle stability of battery c and FIG. 18B shows long term cycle stability of battery d. In FIG. 18A, the span in data labeled with ΔT between cycles 750 and 1050 was acquired when the temperature was decreased from 75° F. (24° C.) to 60° F. (16° C.). The first 100 cycles at a rate of C/10 are also shown. The increased cycle rate led to a drop in capacity in both batteries. After the change in cycle rate, battery d had the higher capacity of just above 1,000 mA h g¹. The battery d cycled reversibly for the first 300 cycles, but then faded significantly, with the capacity decreasing to near 200 mA h g⁻¹ after the 600^{th} cycle. The capacity of the battery c dropped from just above 1,200 to 700 mA h g⁻¹ initially when the cycle rate was increased to 1C, but retained this capacity even after 1200 cycles.

The data in FIG. 18A also showed that the battery response is sensitive to temperature. The decrease in ambient temperature reduced the capacity significantly to 400 mA h g⁻¹. When the temperature returned to 75° F. (24° C.), the capacity also returned to almost 700 mA h g⁻¹.

Si and Ge nanowire Li-ion battery anodes with a variety of binders and a variety of electrolyte solutions are disclosed herein. Similar to Si-based anodes, FEC provided a stabilizing effect for the Ge nanowire anodes. The Ge nanowires exhibited stable and high capacity of 1,248 mA h g⁻¹. This value is close to the theoretical capacity of Ge, an improvement over the previous examples of using Si nanowires as a negative electrode in Li-ion batteries, where the capacities of the best performing batteries were roughly 60% of the maximum theoretical capacity of Si. The battery performance of these thick-film slurry-processed anodes rivals the performance observed for thin film Ge anodes. The Ge nanowire anodes also performed well at fast cycle rates, indicating that Ge nanowires are suitable for high rate applications like electric vehicles.

Large irreversible capacity loss, poor performance at cycle rates of C/5 and faster, and significant capacity fade were observed when excess Au was not removed from the Si nanowires. Battery stability was very poor when poly (vinylidene fluoride) (PVdF) binder and common carbonate electrolytes, ethylene carbonate, dimethyl carbonate and diethyl carbonate were used. Respectable Li-ion battery performance was obtained with sodium alginate binder and fluoroethylene carbonate (FEC) added to the electrolyte, with capacities up to 2,000 mA h g⁻¹ after the first 100 cycles.

### Example 5: Silicon Nanowire Seeded with Tin

Si nanowires were synthesized in a nitrogen filled glove box in a flow-through, high pressure sealed titanium reactor via the supercritical fluid-liquid-solid (SFLS) growth mechanism. The reactor was heated to 450° C. and pressurized with toluene to 6.9 MPa with a closed effluent line. A reactant solution of 0.25 mL of trisilane (Si₃H₈) and Sn(HMDS)₂ in toluene (Si:Sn mole ratio in the range from 20:1 to 400:1) was then injected at a rate of 3.0 mL min⁻¹ over the course of 1 min with the reactor outlet closed. The reactor pressure increased to about 13 to 16 MPa during the reaction. Immediately after injecting the reactant solution, the reactor inlet was closed and the sealed reactor was removed from the heating block and allowed to cool to room temperature. After the reactor has cooled, it was removed from the glove box and opened to extract the nanowires with toluene. The nanowires were precipitated by centrifugation at 8,000 rpm for 5 minutes. The supernatant was discarded. The nanowires were redispersed in 20 mL of toluene and re-precipitated by centrifugation. After repeating the washing procedure one more time, the nanowires were dried on a rotary evaporator and stored for later use. This procedure yielded about 80 mg of nanowire product.

The Sn seed particles were generated in situ in the nanowire growth reactor. Instead of the typical approach of synthesizing seed nanocrystals first and feeding them with the reactant, Sn(HMDS)₂ was added with trisilane. Sn(HMDS)₂ decomposition to Sn is fast enough to compete with trisilane decomposition to Si and produce nanowires. This approach conveniently saves time by eliminating the separate nanocrystal synthesis step and also eliminates the possibility of Sn oxidation during nanocrystal transfer to the reactor.

As a seed metal, Sn is a good choice as it forms a low temperature eutectic with Si at 232° C. as shown in FIG. 20A. But trisilane has very fast decomposition kinetics and very high concentrations of seed particles are needed to prevent homogeneous Si particle formation. For example, relatively high Sn:Si ratios of 1:400 still yielded predominantly amorphous Si particles as shown in FIG. 20B. The Sn-seeded reactions with trisilane required very high Sn:Si molar ratios between 1:20 and 1:60 to obtain a high yield of nanowires. Depending on the Si:Sn ratio used, crystalline, crystalline core-amorphous shell, or amorphous silicon nanowires were produced. For example, crystalline Si nanowires without an amorphous shell were prepared using a reactant solution of 0.250 mL trisilane, 0.116 mL Sn(HMDS)₂, and 0.700 mL toluene (Si:Sn 20:1 mol ratio). Si nanowires with amorphous Si shell and crystalline core were prepared with reactant solutions of 0.250 mL trisilane, 0.058 mL Sn(HMDS)₂, and 0.800 mL toluene (Si:Sn 40:1 mol ratio). Amorphous Si nanowires without a crystalline core were prepared using a reactant solution of 0.250 mL trisilane, 0.039 mL Sn(HMDS)₂, and 0.800 mL toluene (Si:Sn 60:1 mol ratio).

SEM, TEM and XRD analysis of Si nanowires formed by Sn-seeded SFLS growth from trisilane with Si:Sn mole ratio of 20:1 have been performed and the results presented in FIGS. 20A-20H. The nanowires are crystalline, diamond cubic Si. They have lengths of tens of micrometers and average diameter of about 50 nm, with significant kinking. Sn particles were found at the tips of the nanowires, confirming that growth occurs by the SFLS mechanism. Specifically, FIG. 20A is a SEM and FIG. 20B is a TEM image of Sn-seeded Si nanowires. FIG. 20C is a cross-sectional SEM image of a Si nanowire anode film (with PVdF binder). FIG. 20D is a TEM image of a Si nanowire with Sn seed at its tip: FIG. 20E shows the Si nanowire segment of FIG. 20D with <211> growth direction and FIG. 20F shows a high resolution lattice image of the Sn seed with d-spacing of 2.9 Å, corresponding to the (200) plane of tetragonal β-Sn. FIG. 20G is an EDS taken from the Sn tip (top curve) and from the nanowire (bottom curve) and FIG. 20H is an XRD with reference patterns provided for Si and Sn (JCPDS: Si, 00-027-1402; tetragonal β-Sn, 00-004-0673). XRD in FIG. 20H showed a significant amount of Sn in the nanowire sample, which is consistent with the relatively high concentration of Sn needed to produce nanowires.

SEM and TEM analysis of amorphous Si nanowires with crystalline Si core formed by Sn-seeded SFLS growth from trisilane with Si:Sn mole ratio of 40:1 have been performed and the results presented in FIG. 21A-21D. Specifically, FIG. 21A shows SEM image of images of Sn-seeded crystalline-amorphous core-shell Si nanowires. FIG. 21B shows TEM image of Sn-seeded crystalline-amorphous core-shell Si nanowires. The nanowires are highly kinked without Sn seed particles remaining at their tips after synthesis. FIG. 21C shows TEM image of Sn-seeded crystalline-amorphous core-shell Si nanowires at higher magnification, with the crystalline core (c-Si) and the amorphous shell (a-Si) of the nanowire clearly visible. FIG. 21D is an HRTEM image showing the lattice fringes of the crystalline core (c-Si) and the amorphous shell (a-Si). They have lengths of tens of micrometers with an amorphous Si shell about 50 nm thick coating a diamond cubic crystalline Si core ranging about 50 nm in diameter. Sn particles are absent from the tips of the nanowires, consumed during the growth process resulting in the formation of the amorphous Si shell as illustrated in FIGS. 22A-22E. Specifically, the phase diagrams for (FIG. 22A) Au and Si and (FIG. 22B) Sn and Si shows that the reaction temperature of 450° C. exceeds both the Au:Si and Sn:Si eutectic temperatures. FIG. 22C shows the formation of Si nanowires from Au seed particles and trisilane. (FIG. 22D shows the synthesis of Si nanowires from trisilane via in situ seeding with Sn. FIG. 22E shows with relatively high Si:Sn ratio, H evolved from trisilane decomposition reacts with Sn seed particles to form volatile tin hydrides (e.g. SnH₄ or Sn₂H₆), etching away the Sn seed particles during nanowire growth. Under these conditions, Si also deposits heterogeneously on the surface of the nanowires as an amorphous shell. Increased Si:Sn ratios to 60:1 in the reactor resulted in amorphous Si nanowires with no visible crystalline core as shown in the TEM image of FIG. 23. Composition profiles of the nanowires were obtained using dark field scanning transmission electron microscopy (STEM) coupled with energy-dispersive X-ray spectroscopy (EDS) and the results are presented in FIGS. 24A-24C. As shown in FIGS. 24A-24C, the EDS line scans showed that there is nearly 10 wt. % Sn in the crystalline nanowires and 3 wt. % Sn in the crystalline core of the core-shell nanowires. This is well above the solid solubility limit of Sn in Si at the growth temperature of 450° C., which is 0.015 wt. % Sn. EDS line scan shows the presence of Sn in the crystalline core, but not in the amorphous shell of the Si nanowires. No Sn was observed in the amorphous shell of the nanowires. No Au was detected in the line scan across the Au-seeded Si nanowire. Au-seeded Si nanowires made with a similar Si:Au ratio of 40:1 had no Au in the core of the nanowire detectable by EDS.

### Example 6: Si Nanowire Anode Preparation, Battery Assembly, and Testing

Si nanowire slurries were prepared by combining Si nanowires with PVdF or NaAlg binder and conductive carbon with a 7:2:1 weight ratio. The nanowires used in the battery tests were made with 20:1 Si:Sn mole ratio. 100 mg of Si nanowires were dispersed in 2 mL of ethanol and bath sonicated for 1 hour. PVdF binder solution was made by adding 20 mg of PVdF and 10 mg of conductive carbon to 1 mL NMP and bath sonicating for 1 hour. NaAlg binder solutions were made by adding 20 mg of NaAlg and 10 mg of conductive carbon to 1 mL of DI-H₂O followed by bath sonication for 1 hour. The Si nanowire dispersion was then mixed with the binder solution, along with a few additional mL of EtOH or DI H₂O to create uniform suspensions. After wand sonication for 30 minutes, the volume was reduced by evaporation on a rotary evaporator to obtain a viscous slurry. Slurries were doctor-bladed (200 μm gap) onto Cu foil and vacuum dried overnight at 100° C. Individual 11 mm diameter circular electrodes were hole-punched from the coated Cu foil. The mass loading was typically 1 mg cm⁻². Coin cells (2032 stainless steel) were assembled in an argon-filled glove box (<0.1 ppm O₂) using Li foil as the counter electrode. A few drops of electrolyte were placed on the Li counter electrode, followed by the Celgard separator membrane, another few drops of electrolyte, and then the Si nanowire electrode. The battery was crimped and removed from the glove box for testing with an Arbin BT-2143 test unit cycling between 2 V and 10 mV vs Li/Li⁺. Capacities were reported based on the theoretical capacity of Si, i.e., 1C=3,579 mA h g⁻¹.

The Sn seed particles were generated in situ in the nanowire growth reactor. Instead of the typical approach of synthesizing seed nanocrystals first and feeding them with the reactant, Sn(HMDS)₂ was added with trisilane. Sn(HMDS)₂ decomposition to Sn is fast enough to compete with trisilane decomposition to Si and produce nanowires. In-situ seeding has also worked well for supercritical growth of multiwall carbon nanotubes with molecular precursors like ferrocene and cobaltocene for the seed metal particles (Lee et al., Molecular Simulation2005, 31, 637-642; Lee et al., J. Am. Chem. Soc. 2004, 126, 4951-4957; Smith et al., Chem. Mater.2006, 18, 3356-3364). This approach conveniently saves time by eliminating the separate nanocrystal synthesis step and also eliminates the possibility of Sn oxidation during nanocrystal transfer to the reactor.

The Sn-seeded Si nanowires were tested in Li-ion battery coin cells cycled against Li metal between 0.01 and 2.0 V vs. Li/Li⁺ at a rate of C/10 in various electrolyte solvents and the results presented in FIGS. 25A-25F. FIGS. 25A, 25C, and 25E show charge capacity and FIGS. 25B, 25D, and 25F show capacity retention relative to the 5^{th} cycle for Li-ion batteries of this example. Batteries in FIGS. 5A and 25B used PVdF as binder. Batteries in FIGS. 25C and 25D used PVdF annealed at 300° C. as the binder. Batteries in 25E and 25F used NaAlg as the binder. The cycling data presented in FIGS. 25A-25F is further presented in FIGS. 26Ai-26Eiii. Specifically, FIGS. 26Ai, 26Bi, 26Ci, 26Di, and 26Ei show Charge capacity Q, and Coulombic efficiency (ratio of discharge and charge capacity at each cycle); FIGS. 26Aii, 26Bii, 26Cii, 26Dii, and 26Eii show voltage profiles and FIGS. 26Aiii, 26Biii, 26Ciii, 26Diii, and 26Eiii show differential capacity plots of the batteries. Anodes contain either (FIGS. 26Ai-26Aiii, 26Bi-26Biii, 26Ci-26Ciii) PVdF annealed for 12 hrs at 300° C. under nitrogen or (FIGS. 26Di-26Diii and 26Ei-26Eiii) NaAlg binder with 1 M LiPF₆ electrolyte in various 1:1 (v/v) mixtures of (FIGS. 26Ai-26Aiii) EC:DMC, (FIGS. 26Bi-26Biii and 26Di-26Diii) FEC:DEC or (FIGS. 26Ci-26Ciii and 26Ei-26Eiii) FEC:DMC.

The nanowire films were 10-20 μm thick with a loading of about 1 mg cm⁻². In comparison, CVD-grown nanowire anodes typically have mass loadings of 10-200 μg cm⁻². (Laïk et al., Electrochim. Acta 2008, 53, 5528-5532; Ruffo et al., J. Phys. Chem. C 2009, 113, 11390-11398; Kang et al., Appl. Phys. Lett. 2010, 96, 053110; Chakrapani et al., J. Phys. Chem. C 2011, 115, 22048-22053.) The charge capacities were just over 1,800 mA h g⁻¹ after the first 100 cycles for nanowire anodes with PVdF (annealed at 300° C. for 12 hours under nitrogen) or NaAlg binder and FEC added to the electrolyte. FEC has been reported by others as well to have a significant stabilizing effect in Si anodes. (Etacheri et al., Langmuir 2011, 28, 965-976; Choi et al., J. Power Sources 2006, 161, 1254-1259; Nakai et al., J. Electrochem. Soc. 2011, 158, A798-A801.) The anodes with PVdF that were not annealed performed very poorly, also consistent with other reports for Si anodes (Li et al., J. Electrochem. Soc. 2008, 155, A234-A238). In some studies, even with annealing, PVdF has not been found to be an effective binder for Si anodes (Kovalenko et al., Science 2011, 334, 75-79; Magasinski et al., ACS Appl. Mater. Interfaces 2010, 2, 3004-3010).

Anodes with NaAlg binder performed well without the need for a high temperature anneal, as others have found for both Si particle and nanowire-based anodes (Kovalenko et al., Science 2011, 334, 75-79). NaAlg is also ecologically friendly-produced by brown algae and processed with water. NaAlg is thought to serve as an effective binder due to self-healing that can occur during the volume changes by reforming hydrogen bonds between sugar-like moieties in the binder (e.g., carboxymethylcellulose—CMC, NaAlg, etc.) (Bridel et al., Chem. Mater. 2009, 22, 1229-1241; Mazouzi et al., Electrochem. Solid St. 2009, 12, A215-A218) and to the partially oxidized Si surface.

Differential Capacity Plots.

Voltage profiles during cycling and the corresponding differential capacity (dQ/dV) plots (FIGS. 27A-27E) provide more information about the stability of the batteries. Specifically, FIGS. 27A-27E panels (i,iii) show color maps and FIGS. 27A-27E panels (ii) shows waterfall plots of the differential capacity data correspond to the battery data in FIGS. 25A-25F. FIG. 27A has EC:DMC as solvent; FIGS. 27B and 27D has FEC:DEC as solvent. FIGS. 27C and 27E has FEC:DMC as solvent. Anodes were formulated with either PVdF annealed for 12 hrs at 300° C. under nitrogen in FIGS. 27A, 27B and 27C or NaAlg binder in FIGS. 27D and 27E. The top two rows (row i and top row ii) show the differential capacity during discharge (or delithiation) and the two bottom rows (bottom row ii and row iii) show the differential capacity during charge (or lithiation).

The differential capacity curves are relatively stable for the batteries without significant capacity fade, but change markedly for those with significant fade. For example, batteries with FEC-containing electrolyte showed the characteristic features for a-Si lithiation and delithiation at 250 mV and just below 100 mV (during lithiation) and at 300 mV and 500 mV (during delithiation), with little change over time. Batteries with EC:DMC electrolyte on the other hand showed significant changes with cycling. These differences are more apparent in the waterfall plots and color maps of the differential capacity shown in FIGS. 27A-27E. Even for the FEC-containing batteries that had relatively little capacity fade, the peaks drifted slightly as cycling progressed, indicating some irreversible chemistry taking place in the battery.

From the differential capacity plots, it is not clear whether Sn is electrochemically active and storing lithium or not. Sn has a capacity of 992 mA h g⁻¹ and Li insertion into Sn usually occurs at around 400 mV and Li delithiation at the slightly higher voltage of 500 mV (Courtney et al., Phys. Rev. B 1998, 58, 15583-15588; Todd et al., Int. J. Energ. Res. 2010, 34, 535-555). There is no clear signature of Sn lithiation, but a Sn-related signal would be relatively weak compared to Si because it makes up only a fraction of the sample (for example 5% w/w) and it has a lower capacity than Si.

Rate Capability.

The discharge capacity of Si nanowire anodes cycled at faster rates are studied and the results presented in FIGS. 28A and 28B. Specifically, FIG. 28A shows the charge capacities of Sn-seeded Si nanowire anodes with PVdF annealed under nitrogen for 12 hours at 300° C. and FIG. 28B with NaAlg binder cycled at various rates between 0.01 and 2 V vs. Li/Li+ against Li foil with 1 M LiPF₆ in 1:1 v/v mixtures of: EC:DEC, FEC:DEC, or FEC:DMC. The capacity decreases with faster cycling rate due to kinetic limitations to charging. The Sn-seeded Si nanowires showed decreased capacities at faster cycling rates, with a capacity of about 500 mA h g⁻¹ at 2C. By using Sn instead of Au as the seed metal, Si nanowires with much better rate capability are obtained.

It is worth noting that the performance of the batteries with EC:DMC was comparable to the FEC-containing batteries in the tests in FIGS. 28A and 28B at higher cycling rates. However, often Si-anodes without FEC will exhibit reasonable battery stability for the first 30-50 cycles, but then degrade significantly after that. The anodes with NaAlg binder rebounded to high capacities (1,600 mA h g⁻¹) when the rate was reduced back to C/10 after cycling at C/2, C, and 2C, indicating that the capacity loss at faster cycle rates is reversible and results from kinetic limitations in the battery. The EC:DMC containing batteries showed a return to higher capacity when the rate was decreased back to C/10, but there is substantial capacity fade at that point as shown in FIG. 28A.

FIGS. 29Ai-29Eiii and 30A-30E show voltage profiles and differential capacity curves for Si nanowire batteries correspond to the battery data of FIGS. 28A and 28B. Specifically, FIGS. 29Ai, 29Bi, 29Ci, 29Di, and 29Ei show charge and discharge capacity Q, vs Coulombic efficiency, FIGS. 29Aii, 29Bii, 29Cii, 29Dii, and 29Eii show voltage profiles and FIGS. 29Aiii, 29Biii, 29Ciii, 29Diii, and 29Eiii show differential capacity curves for Sn-seeded Si nanowire anodes cycled at different rates. FIGS. 29Ai-29Aiii, 29Bi-29Biii, and 29Ci-29Ciii have PVdF annealed at 300° C. as binder and FIGS. 29Di-29Diii and 29Ei-29Eiii have NaAlg as binder. FIGS. 29Ai-29Aiii have EC:DMC as solvent. FIGS. 29Bi-29Biii and 29Di-29Diii have FEC:DEC as binder. FIGS. 29Ci-29Ciii and 29Ei-29Eiii have FEC:DMC as binder *Cycles 20 and 25 for NaAlg were at C/20. FIGS. 30A-30E panels (i & iii) show differential capacity color maps and FIG. 30A-30E panel (ii) show waterfall plots for Sn-seeded Si nanowire batteries corresponding to the battery data of FIGS. 28A and 28B. FIGS. 30A, 30B, and 30C have PVdF annealed at 300° C. as binder and FIGS. 30D and 30E have NaAlg as binder. FIG. 30A has EC:DMC as solvent. FIGS. 30B and 30D have FEC:DEC as binder. FIGS. 30C and 30E have FEC:DMC as binder. The top two rows (row i and top row ii) show the differential capacity during discharge (or delithiation) and the two bottom rows (bottom row ii and row iii) show the differential capacity during charge (or lithiation).

At the slower cycling rates, the differential capacity curves show the characteristic features of Si lithiation and delithiation. When the cycling rate was increased, the lithiation peaks shifted to lower potential and the delithiation peaks shifted to higher potential. When the rate exceeded C/2, the two lithiation peaks and the two delithiation peaks also merged into a single lithiation and delithiation features. When the cycling rate was reduced again to C/10, the characteristic lithiation and delithiation peaks re-emerged (FIGS. 30A-30E). The differential capacity curves confirm that the drop in capacity at higher cycling rates is due to kinetic limitations that are reversible.

### Example 7: Crystalline, Amorphous with Crystalline Core or Amorphous Si Nanowire Anode Preparation, Battery Assembly, and Testing

Core-shell Si nanowire slurries were prepared by combining nanowires with NaAlg and PAA binders and conductive carbon in a 7:1:1:1 weight ratio. 100 mg of Si nanowires, 10 mg NaAlg, 10 mg PAA, and 10 mg conductive carbon were dispersed in 2 mL ethanol and 2 mL H₂O and wand sonicated for 30 minutes. After sonication, the volume is reduced by evaporation on a rotary evaporator to obtain a viscous slurry that is doctor-bladed (200 μm gap) onto Cu foil. The slurry is dried in ambient then heated to 160° C. under vacuum for 2 hours to crosslink the NaAlg and PAA binder. Individual 11 mm diameter circular electrodes are hole-punched from the coated Cu foil with a mass loading typically about 0.5-1 mg cm⁻². Coin cells (2032 stainless steel) are assembled in an argon-filled glove box (<0.1 ppm O₂) using Li foil as the counter electrode. A few drops of electrolyte solution (1:1 w/w EC:DEC with 5 wt % FEC) are placed on the Li counter electrode, followed by the Celgard separator membrane, another few drops of electrolyte, and then the Si nanowire electrode. The battery is crimped and removed from the glove box for testing with an Arbin BT-2143 test unit cycling between 2 V and 10 mB vs Li/Li+. Capacities are reported based on the theoretical capacity of Si, i.e., 1C=3,579 mA h g⁻¹.

Crystalline Si nanowires, crystalline-amorphous core-shell Si nanowires, and amorphous Si nanowires were tested in Li-ion battery coin cells cycled against Li metal between 0.01 and 2.0 V vs. Li/Li⁺ at various cycle rates were studied and the results presented in FIGS. 30A-31C and summarized in Table 3 below.

TABLE 3
Summary of Sn seeded Si nanowire anode battery performance

| | | | | Capacity (mA h g⁻¹) | | | | |
|---|---|---|---|---|---|---|---|---|
| | | | Electrolyte | Cycle | Cycle | Cycle | Retention (%) | |
| | Nanowires | Binder | Solvent | 1 | 5 | 100 | Qᵣₑₜ₁^{a} | Qᵣₑₜ₅^{b} |
| 1 | Crystalline | NaAlg + PAA | EC:DEC + 5% | 3464 | 3302 | 1469 | 42.4 | 44.5 |
| | | | FEC | | | | | |
| 2 | Crystalline- | NaAlg + PAA | EC:DEC + 5% | 3038 | 2800 | 2250 | 74.1 | 80 |
| | Amorphous | | FEC | | | | | |
| 3 | Amorphous | NaAlg + PAA | EC:DEC + 5% | 3423 | 3619 | | | |
| | | | FEC | | | | | |

At a cycle rate of C/10, the discharge capacity was highest and most stable for the amorphous Si nanowires, about 3,500 mA h g−1 after 40 cycles. At a cycle rate of 1C, after an initial conditioning cycle at C/20, the amorphous Si nanowires exhibited the highest capacity, about 1500 mA h g⁻¹ after 100 cycles. The amorphous Si nanowires maintain high capacities even at faster cycles rates, 2C, exhibiting a capacity about 1000 mA h g⁻¹ after 10 cycles. The capacity of the crystalline Si nanowires using crosslinked NaAlg and PAA (FIGS. 31A-31C) is much greater than when using pure NaAlg (FIGS. 25E and 25F) as the binder material. It is thought that the crosslinking of the NaAlg and PAA harness the strong binding of the NaAlg and Si with the strong adherence of PAA to Cu to improve binder stability through repeated cycling.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

1.-56. (canceled)

57. A method of making tin-seeded silicon nanowires, the method comprising:
forming a supercritical fluid in a reactor;
injecting a reaction mixture comprising a nanowire precursor and a tin source material into the reactor to initiate a reaction forming tin-seeded silicon nanowires, wherein a molar ratio of silicon to tin in the reaction mixture is from 20:1 to 400:1; and
cooling the reactor to room temperature, wherein the tin-seeded silicon nanowires comprise silicon nanowires including from 0.5 to 10 wt. % tin.

58. The method of claim 57, wherein forming the supercritical fluid comprises:
preheating and pressurizing the reactor; and
injecting a solvent into the reactor.

59. The method of claim 57, wherein the supercritical fluid comprises toluene, hexane, benzene, or xylene, wherein the nanowire precursor comprises a silane compound, and wherein the tin source comprises an organotin compound.

60. The method of claim 57, wherein the supercritical fluid comprises toluene, wherein the nanowire precursor comprises trisilane, and wherein the tin source comprises Sn(HMDS)₂.

61. The method of claim 57, wherein the reaction comprises thermally degrading the nanowire precursor in the reactor.

62. The method of claim 57, wherein the reaction comprises forming tin seed particles from the tin source in the reactor.

63. The method of claim 57, wherein the tin-seeded silicon nanowires further comprise a graphitic carbon coating.

64. A method of making an anode for a Li-ion battery, the method comprising:
making tin-seeded silicon nanowires by the method of claim 57;
forming a nanowire dispersion comprising the tin-seeded silicon nanowires and a solvent;
forming a slurry comprising the nanowire dispersion, a binder, and a conductive carbon; and
slurry casting the slurry onto a conductive substrate to form a coated substrate; and
drying the coated substrate.

65. The method of claim 64, wherein the coated substrate comprises an anode active material layer over the conductive substrate, wherein the anode active material layer comprises a film of the tin-seeded silicon nanowires having a loading of from about 0.1 mg/cm² to about 1.5 mg/cm² and a thickness of from about 10 μm to about 25 μm.

66. A method of making a Li-ion battery, the method comprising:
making an anode according to the method of claim 64; and
positioning a separator and an electrolyte between the anode and a cathode.

67. Tin-seeded silicon nanowires comprising:
silicon nanowires including from 0.5 to 10 wt. % tin.

68. The tin-seeded silicon nanowires of claim 67, wherein the silicon nanowires have an average diameter of from about 1 nm to about 100 nm, wherein the silicon nanowires have an average length of from about 1 μm to about 100 μm, and wherein the silicon nanowires have a length to diameter aspect ratio of from about 100 to about 10000.

69. The tin-seeded silicon nanowires of claim 67, wherein the silicon nanowires are crystalline nanowires, amorphous with a crystalline core, or amorphous nanowires.

70. An anode for a Li-ion battery, the anode comprising:
a conductive substrate; and
an anode active material layer, the anode active material layer comprising nanowires, a conductive carbon, and a binder, wherein the nanowires comprise the tin-seeded silicon nanowires of claim 67.

71. The anode of claim 70, wherein the binder comprises polyvinylidene fluoride or sodium alginate.

72. The anode of claim 70, wherein the anode has a discharge capacity of at least 500 mA h g⁻¹ when cycled at a 2C rate or wherein the anode has a discharge capacity retention at a 100th cycle of at least 50% relative to a first cycle when cycled at a rate of C/10.

73. The anode of claim 70, wherein the anode has a first cycle irreversible capacity loss of less than 200 mA h g⁻¹.

74. The anode of claim 70, wherein less than 2% of the nanowires are covalently or ionically attached to the conductive substrate.

75. The anode of claim 70, wherein the anode active material layer comprises a film of the tin-seeded silicon nanowires having a loading of from about 0.1 mg/cm² to about 1.5 mg/cm² and a thickness of from about 10 μm to about 25 μm.

76. A Li-ion battery, comprising:
the anode of claim 70;
a cathode;
a separator between the anode and the cathode; and
an electrolyte comprising at least one lithium salt and at least one aprotic solvent.
